(19) United States
(12) Patent Application Publication
(10) Pub. No.: US 2026/0072053 A1
(43) Pub. Date: Mar. 12, 2026

(54) Systems, Methods and Apparatus for Experimental Gravity Modification

(71) Applicants: John Brandenburg, Southlake, TX (US); Michael G. Smith, Keller, TX (US)

(72) Inventors: John Brandenburg, Southlake, TX (US); Michael G. Smith, Keller, TX (US)

(21) Appl. No.: 18/828,446

(22) Filed: Sep. 9, 2024

(51) Int. Cl. G01N 37/00

(52) U.S. Cl. CPC G01N 37/005

(57) ABSTRACT

Systems, methods and apparatus are provided through which in some implementations an experimental apparatus to modify gravity includes an electrically conducting dome, three or more electrically conducting coils attached to the interior of the electrically conducting dome, and a power source electrically coupled to the electrically conducting coils, the electrically conducting coils configured to generate rotating electromagnetic fields that form a Poynting vector vortex, that produces a gravity force that is perpendicular to the Poynting vector vortex.

### BACKGROUND OF THE INVENTION

This disclosure relates generally to propulsion, and more particularly to gravity modification.

Einstein was correct, conceptually, in his conviction that electro-magnetism and gravity, the two long range forces of nature, could be unified, and that the unification of electro-magnetism and gravity involves the observed pre-dominance of hydrogen (the proton and electron pair), as the known source of mass and charge in the universe. However, Einstein's unification efforts were hindered by his skepticism of quantum mechanics. This latter concept, being introduced with appearance of Kaluza-Klein theory, was published despite Einstein's doubts concerning quantum mechanics, but with his sponsorship. The cellular structure of spacetime, breaking the scale invariance of the vacuum, necessary in order to understand the existence of a hidden 5th dimension, by which gravity and electro-magnetism are unified. Thus, Einstein's pivotal role in establishing quantum mechanics, despite Einstein's misgivings, and Einstein's seminal discovery of the ZPF (Zero-Point Fluctuation), and even endorsing application of ZPF to spacetime, has laid the groundwork for the unification effort that Einstein began.

An additional insight comes from Hawking, who showed that the Black-hole, in the context of a quantum vacuum, is unstable to evaporation into matter-antimatter and from there into thermal gamma rays, and by extension, entropy.

### SUMMARY OF THE INVENTION

The above-mentioned shortcomings, disadvantages and problems are addressed herein, which will be understood by reading and studying the following specification.

The above-mentioned shortcomings, disadvantages and problems are addressed herein, which will be understood by reading and studying the following specification.

In one aspect, spacetime can be understood as electrodynamic only through quantum mechanics, in which spacetime consists of a plasma of virtual charged particles or alternatively charged with electro-magnetism fields of the ZPF (Zero-Point Fluctuation), and hence that gravity itself is essentially electrodynamic. Further, accepting the concept that the universe is quantized, having a cellular structure, in order to understand the significance of the classical radii of protons and electrons in the cosmos. The cellular structure of spacetime, breaking the scale invariance of the vacuum, is helpful in order to understand the existence of a hidden 5th dimension, by which gravity and electro-magnetism are unified.

In implementing these concepts, an experimental system of one or more computers can be configured to perform particular operations or actions by virtue of having software, firmware, hardware, or a combination thereof installed on the system that in operation causes or cause the experimental system to perform the actions. One or more computer programs can be configured to perform particular operations or actions by virtue of including instructions that, when executed by data processing apparatus, cause the apparatus to perform the actions. One general aspect includes an experimental apparatus to modify gravity. The experimental apparatus also includes an electrically conducting dome; three or more electrically conducting coils attached to an interior of the electrically conducting dome; and a power source electrically coupled to the electrically conducting coils, the electrically conducting coils configured to generate rotating electromagnetic fields that form a Poynting vector vortex, that produces a force that is perpendicular to the Poynting vector vortex. Other implementations of this aspect include corresponding experimental computer systems, apparatus, and computer programs recorded on one or more computer storage devices, each configured to perform the actions of the methods.

One general aspect includes an experimental system to modify gravity. The experimental system also includes an electrically conducting dome; three or more electrically conducting coils attached to an interior of the electrically conducting dome; and a power source electrically coupled to the electrically conducting coils, where the electrically conducting coils are configured to generate rotating electromagnetic fields that form a Poynting vector vortex, that produces a force that is perpendicular to the Poynting vector vortex. Other implementations of this aspect include corresponding computer systems, apparatus, and computer programs recorded on one or more computer storage devices, each configured to perform the actions of the methods.

One general aspect includes an experimental method energizing electrically at least three electrically conducting coils from one or more power sources; and generating rotating electromagnetic fields that form a Poynting vector vortex, the Poynting vector vortex producing a force that is perpendicular to the Poynting vector vortex. Other implementations of this aspect include corresponding experimental computer systems, apparatus, and computer programs recorded on one or more computer storage devices, each configured to perform the actions of the methods.

One general aspect includes an experimental computer-accessible medium having executable instructions to control an experimental propulsion apparatus. The computer-accessible medium includes energizing electrically at least three electrically conducting coils from one or more power sources; and generating rotating electromagnetic fields that form a Poynting vector vortex, the Poynting vector vortex producing a force that is perpendicular to the Poynting vector vortex. Other implementations of this aspect include corresponding computer systems, apparatus, and computer programs recorded on one or more computer storage devices, each configured to perform the actions of the methods.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF DRAWINGS

FIG. 1 is an isometric diagram of an overview of an experimental propulsion apparatus to modify gravity, according to an implementation.

FIG. 2 is a diagram of evaporation of a black-hole into gamma rays, according to an implementation.

FIG. 3 is a diagram of the E×B drift caused by crossed electric and magnetic fields, according to an implementation.

FIG. 4 is a diagram of a simulation of an electro-magnetism-synthetic gravity field, according to an implementation.

FIG. 5 is a diagram of two hot ideal radiators in a cold box, according to an implementation.

FIG. 6 is a diagram of two cold ideal radiators in a hot box, according to an implementation.

FIG. 7 is a diagram of a Gendanken experiment, according to an implementation.

FIG. 8 is a diagram of a quantum vacuum, according to an implementation.

FIG. 9 is a diagram of plates exhibiting the Casimir force, according to an implementation.

FIG. 10 is a diagram of the difference in modes allowed between a between plates, according to an implementation.

FIG. 11 is a Feynman diagram of photon-photon scattering, according to an implementation.

FIG. 12 is a diagram of the gravity pressure and hydrostatic pressure of the Earth, according to an implementation.

FIG. 13 is a conceptual diagram of radiation scattering off of a charged particle and creating a donut shaped region of interference between the scattered and incident waves, according to an implementation.

FIG. 14 is a diagram of the appearance and annihilation of a mesoscale mass particle-antiparticle pair in the vacuum, according to an implementation.

FIG. 15 is a diagram of the appearance of a mesoscale mass particle-antiparticle pair in the vacuum, according to an implementation.

FIG. 16 is an illustration of the Sunyaev-Zeldovich effect, according to an implementation.

FIG. 17 is a schematic of a leaky vacuum, according to an implementation.

FIG. 18 is a diagram of quantum Mie scattering, according to an implementation.

FIG. 19 is a diagram of quantum Mie scattering, according to an implementation.

FIG. 20 is a diagram of quantum Mie scattering, according to an implementation.

FIG. 21 is a diagram of quantum Mie scattering, according to an implementation.

FIG. 22 is a diagram of a Gama ray spectrum from Crab nebula supernova remnant.

FIG. 23 is a diagram of Gamma ray spectrum from a very energetic Gamma Ray Burst 090510A.

FIG. 24 is a diagram of two models of the proton.

FIG. 25 is a diagram of an experimental curve of the variation of a with energy, according to an implementation

FIG. 26 is a diagram of two models of an electron absorbing and reradiating a photon, according to an implementation.

FIG. 27 is a diagram of a simplified scheme for “Mieon” process generation of the quanta of the Strong and Weak Force plus the Higgs Boson.

FIG. 28 is a diagram of a potential function for spacetime in mass-geometry parameter s.

FIG. 30 is a diagram of the “gravity siren” as gravity waves emitted by mutually orbiting pair of black-holes increases in frequency as the system loses energy and “in-spirals”.

FIG. 31 is a diagram of an eruption of mount Pinatubo showing the result of an efficient turbulent cascade, turning a rising flow into a chaotic, turbulent flow.

FIG. 32 is diagram of the approximate sequence in a Black Hole merger.

FIG. 33 is a diagram of the detection of Gravity Waves by the LIGO group.

FIG. 34 is a diagram of the apparent detection of a Gamma Ray burst by the FERMI observatory coincident in time with the detection Gravity Waves by a LIGO group.

FIG. 35 is a flowchart of an experimental method to control a propulsion apparatus, according to an implementation.

FIG. 36 is a block diagram of an experimental propulsion control computer in which different implementations can be practiced.

FIG. 37 is a block diagram of an experimental data acquisition circuit of the propulsion control computer, according to an implementation.

FIG. 38 is a block diagram of an experimental hardware and operating environment in which different implementations can be practiced.

FIG. 39 is a block diagram of an experimental handheld mobile device, according to an implementation.

### DETAILED DESCRIPTION OF THE INVENTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, apparatus of implementations are described. In the third section, implementations of methods are described. In the fourth section, a hardware and the operating environment in conjunction with which implementations may be practiced are described. Finally, in the fifth section, a conclusion of the detailed description is provided.

### System Level Overview

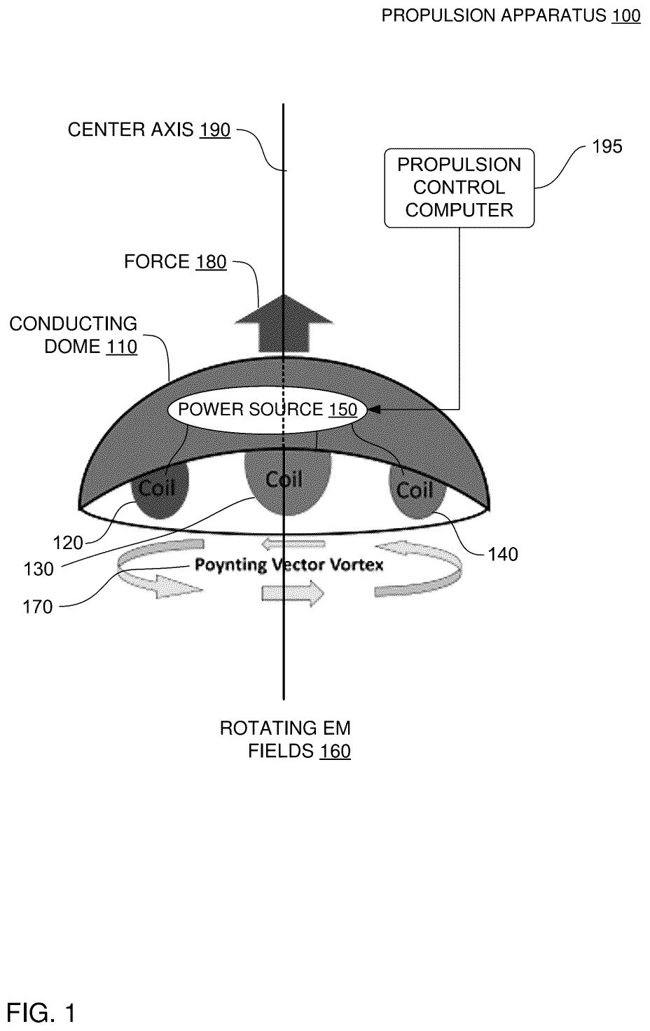

FIG. 1 is an isometric diagram of an overview of an experimental propulsion apparatus 100 to modify gravity, according to an implementation. Experimental propulsion apparatus 100 generates gravity from electrically conducting coils.

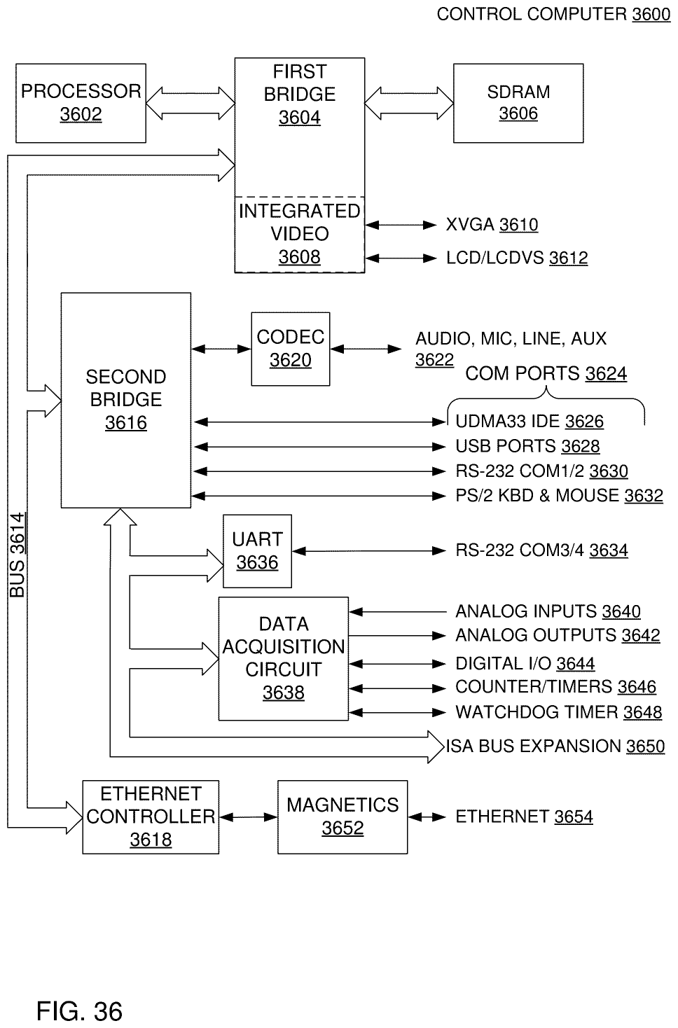

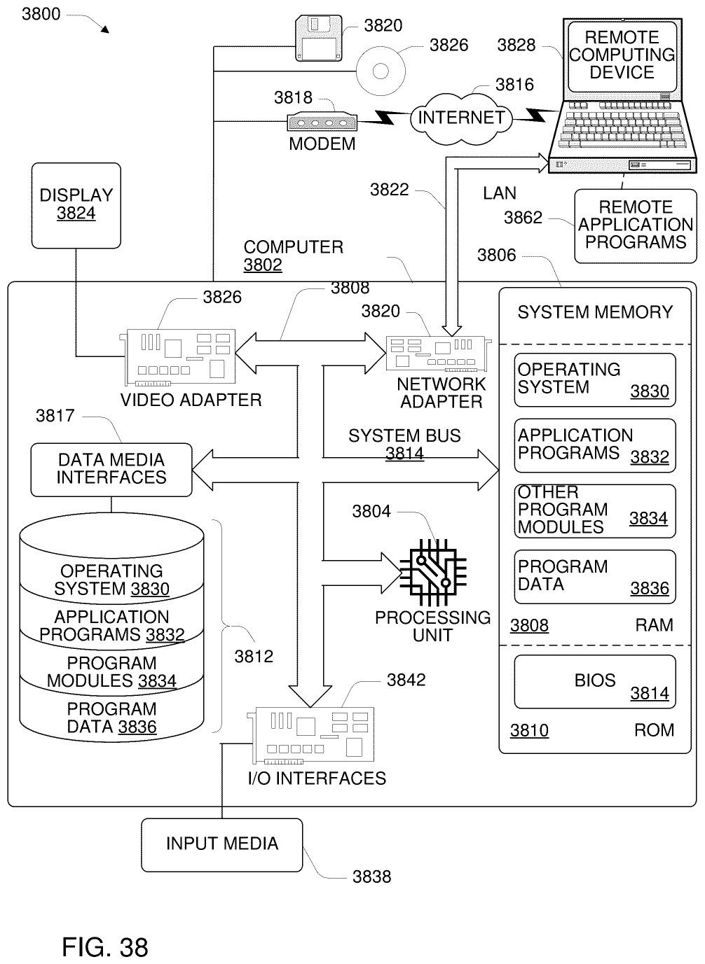

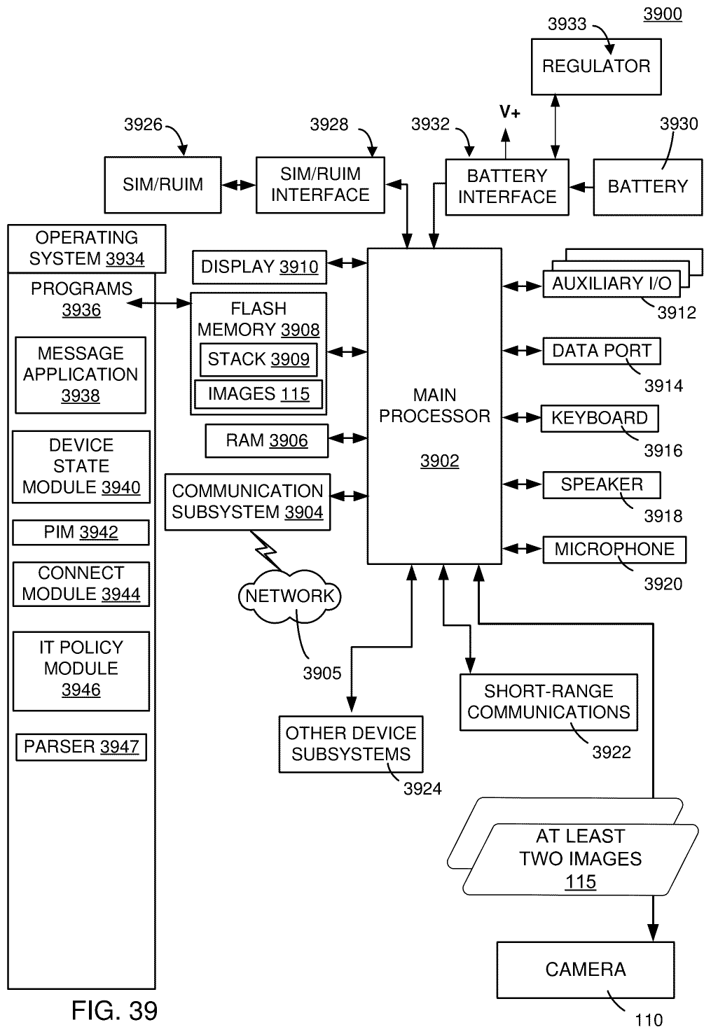

Propulsion apparatus 100 includes an electrically conducting dome 110 upon which are attached to three or more electrically conducting coils, 120, 130 and 140. When the electrically conducting coils, 120, 130 and 140 are electrically energized by one or more power sources 150, rotating electromagnetic (EM) fields 160 are generated that form a Poynting vector vortex 170, that produces a gravity force 180 that is perpendicular to the Poynting vector vortex 170. The gravity force 180 is gravity. Propulsion apparatus 100 is centered and symmetrical about center axis 190. The electrically conducting coils, 120, 130 and 140 are positioned symmetrically about center axis 190. Each of the electrically conducting coils, 120, 130 and 140 are identical to each other. The power source(s) 150 are electrically coupled to the electrically conducting coils, 120, 130 and 140. However, the power source(s) 150 can be physically positioned or located in a variety of physical positions or locations, other than what is shown in FIG. 1, such as outside of the electrically conducting dome 110. The propulsion apparatus 100 includes a propulsion control computer 195 that controls the power source 150 and thus controls power from the power source 150 to the electrically conducting coils 120, 130 and 140. Examples of the propulsion control computer 195 include propulsion control computer 3600 in FIG. 36, hardware and operating environment 3800 in FIG. 38 and a handheld device 3900 in FIG. 39. In some implementations, approximately 200 kw of electric power input into the three or more electrically conducting coils, 120, 130 and 140 produces one ton of gravity force 180. In some implementations discussed below in the section “Estimate of Lift Per Unit of Power of propulsion apparatus 100 in FIG. 1”, approximately 33 kw of electric power input into the three or more electrically conducting coils, 120, 130 and 140 produces one ton of gravity force 180.

Gravity and electro-magnetism are unified under two postulates that: 1. Gravity fields are an array of E×B drifts and 2. The separate appearance of gravity and electro-magnetism fields from each other is correlated with the separation of protons and electrons from each other as the emerge from the Planck scale. The value of G, the Newton gravitation constant and the proton mass to good accuracy from the Planck scale with no free parameters. The values of the pion mass for the Strong Force and the W and Z boson masses as quantum Mie scatterings off the hidden dimension structures associated with the proton and electron masses are understood. The Higgs boson mass follows from similar formalism. Vacuum decay with the production of hydrogen and a CBR (Cosmic Background Radiation) is also predictable.

The quantum nature of reality is fundamental in the operation of propulsion apparatus 100 and in this entire disclosure. Understanding unified gravity and electromagnetism solves the geometric problem of unifying the “great scales” of the Hubble and Planck radii, with the “mesoscale” of the subatomic. Physical models describe unified gravity and electromagnetism, rather than sophisticated mathematics, yet also explains basic observations and predicts new phenomena.

The unification of gravity and electromagnetism is based not only physical model of gravity as an electrodynamic effect of spacetime in the classical limit, but also, following Einstein's pathway, on model of the observed pre-dominance of hydrogen in the cosmos. In the unification of gravity and electromagnetism both of these phenomena stem from the quantum mechanical consequences of a hidden 5^{th} dimension that gives rise to separated pair of electro-magnetism and gravity fields and also the pair of subatomic particles, the electron and proton that make up hydrogen the cosmos. Formally, the unification of gravity and electromagnetism can be considered a combination of Sakharov's theories of both gravity as the metric elasticity of space due to electro-magnetism ZPF (Zero Point Fluctuations) and also Einstein's theory of Baryogenesis, but in addition the Kaluza-Klein theory of electro-magnetism-gravity unification through a hidden 5^{th} dimension. The hidden dimension of Kaluza-Klein is required in order to have separate electro-magnetism and gravity fields and the existence of the hidden dimension of Kaluza-Klein in a quantum mechanical electrodynamic spacetime manifold gives rise to subatomic particles through resonant Mie scattering.

Essential to the unification gravity and electromagnetism is the concept of an electrodynamic fabric to spacetime, so that the vacuum is no longer simply a manifold but a dynamic ethereal substance, full of ZPF fields and virtual particles. Furthermore, the hidden 5^{th} dimension of Kaluza-Klein required to support separate electro-magnetism and gravity fields, by breaking the scale symmetry of the vacuum, gives rise to particles. That is: the requirement of a hidden 5^{th} dimension breaks the scale symmetry of the vacuum and creates scattering and virtual particles near the wavelength of the hidden dimension. Breaking the scale symmetry not only creates particles as resonances, the proton and electron, but also creates entropy. The vacuum without a hidden dimension is coherent and ordered, but with a hidden dimension included creates scattering and de-coherence. However, remarkably, the vacuum without a hidden dimension also creates other phenomena.

The unification of gravity and electromagnetism, unexpectedly shows that the subatomic forces called Strong and Weak forces, are created by exchange between boson fields around particles, as a secondary consequence of the hidden 5^{th} dimension. The breaking of the scale invariance of the vacuum by the hidden 5^{th} dimension creates resonant structures in the vacuum, and with Quantum vacuum turbulence exciting the resonant structures, quantum Mie scattering occurs, giving rise to the subatomic exchange forces. This is done with a formalism resembling the Feynman path Integral formalism. The unification of gravity and electromagnetism thus predicts, astonishingly, the masses of the bosons associated with the Weak Force W boson but also the pion of the Strong force, to high accuracy.

In the unification of gravity and electromagnetism, the breaking of scale symmetry in the vacuum must, through Kaluza-Klein, create a scalar field, to mediate scale changes which in turn are manifested as particle masses. As stated by Dr. Alfred Luhen of Madison College, “one cannot create mass without creating gravity” and thus any complete Standard Model involving the Higgs field must also incorporate gravity through General Relativity. Thus, in the unification of gravity and electromagnetism, mass cannot be created through the Higgs mechanism in the unification of gravity and electromagnetism without creating gravity. The creation of mass cannot be separated from gravity with the result that the Higgs boson is in structural resonance with the main massive particle in the universe, the proton. Thus, the Higgs Boson mass is part of the mechanism of the vacuum manifold that lays the foundation of a hydrogenic universe.

The unification of gravity and electromagnetism shows a vacuum unstable to creation of proton-electron pairs, with profound Cosmological consequences and a Strong and Weak force between subatomic particles. Finally. The physical meaning of the Higgs boson and the scale and the occurrence of the Higgs boson and the Radion scale-inducing field in creating the hydrogenic universe is shown.

The vacuum, in modern quantum mechanical understanding, is not empty. The vacuum is instead alive with virtual particles, including electromagnetic waves organized as photons. The virtual particles, including electromagnetic waves organized as photons, herein called the ZPF (Zero Point Fluctuation) was first identified by Einstein. The best calculations of the energy density of the vacuum yield vast numbers: “the most embarrassing number in physics” of 10¹¹⁴ ergs/cm, indicating that matter, with an average density in the cosmos of 1 GeV/m (one hydrogen atom per cubic meter) is merely a perturbation on the vacuum. Thus, formulating a physical theory of the vacuum, matter, in the form of subatomic particles will be recovered as a perturbation around the vacuum state.

Dirac's Large Numbers Hypothesis provides a profound observation, where he observed, in esu units:

$$\frac{G {m}_{p} {m}_{e}}{{e}^{2}} ≅ \frac{{r}_{e}}{{R}_{H}} \qquad ( 1 )$$

Where G (using esu units) is the Newton Gravitation Constant, mₚ and mₑ are the proton and electron mass respectively, and rₑ is the classical electron radius: rₑ=e²/mₑc² and R_{H} is the Hubble radius, which is the Hubble Time T_{H} times the speed of light c: R_{H}=CT_{H}. In regards to the physical meaning of this expression, an approximate model of the Cosmos as being at Ω˜1, indicates that the universe has just nearly the critical density to be expanding at escape velocity from the universe itself.

$$Ω = \frac{8 {πGm}_{p} n {R}_{H}^{2}}{3 {c}^{2}} ≅ 1 \qquad ( 2 )$$

where n is the number density of hydrogen in space, which can be correlated to the critical optical thickness of the Cosmos, the universe is at nearly the critical density to be neither optically thick or thin, but instead is “misty”:

$${σ}_{Th} n {R}_{H} = \frac{8 π n {r}_{e}^{2} {R}_{H}}{3} ≅ 1 \qquad ( 3 )$$

where σ_{Th}=8πrₑ²/3 is the Thompson scattering cross-section for electro-magnetism radiation. Equating Eq. 2 and Eq. 3 and assuming the hydrogen in space is fully ionized Eq. 1 is derived. Therefore, the Dirac condition is consistent with the critical density of matter in the universe for gravitational interactions, being correlated with the electro-magnetism critical scattering thickness of the Cosmos. Accordingly, the Dirac relation is consistent with a Cosmos where gravity interactions are a form electro-magnetism interaction and the visible universe is both critically interacting gravitationally and electromagnetically.

Such an identification of gravity with electro-magnetism scattering must involve quantum renormalized electro-magnetism interactions at the subatomic level, because the Thompson cross section, and other so-called “classical” quantities, are products of a multitude of subatomic quantum interactions. Accordingly, a quantum numerical connection between the Cosmic and subatomic scales exists:

$$- \frac{3}{2} ln [ \frac{G {m}_{p} {m}_{e}}{{e}^{2}} ] \approx {α}^{- 1} = 137 \qquad ( 4 )$$

While the propulsion apparatus 100 is not limited to any particular electrically conducting dome 110, electrically conducting coils, 120, 130 and 140, power sources 150, rotating electromagnetic (EM) fields 160, Poynting vector vortex 170, gravity force 180 and center axis 190, for sake of clarity simplified electrically conducting dome 110, electrically conducting coils, 120, 130 and 140, power sources 150, rotating EM fields 160, Poynting vector vortex 170, gravity force 180 and center axis 190 are described.

### Estimate of Lift Per Unit of Power of Propulsion Apparatus 100 in FIG. 1

Given the vacuum Bernoulli equation:

$$\frac{{g}^{2}}{2 π G} = \frac{{S}^{2}}{{u}_{o} {c}^{2}}$$

Where g is gravity, lift is produced by perturbing the following equation:

$$\frac{dgg}{2 π G} = \frac{dSS}{{u}_{o} {c}^{2}}$$

Assuming an Invar (Fe—Ni36 alloy) disk (density 8.1×10³ kg/m³) with a set of 3 coils beneath the disk, and assuming mass per unit area of Invar is 0.24 kg/m² (0.03 mm thickness), a force of 2.4 N/m² will levitate the disk in equilibrium in reference to gravity of the Earth. Assuming the Invar layer is supported by a high strength composite disk of negligible mass.

Therefore, the lifting force due to gravity modification is:

$$\frac{dgg}{2 π G} = \frac{2.4 N}{{m}^{2}}$$

dS/u₀ can be interpreted as =Vᵣₒₜ where the power flux S is interpreted as rotational but also has a component into the Invar due to resistive losses, so that the imposed dS′ is locally parallel to the S_{g} due, to the radiation pressure striking each nucleon to create gravity, which is S_{g}/c. This is approximately, for a single proton or neutron:

$${S}_{g} / c = mg / σ$$

$$m = 1.67 \times {10}^{- 24} \to 1.67 \times {10}^{- 27} kg$$

$$σ = π {r}_{o}^{2}$$

$${r}_{o} = 1.4 \times {10}^{- 13} cm \to 1.4 \times {10}^{- 15} m$$

$$σ = π {r}_{o}^{2} = 6.15 \times {10}^{- 30} {m}^{2}$$

$${S}_{g} / c = mg / σ = 9.8 N / kg 1.67 \times {10}^{- 26} kg / 6.15 \times {10}^{- 30} {m}^{2} = 2.7 \times {10}^{4} N / {m}^{2}$$

$${S}_{g} ≅ 2.7 \times {10}^{4} N / {m}^{2} \times {v}_{e s c} , where {v}_{e s c} = 1.1 \times {10}^{4} m / sec$$

Furthermore, in estimating lifting force per unit of applied EM power, from the Vacuum Bernoulli equation:

$$\frac{{dSS}_{g}}{c} = \frac{2.4 N}{{m}^{2}}$$

$$becomes :$$

$$\frac{dS}{c} = \frac{2.4 N}{{m}^{2}}$$

Assuming the lifting force depends on the applied EM field, choosing Sg=u₀c and also assuming the EM field applied to modify the gravity field is a rotating field which at the same time diffuses into the Invar surface due to resistive losses, then:

$${u}_{ap} \frac{{V}_{rot}}{c} = \frac{2.4 N}{{m}^{2}}$$

Assuming Vᵣₒₜ=2πR f, where f=a rotation frequency of 1 kHz (f=10³/sec) and a disk radius of approximately R=30 meters, which yields a mean rotation <Vᵣₒₜ>=1×10⁵ m/sec, yielding gives <Vᵣₒₜ>/c=3.3×10⁻⁴

$${u}_{ap} = \frac{2.4 N}{{m}^{2}} = 2.4 \frac{J}{{m}^{3}}$$

Assuming an applied field of energy density of 2.4 J/m³. This is a small field so to avoid high resistive heating of the Invar disk. This corresponds to an energy density uₐₚ=½ B²/μₒ where μₒ=1.25×10⁻⁶H/m. The field strength B can be solved for:

$${B}^{2} ( T ) = 2.4 \times 2.5 \times {10}^{- 6}$$

$$B = 2.4 \times {10}^{- 3} T or 10 G$$

Assuming that 10⁻⁵ fraction of the applied field energy is absorbed every rotation the Sₐₚ vector in the vertical direction is approximately S_{ap-vertical} is 8 W/m². This the resistive energy loss of the fields used to modify gravity.

$$\frac{{B}^{2}}{2 {μ}_{0}} \times {ν}_{rot} \times {10}^{- 5} = 8 \frac{W}{{m}^{2}}$$

leading to a lifting force per unit power of approximately:

$$lifting force per unit of applied power = \frac{0.3 N}{W}$$

$$or , since 1 Ton ( metric ) = 10 , 000 N$$

$$lifting force per unit of applied power ≅ \frac{1 Ton}{33 kW}$$

This estimate of lifting power per unit of applied power compares well with that for an ultralight aircraft at lift per unit power ˜0.1 N/W˜suggesting that, in some implementations, gravity modification flight can be made all electric powered.

### Apparatus Implementations

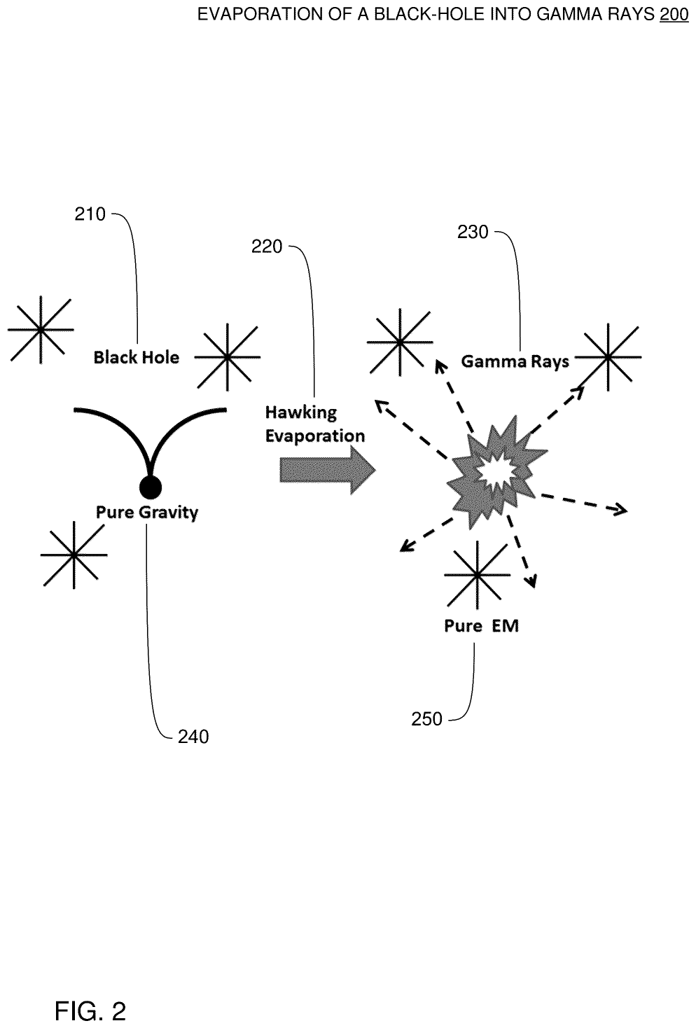

In the previous section, a system level overview of the operation of an implementation was described. In this section, the particular apparatus of such an implementation are described by reference to a series of diagrams in FIGS. 2-34.

FIG. 2 is a diagram 200 of evaporation of a black-hole into gamma rays, according to an implementation. Diagram 200 shows that gravity consists of electro-magnetism. Given the additional insight from Hawking, who showed that black-holes 210 (in the context of a quantum vacuum) are unstable to evaporation 220 into matter-antimatter and from there into thermal gamma rays 230, and by extension, entropy. Based on the idea of conservation of physical quantities, what emerges is a reflection of what lies within. Accordingly, an object of pure gravitational field energy 240 can turn into pure electro-magnetic energy 250 plus entropy. Intuitively, this again shows a fundamental connection between gravity 240 and electro-magnetism 250 can be made.

### A Physical Model of Electro-Magnetic Gravity and Spacetime

Section 1. The Synthesis of a Basic Gravity Field from Electro-Magnetism

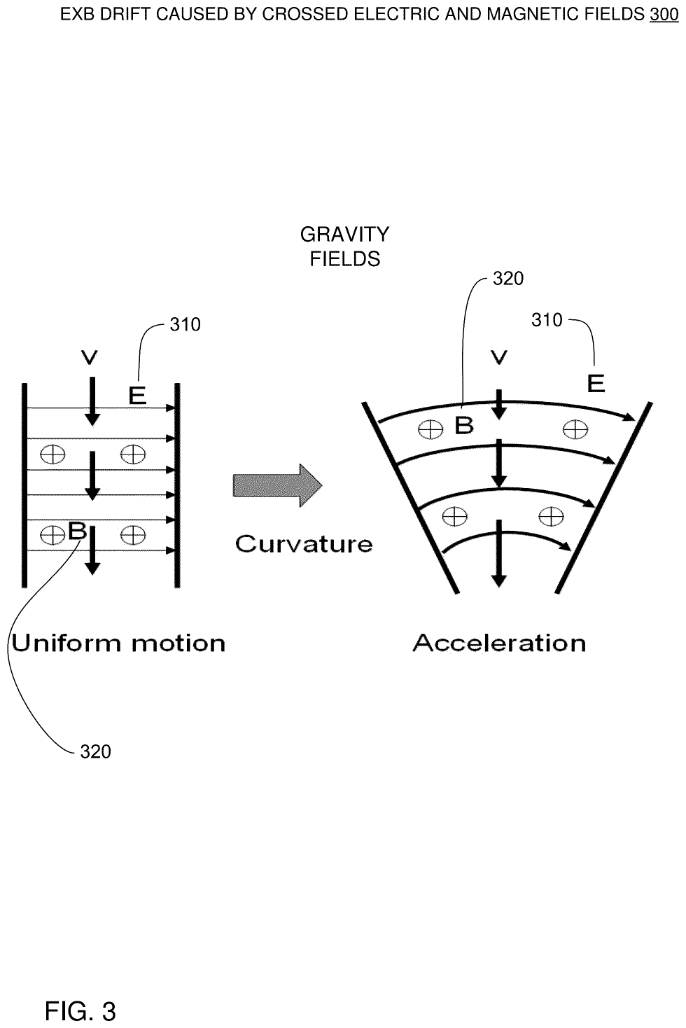

FIG. 3 is a diagram 300 of the E×B drift caused by crossed electric and magnetic fields, according to an implementation. Diagram 300 shows that all charged particles identically and in non-uniform E fields 310, but uniform B fields 320, can cause acceleration.

The concept for a synthesis of a gravity field from electromagnetism is the outgrowth of the effort to achieve controlled thermonuclear fusion, most specifically the magnetic confinement of plasmas for fusion. An effect called an “E-cross-B drift” or E×B drift is identified.

The E×B drift is remarkable in that the E×B drift affects all charged particles identically regardless of charge or mass. This model of a gravity field can be derived by first assuming uniform E 310 and B 320 fields at right angles to each other, as in FIG. 3, for example, Eₓ and B_{z} in the x and z directions respectively. Accordingly for motion of a charged particle in the x and y directions or r, θ, using esu units:

$$m \frac{\partial {V}_{x}}{\partial t} = q {E}_{x} + \frac{{V}_{y}}{c} {B}_{z} \qquad ( 1. )$$

$$m \frac{\partial {V}_{y}}{\partial t} = q {E}_{y} - \frac{{V}_{x}}{c} {B}_{z} \qquad ( 1.1 )$$

Where E_{y} is included for a curvilinear E field 310, this is solved by assuming a velocity function of two parts, in x and y coordinates. The simplification that Eₓ>>E_{y}, shows a particle at the center of the region between the two plates.

$$V = {V}_{o s c} + {V}_{d} \qquad ( 1.2 )$$

$${V}_{d} = \frac{c {E}_{x}}{{B}_{z}} \qquad ( 1.3 )$$

$${V}_{o s {c}_{y}} = {V}_{⊥} ( sin {ω}_{c} t ) \qquad ( 1.4 )$$

$${V}_{o s {c}_{x}} = {V}_{⊥} ( cos {ω}_{c} t ) \qquad ( 1.5 )$$

Where V_{⊥} is assumed to be a constant with V_{⊥}≤V_{d} accordingly

$${ω}_{c} = eB / mc \qquad ( 1.6 )$$

As a result, in general for the average motion of the particle. Note this drift velocity shown in Eq. 1.4 is independent of charge and mass.

When the magnetic field is uniform and the E field 310 is varied at right angles to the magnetic field, in the direction of the drift, the particle will experience an acceleration in the direction of the E×B drift^{Klein} of the particle:

$$\frac{\partial {V}_{d}}{\partial t} = \frac{{c}^{2} {E}_{x}}{{B}_{z}^{2}} \frac{\partial {E}_{x}}{\partial y} = \frac{\partial ϕ}{\partial y} \qquad ( 1.7 )$$

$$ϕ = ( {\frac{1}{2} [ \frac{{E}_{x}}{{B}_{z}} ]}^{2} {c}^{2} ) \qquad ( 1.8 )$$

The energy source for this acceleration is the E field 310, whose variation in the direction of drift leads to a small “polarization drift” Vₚ increment of velocity for the particle in the direction of the E field 310 during each gyro-period.

$${V}_{p} = \frac{c}{{ω}_{c} {B}_{z}} \frac{{dE}_{x}}{dt} = \frac{{c}^{2} {E}_{x}}{{B}_{z}^{2} {ω}_{c}} \frac{\partial {E}_{x}}{\partial y} \qquad ( 1.9 )$$

$$m \frac{\partial {V}_{d}}{\partial t} = \frac{q}{c} {V}_{p} {B}_{z} \qquad ( 1.1 )$$

$$m \frac{\partial {V}_{d}}{\partial t} = \frac{q}{c} {B}_{z} \frac{{c}^{2} {E}_{x}}{{B}_{z}^{2} {ω}_{c}} \frac{\partial {E}_{x}}{\partial y} = m \frac{\partial ϕ}{\partial y} \qquad ( 1.11 )$$

For the case of a time varying Eₓ field, an acceleration of the particles is:

$$\frac{\partial {V}_{d}}{\partial t} = \frac{c}{{B}_{z}} \frac{\partial {E}_{x}}{\partial t} \qquad ( 1.12 )$$

$${V}_{p} = \frac{c}{{ω}_{c} {B}_{z}} \frac{\partial {E}_{x}}{\partial t} \qquad ( 1.13 )$$

$$m \frac{\partial {V}_{d}}{\partial t} = \frac{q}{c} {B}_{z} \frac{c}{{ω}_{c} {B}_{z}} \frac{\partial {E}_{x}}{\partial t} \qquad ( 1.14 )$$

The electric field vanishes in the guiding center frame of the accelerating particle because of the Lorentz frame shift:

$$- {E}_{x} = \frac{{V}_{d}}{c} {B}_{z} \qquad ( 1.15 )$$

Therefore, for either the case of a time varying E field 310 or spatially varying E field 310 with a uniform B field 320 at right angles to the E field 310, a field of acceleration of charged particles can be achieved that is independent of the charge and mass of the charged particles and therefore satisfies an equivalence principle. Such a field of acceleration mimics a gravity field in the limit of B and E being both very strong, but with E/B<1. The source of energy for this acceleration is the variation of the E field 310, which the charged particle samples while undergoing cyclotron motion in the uniform B field 320.

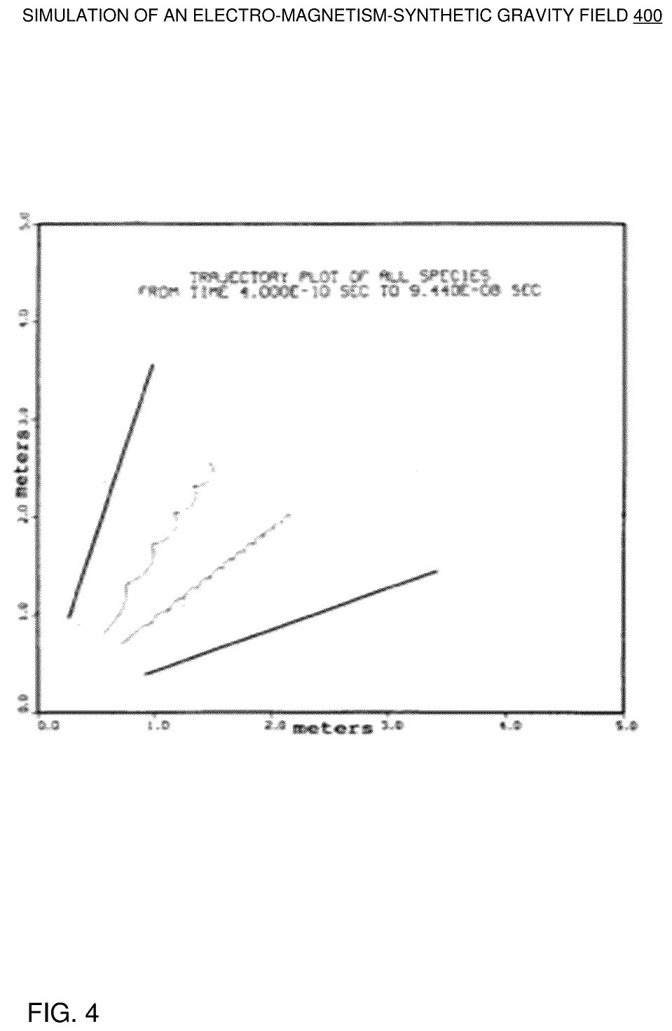

FIG. 4 is a diagram 400 of a simulation of an electro-magnetism-synthetic gravity field, according to an implementation. Diagram 400 shows trajectories of an electron and a “heavy positron” of 10× an electron mass. A synthetic gravity field can be achieved in a laboratory by the arrangement of two parallel plates at different potentials, with a uniform magnetic field parallel to the surfaces of the two parallel plates. The synthetic gravity field will cause charged particles to drift at right angles to the resulting E and B fields, a time variation of the voltage difference, or the setting of the plates at an angle to each other results in the field of acceleration.

This is easily confirmed by a particle simulation where an electron and a ‘heavy positron’ of positive charge but 10× the mass of electron are released in uniform magnetic field but between two plates set at an angle between each other, as seen in FIG. 4.

Written in terms of the Poynting vector, S=cE×B/4π (in esu), the E×B drift can be expressed as:

$${\vec{V}}_{d} = c \frac{\vec{E} \times \vec{B}}{{B}^{2}} = \frac{\vec{S}}{( {B}^{2} / 4 π )} \qquad ( 1.16 )$$

This arrangement works well in a laboratory for individual charged particles moving in a vacuum, however. Furthermore, this laboratory model corresponds to real life gravity fields moving macroscopic objects because for strong enough E and B fields, all charged particles will behave as single particles, ignoring the fields of other particles in first approximation. Furthermore, the strong E and B fields in the vacuum exist that would make this physical model of gravity be consistent with GR (General Relativity), presently the most advanced and verified theory of gravity. To apply this model of gravity around a planet, considering that spacetime is cellular in microstructure and hosts an array of E×B drift regions, vacuum spacetime is a simultaneously ferro-electric and ferro-magnetic material. For this model of gravity fields to be consistent with GR, spacetime must be a fabric of powerful electric and magnetic fields.

### Section 2. Electro-Magnetic Spacetime

A physical model of gravity fields can be composed of locally uniform magnetic and varying electric fields. Flat spacetime can be conceived of as being composed of uniform magnetic and electric fields. But the vacuum is observed to be massless, or even to have a tiny negative mass density. To be consistent with GR, the mass density of the very E and B fields causing gravity must be considered as a source of gravity. This problem is not unique to the unification of gravity and electromagnetism but is a pressing problem for any theory of a quantum vacuum.

Einstein discovered the ZPF (Zero Point Fluctuation) in 1910, showing that as a consequence of the Heisenberg Uncertainty principle the vacuum must be populated with an electro-magnetism modes. The physical presence of these modes can be seen in the existence of the Casimir Effect. However, the fact that these modes do not create an observable mass-energy density in the vacuum is one of the great mysteries of physics. This problem was considered by the great Russian physicist Yakov Zeldovich who argued that a ZPF mass density term would appear as a Cosmological Constant term, allowed by General Relativity, and that another such term existed to cancel the ZPF term. The Zeldovich Cancelation term would then be required for a massless vacuum. The basic field equation for GR including the Cosmological Constant A is:

$${R}_{νμ} - \frac{1}{2} {g}_{νμ} R = \frac{8 π G}{{c}^{4}} {T}_{ν μ} - Λ {g}_{ν μ} \qquad ( 1.17 )$$

$$\frac{8 π G}{{c}^{4}} {T}_{ν μ} - Λ {g}_{ν μ} = 0 \qquad ( 1.18 )$$

Considering the concepts of Sahkarov, in gravity's relationship to the electro-magnetism ZPF, and the Kaluza-Klein theory of electro-magnetism-gravity unification, and the relationship of the Kaluza-Klein theory of electro-magnetism-gravity unification to a hidden 5^{th} dimension and the Hilbert action principle in four spacetime dimensions with a zero cosmological constant, it can be determined that:

$$W = {( 16 π G )}^{- 1} \int R \sqrt{- g} d {x}^{4} \qquad ( 1.19 )$$

where R is the Curvature Scalar. Finding the extremum of the Curvature Scalar leads to the vacuum gravity equations with canceled ZPF electro-magnetism fields.

$${R}_{v μ} - \frac{1}{2} {g}_{v μ} R = 0 \qquad ( 1.2 )$$

Sakharov interpreted the integrand as a real energy density. Sakharov equated the real energy density to a perturbed quantum electro-magnetism ground state spectrum of ZPF (Zero Point Fluctuation) due to the Heisenberg Uncertainty principle applied to the vacuum electro-magnetism field. The zero'th-order ZPF is assumed to vanish due to a canceling cosmological constant term proposed by Yakov Zeldovich, who was a colleague of Sakharov's. This “Zeldovich Cancelation” ensures that only the perturbations due to curved space cause the effect of the ZPF to appear. Sakharov calculated the perturbed part of the ZPF due to spacetime curvature. He then derived a formula for G in terms of an integral over the perturbed ZPF:

$$W = {G}^{- 1} ≅ \frac{ℏ}{2 {c}^{5}} {\int }_{O}^{{ω}^{*}} ω d ω = \frac{{ℏω}_{P}^{2}}{{c}^{5}} \qquad ( 1.21 )$$

$$G ≅ \frac{{c}^{3} {r}_{P}^{2}}{ℏ} = \frac{{c}^{4}}{{r}_{P}^{2} {T}_{o}} \qquad ( 1.22 )$$

where ω_{P} is the Planck frequency c/r_{P}, where r_{P}=(G [symbol] /c³)^{1/2} and the energy density Tₒ= [symbol] c/r_{P}⁴ is the Planck scale energy density. This is consistent with a physical model of gravity forces as due to imbalances of the electro-magnetism Poynting vector, S=cE×B/4π (in esu) or a radiation pressure P=<S>/c. The second example of radiation pressure or Poynting vector acting on particles in a box whose wall absorb and emit radiation is shown in FIG. 4. In FIG. 4, the left figure shows hot-bright particles in a dark-cold enclosure, the right figure shows cold-dark particles in a hot-bright enclosure. Mutual radiation pressure forces are shown by block arrows.

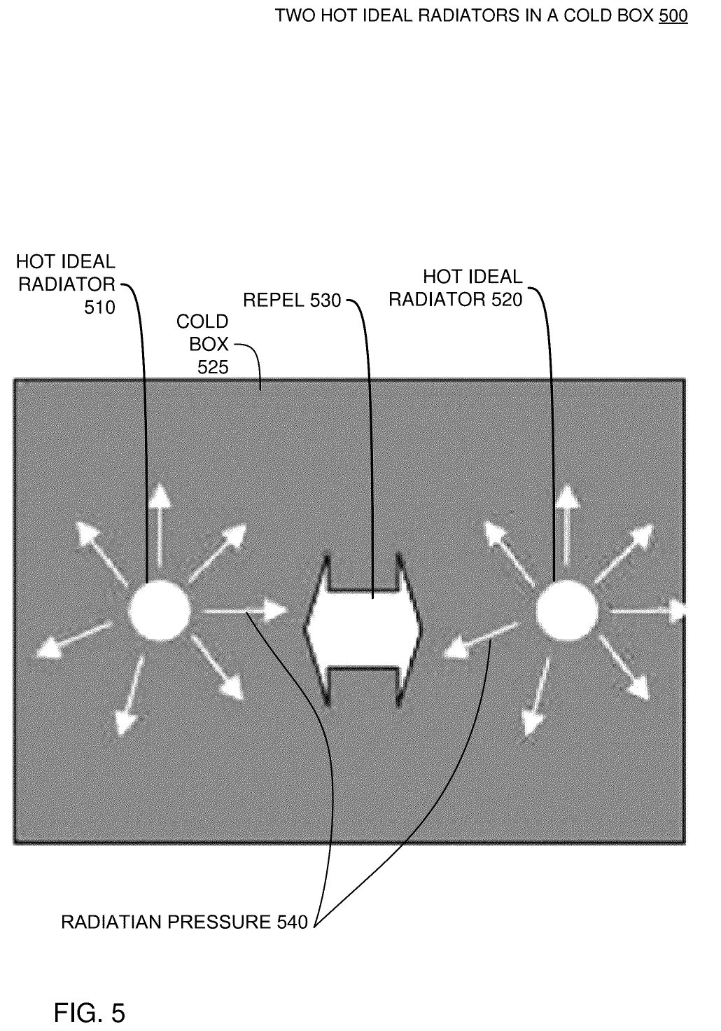

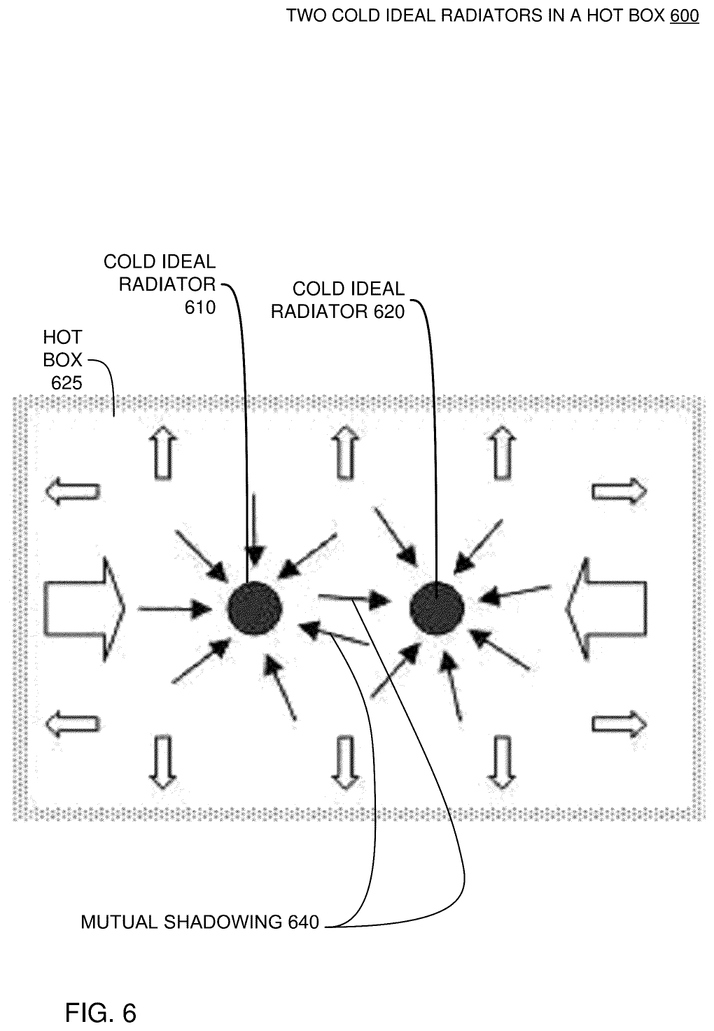

FIG. 5 is a diagram 500 of two hot ideal radiators in a cold box, according to an implementation. In FIG. 5, two ss 510 and 520 in a cold box 525 repel 530 each other by mutual radiation pressure 540. FIG. 6 is a diagram 600 of two cold ideal radiators 610 and 620 in a hot box 625, according to an implementation. In FIG. 6, the two cold ideal radiators 610 and 620 in a hot box 625 attract each other due to mutual shadowing 640.

Radiation Pressure Affecting Particles in an Enclosure. As was shown above, an E×B or Poynting drift field, with constant B and E growing stronger in the direction of the drift, can produce gravitational-like acceleration of charged particles of all charges and masses, as shown in FIG. 3. The Sakharov model for the gravitational force is basically that of a radiation pressure Poynting field produced by non-uniformities in the ZPF and is successful in the sense that is self-consistent (see FIG. 5 and FIG. 6). Sakharov arrived at this physical model for gravity because he worked on the Soviet Hydrogen Bomb where radiation pressure is crucial. The same idea can be derived, in relativistic-covariant form, where the zeroth-order ZPF stress energy is caused to vanish. The Zeldovich Cancelation is explained as electro-magnetism-gravity unification physics. The following equations show this theory in covariant form. If the metric tensor for gravity is written as a normalized first part of the electro-magnetism momentum-stress tensor:

However, if the fundamental structure of spacetime is electro-magnetic can be expressed

$${g}_{α β} = \frac{4 {F}_{α}^{γ} {F}_{γβ}}{{F}_{μ γ} {F}^{μ γ}} \qquad ( 1.23 )$$

the metric tensor as an electromagnetic tensor:

For the case of statistically uniform isotropic vacuum fields, the elements of the gradient of the metric will vanish.

When expression 1.23 is used, the electro-magnetism stress tensor for the ZPF can be made to vanish.

Assuming isotropy, the unification of gravity and electromagnetism metric tensor is:

$${T}_{a β} = {F}_{α}^{γ} {F}_{γβ} - {g}_{a β} \frac{{F}_{μ γ} {F}^{μ γ}}{4} = 0 \qquad ( 1.24 )$$

$${g}_{a β} = {2 [ {B}^{2} - {E}^{2} ]}^{- 1} ( \begin{matrix}- {E}^{2} & 0 & 0 & 0 \\ 0 & {E}_{x}^{2} - {B}_{y}^{2} - {B}_{z}^{2} & 0 & 0 \\ 0 & 0 & {E}_{x}^{2} - {B}_{y}^{2} - {B}_{z}^{2} & 0 \\ 0 & 0 & 0 & {E}_{x}^{2} - {B}_{y}^{2} - {B}_{z}^{2}\end{matrix} ) \qquad ( 1.25 )$$

Assuming a model of spacetime containing adjacent regions of strong E or B fields, the particles travel as wave packets and sample a volume swept out by a wave-front, thus the particles have an average spacetime. An average over volume so that <B²>=<E₂> and <E·B>=0 results in a volume average of two metric forms one dominated by electric flux, for instance, in its local direction E_{y}

$${g}_{α β} = [ \begin{matrix}2 & 0 & 0 & 0 \\ 0 & 0 & 0 & 0 \\ 0 & 0 & - 2 & 0 \\ 0 & 0 & 0 & 0\end{matrix} ] \qquad ( 1.26 )$$

And another, in an adjacent region, by magnetic flux also in B_{y}

$${g}_{α β} = [ \begin{matrix}0 & 0 & 0 & 0 \\ 0 & - 2 & 0 & 0 \\ 0 & 0 & 0 & 0 \\ 0 & 0 & 0 & - 2\end{matrix} ] \qquad ( 1.27 )$$

Upon volume average, assuming large scale isotropy, The familiar Lorentzian flat space metric can be recovered as follows:

$$< {g}_{αβ} > = [ \begin{matrix}1 & 0 & 0 & 0 \\ 0 & - 1 & 0 & 0 \\ 0 & 0 & - 1 & 0 \\ 0 & 0 & 0 & - 1\end{matrix} ] \qquad ( 1.28 )$$

Using the observation that for nearly flat spacetime, gravity fields and potentials of the gravity field are linearly additive, the effective gravity potential for the E×B drift model of gravity can be derived, assuming the electro-magnetism form of the metric tensor required for self-censorship. The upper left diagonal element of the metric tensor can be determined as follows: gₒₒ, and from the upper left diagonal element of the metric sensor, the effective Newtonian gravity potential can be determined.

Accordingly for perturbing fields and a gravity potential in terms of an E×B drift model of gravity that is valid for both DC and oscillating E fields, where charged particles are accelerated into the strongest part of the perturbing E field. To determine how the Newtonian gravity potential occur between charged particles starting with the expression for a gravity potential in terms of E and B fields in the vacuum, where V_{D} is the particle drift velocity in the crossed E and B fields:

$$< {g}_{00} > = 1 + 2 ϕ / {c}^{2} ≅ \frac{- {E}^{2}}{{B}^{2} - {E}^{2}} , {E}^{2} = {E}_{x}^{2} \qquad ( 1.29 )$$

Obtaining from the unification of gravity and electromagnetism metric tensor to first order in Eₓ/B_{z}<<1 and averaging with a flat metric.

$$- 1 - 2 ϕ / {c}^{2} = - \frac{{E}_{x}^{2}}{{B}^{2}} \qquad ( 1.3 )$$

Obtaining the Newtonian potential as the perturbing E electric energy density divided by the more powerful magnetic field:

$$ϕ = \frac{1}{2} \frac{{E}_{x}^{2}}{{B}_{o}^{2}} {c}^{2} + \frac{1}{2} {c}^{2} \qquad ( 1.31 )$$

Accordingly, the E×B drift model of gravity and spacetime requires cells of very strong E and B fields to be present in space time, as part of the ZPF, yet not be visible directly. This is found to be consistent, in this example, with the form of the unification of gravity and electromagnetism metric tensor that is required to self-censor the ZPF. Below, the E×B drift model of gravity and spacetime leads to the Schwartzchild metric for point masses to exist around charged particles in the vacuum. But first, the apparent cellular nature of spacetime must be investigated, that is: the fact that scale invariance of the vacuum is broken in such a way as to favor the production of hydrogen from the vacuum during the Big Bang.

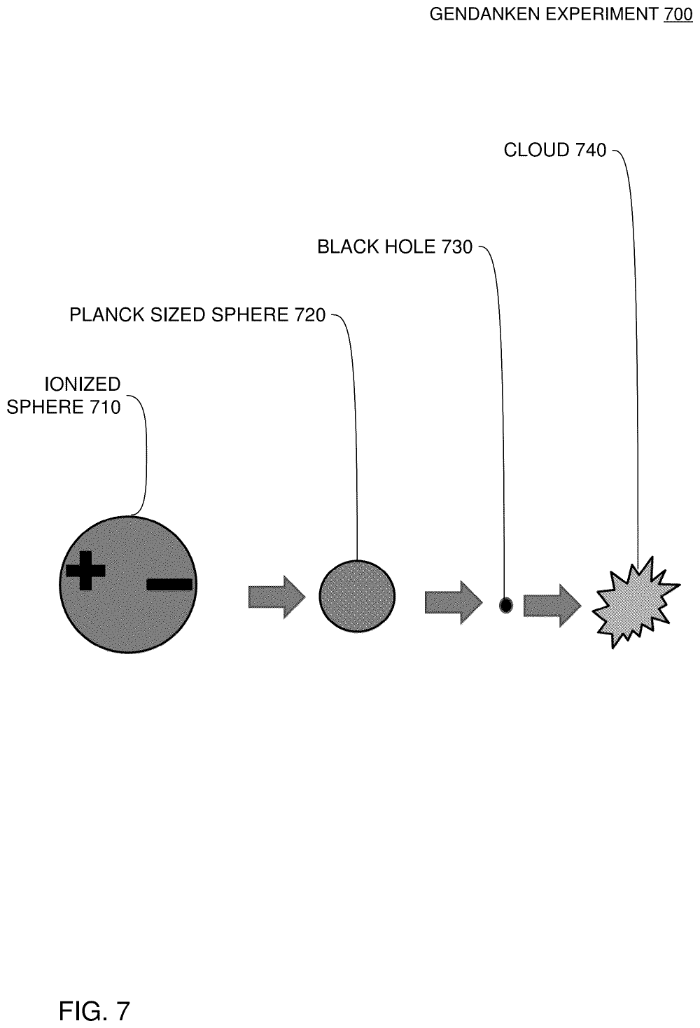

FIG. 7 is a diagram 700 of a Gendanken experiment, according to an implementation. The Gendanken experiment in FIG. 7 yields the Gravitation Constant and Proton Mass from the Planckian Vacuum. In the Gedanken experiment in FIG. 7, a single atom of hydrogen, a proton and an electron, is shrunk within a sphere, ionizes into an ionized sphere 710, becomes a Planck sized sphere 720, which becomes a black hole 730, whereupon, the black hole 730 undergoes hawking evaporation and becomes a cloud 740 of gamma rays, matter and antimatter so that original hydrogen is lost.

### Section 1. A Gedanken Experiment

In a “Gedanken” experiment, a single atom of hydrogen is confined in a sphere whose size is shrunk continuously until the sphere reaches approximately the radius of a Planck length r_{P}=( [symbol] G/c³)^{1/2}, 710 and 720. At this point the electron and proton making up the hydrogen will have long since ionized and increased in mass due to Heisenberg Uncertainty. The proton and electron will then form a Black Hole 730 which will then undergo Hawking Evaporation (FIG. 7) into a cloud 740 of photons, particles and anti-particles of the particles. The Hawking evaporation will destroy the baryon and lepton number of the proton and electron, leaving only the quantum numbers of the vacuum, which is in accordance with the observation that many of the quantities observed in the present day cosmos are “running constants” and change under radically smaller spacetime curvature, to merge eventually with Planck Scale quantities. Therefore, physical constants may be tied to a specific range of scale-size for the radius of curvature of spacetime, and these physical quantities will change dramatically when the radius of curvature approaches the Planck Scale.

Above, gravity fields are formulated as electro-magnetic, but this appeared to require a cellular nature for spacetime, in order to allow gravity fields, and spacetime, to be composed of regions of powerful electric and magnetic fields. At first, such a physical picture seems perfectly consistent with the concept of the Planck Scale, where spacetime is a foam of scale size equal to the Planck Length: r_{P}=(G [symbol] /c³)^{1/2}. However, at the Planck scale only a limited group of physical constants are possible and these do not include many of those constants that describe the universe experienced by us. The primordial first instants of the Big Bang the entire universe can be understood as in a compressed state at the Planck Scale but that the primordial first instants of the Big Bang the entire universe expanded from this scale to “deploy” a new larger scale that carried with the entire universe, the physics of the cosmos we experience now. Therefore, the concept of cellular spacetime must be further quantified to define a range of scale size for a cellular structure in spacetime that is distinct from the Planck Scale and represents an expanded scale that emerges from that primordial scale.

Thus, based on the Gedanken experiment, any cellular scale size in the vacuum is “fully deployed” to proper size of the cellular scale size in the vacuum in the present cosmos, and helps determine its physics, but this scale size is crushed out of existence at the Planck scale, where hydrogen disappears. Accordingly, Gedanken experiments that squeeze a proton-electron pair into the vacuum, also squeezes the cellular scale-size into the Planckian vacuum.

Assuming that the wave functions of the proton and electron, carrying with the proton and electron all identifying quantum numbers the proton and electron have merged as the Black Hole 730 forms at the Planck Scale, then the radius of spacetime local spacetime curvature r→r_{P} before this happens. To model this behavior, a U(1) symmetry model for the proton and electron masses can be used, considering that since all information disappears, the model can be formulated only in terms of charge q, mass m, and mass ratio mₚ/mₑ=σ. Accordingly a U(1) mass model is obtained as follows:

$$m = {m}_{o} cos ( ϕ ) + {im}_{o} sin ( ϕ ) \qquad ( 2.1 )$$

The U(1) symmetry is complex valued with real and imaginary mixed together. Particles with imaginary rest masses are tachyons, particles that move faster than light. The simplest physical interpretation that can be made for such imaginary particles is that the tachyons are particles that have fallen inside the event horizon of a Black Hole, accelerating beyond the speed of light in the process and being out of communication with the real particles of the universe. This is important at the Planck scale because their particles appear out of the vacuum, form black holes and disappear, so that spacetime is effectively a “foam.” Foamy spacetime features Black Holes that are so closely packed that determining whether a particle is inside or outside an event horizon is possible. Thus particles at the Planck scale can be physically represented as complex, half real and half imaginary, with masses satisfying a U(1) symmetry. So the Planck scale is completely chaotic, mixing imaginary masses with real ones.

At the Planck scale, everything becomes simple, the electro-magnetism and gravity forces unify to one force obeying U(1) symmetry and Lepton and Baryon number also disappear, in fact everything disappears but “vacuum” quantities: G, c, and ℏ, the Newton gravitation constant, the speed of light, and the rationalized Planck's constant respectively. These determine the Planck Length: r_{P}=(G [symbol] /c³)^{1/2}. Planck mass M_{P}=( [symbol] c/G)^{1/2}, and Planck charge q_{P}=( [symbol] c)^{1/2}. However, assuming also that since electro-magnetism forces still exist and enforce quantization of charge and the charge neutrality of the vacuum, so that quarks remain grouped in groups of 3 having one positive electron charge to cancel the charges of electrons. Thus, a plasma consisting of quarks and electrons occurs at the Planck scale but protons, are still identifiable as groups of quarks because the vacuum must be charge neutral.

Therefore, at the Planck scale, Planck masses of real and imaginary masses consisting of a quark-electron plasma can be represented as relativistic mass-dilated electrons and protons because of the requirement of charge neutrality.

On the end of the spectrum of sizes, assuming a “fully deployed” cellular scale of subatomic size, can be of the size range:

$${r}_{o} = \frac{{e}^{2}}{{m}_{o} {c}^{2}} \qquad ( 2.2 )$$

where mₒ=(mₚmₑ)^{1/2}, so that the size scale is neutral between protons and electrons, and a size parameter is determined entirely by low energy physics quantities. This energy and size scale is the “mesoscale” because the mesoscale lies between the Planck Scale and the Cosmic Scale.

The is Gendanken experiment based on the unification of gravity and electromagnetism postulate that baryon and lepton number disappear at the Planck scale coincidentally with the separate identity of Gravity and electro-magnetism fields. The vacuum is thus as simple as possible at the Planck scale, only particles and anti-particles of Planck mass and charge exist there.

In contrast the appearance of the cellular scale size as the universe expands from the Planck scale represents the appearance of a new degree of freedom. This is similar to when a molecular layer evaporates from a surface and becomes a 3-dimensional gas. Accordingly, that the expansion from the Planck Scale allows the appearance of a 5^{th} dimension, represented by the appearance of a new scale size: rₒ, which is the appearance of particles: electrons and protons with the classical radii of the protons and electrons. That is, the appearance of the 5^{th} dimension allows the appearance of the mesoscale. The expansion of the universe from the Planck Scale thus allows a new 5^{th} dimension, a new degree of freedom, of much larger scale size than the Planck Scale, to appear, and with the new 5^{th} dimension, a new physics appears, which is included into the U(1) mass model as follows:

The angle φ, in this model, corresponds to charge state and is thus quantized as a canceling pair±φₒ, even in the Planck Scale. However let us model the appearance of the fifth dimension by allowing this angle to become an imaginary rotation angle to give two real particle masses corresponding to an “up” quantum state and “down” quantum state from the U(1) symmetry. Assuming a model of a scale dependent vacuum where the existence of a 5^{th} dimension breaks the vacuum scale invariance, the mass model is:

$$m = {m}_{o} exp ( \pm {ϕ}_{0} ) \qquad ( 2.3 )$$

Where φ is a parameter such that φ=0 when the 5^{th} dimension does not exist and φₒ=1 when the 5^{th} dimension is “fully deployed” and separate particle masses are generated at do from Eq. 2.3 at r→rₒ

$${( \frac{{m}_{p}}{{m}_{e}} )}^{1 / 2} = exp ( {ϕ}_{0} ) = σ \qquad ( 2.4 )$$

Where σ is a mass asymmetry parameter, being the square root of the mass ratio of the electron to the proton.

Thus, even though mass symmetry is broken in terms of the new 5 space we experience, mass symmetry is preserved in terms of a geometry involving the imaginary angles in the original U(1) symmetry. That is, the new particle dimension looks symmetric in the space of imaginary angle.

Requiring that this e mass model, shows the behavior as mₒ→M_{P}, σ→1 as r/r_{P}→1

To obtain a smooth transition to the Planck scale as curvature collapses to the Planck length the angle φₒ must be dependent on curvature near the Planck length but very insensitive to the angle at larger curvatures, where the new fifth dimension is fully deployed. Based on the lack of observation of proton decay, lepton and baryon numbers are strongly conserved. The simplest model to obtain this mixture of scale sensitivity with curvature r is for the rotation angle to have the dependence on our 5^{th} dimensional deployment parameter

$$ϕ ≅ ln ( σ ) \qquad ( 2.5 )$$

$$σ ≅ ln ( r / {r}_{P} ) \qquad ( 2.6 )$$

So that lepton and baryon numbers disappear, with σ→1 as r→r_{P}

Therefore, in the unification of gravity and electromagnetism, the separate appearance of proton and electron pairs from the vacuum is, like the separate appearance of electro-magnetism and gravity forces, linked to the appearance and full development of the fifth dimension. The physical description of this new 5^{th} dimension coming into being at scale size that corresponds to the size of a particle classical radius rₒ.

However, formula 2.6 cannot be correct near r=r_{P} where σ→1, thus the formula 2.6 must be modified slightly so that both the right and left side go to zero smoothly at r=r_{P} and σ=1, where σ can be assumed to go to one with the vanishing of a small parameter ε→0

$$σ = 1 + ε \qquad ( 2.7 )$$

Eq. 2.6 can be re-written:

$$ln ( r / {r}_{P} ) = σ - \frac{1}{{σ}^{2}} \qquad ( 2.8 )$$

Note both sides of this expression now to zero as both quantities r/r_{P} and σ→1. The correction factor is added as second order in σ, that is σ⁻²=mₑ/mₚ to be similar to the reduced mass correction of the conventional dynamics of the electron-proton system. Therefore, when the new 5^{th} dimension is “fully deployed”, where σ=42.8503

$$ln ( {r}_{o} / {r}_{P} ) = σ - \frac{1}{{σ}^{2}} \qquad ( 2.9 )$$

Note how both sides of this expression go to zero with leading order in ε, as r/r_{P}→1:

$$ln ( r / {r}_{P} ) = σ - \frac{1}{{σ}^{2}} ≅ 3 ε \qquad ( 2.1 )$$

Correcting the mass formula so that mₒ=M_{P} at the Planck scale, using the Planck charge q_{P} and assuming that the normalized charge state assumes the role of determining mass q/e, but as r=r_{P} is approached, that e→q_{P}=( [symbol] c)^{1/2} so that α→1 and also all masses approach the Planck mass mₒ→M_{P}:

$$m = {m}_{o} exp ( \frac{\pm q}{e} ln σ ) \qquad ( 2.11 )$$

This formula gives the observed mass difference between the electron and proton and also ensures that this difference disappears as r/r_{P}→1. However, not only mass the mass difference disappear but the mass mₒ must undergo the process mₒ→M_{P}, as σ→1. Therefore extending this formula, where normalized charge controls mass, to obtain:

$${m}_{o} ≅ {M}_{P} exp ( \frac{{q}^{′}}{e} ln σ ) \qquad ( 2.12 )$$

Where this gives the proper limit as mₒ→M_{P}, σ→1.

However, the condition mₒ→M_{P} is required, further requiring the condition that r, r_{P}, mₒ and M_{P} have the proper quantum relationship rₒ= [symbol] /(mₒc) so that near the Planck scale:

$$ln ( \frac{{m}_{o} {r}_{P}}{{M}_{P} {r}_{o}} ) = ln ( \frac{{m}_{o}}{{M}_{P}} ) + ln ( \frac{{r}_{o}}{{r}_{P}} ) = - 3 ε + 3 ε = 0 \qquad ( 2.13 )$$

Eq. 2.13 behavior is obtained in ε for the mₒ system by modifying Eq. 2.12, as in the σ expression in Eq. 2.6, with a second order term α to ensure the proper behavior for mₒ, as α⁻^{½} and σ→1

$$m = {M}_{P} exp ( - ( {α}^{- 1 / 2} + α + 1 ) ln σ ) exp ( ( q / e ln σ ) \qquad ( 2.14 )$$

This requires, at normal spacetime curvature and charge state q/e=+1 the expression for the proton mass, with M_{P}=2.17645×10⁻⁵ g:

$${m}_{p} = {M}_{P} exp ( - ( {a}^{1 / 2} + a ) ln σ ) = 1.6 \; 665 \times {10}^{- 24} g \qquad ( 2.15 )$$

This expression agrees with the observed rest mass of the proton 1.67262×10⁻²⁴ g, to 3.6 parts per thousand and goes to the proper limit of mₚ=M_{P} as σ→1.

In regards to primary expression relating normalized spacetime curvature to the mass ratio, the expansion of the effective curvature to rₒ, which can be termed the “mesoscale” radius-since the expansion of the effective curvature to rₒ is the range of scales of classical particle radii and lies between the Planck and Cosmic scales-then yields, by Eq. 2.9 the relation:

$$ln ( {r}_{o} / {r}_{P} ) = σ - \frac{1}{{σ}^{2}} = 42.8 \; 50 … . \qquad ( 2.16 )$$

If the ratio of the mesoscale radius to the Planck radius is examined, the ratio is then also known as a quantum normalized ratio of coupling constants between gravity and electro-magnetism,

$${r}_{o} / {r}_{P} = \sqrt{\frac{{e}^{2} α}{G {m}_{o}^{2}}} \qquad ( 2.17 )$$

Equation 2.17 shows that the gravitational interaction between two masses is mediated by the emission and absorption of electro-magnetism photons. This is as expected if both electro-magnetism and gravity were both part of the same general phenomenon. The formula of Eq. 2.16 can be inverted to find an accurate expression for the gravitation constant.

The gravity constant can be obtained using the measured value of the proton electron mass ratio, to first order:

$$G = ( {e}^{2} / {m}_{p} {m}_{e} ) α exp ( - 2 ( σ - 1 / {σ}^{2} ) ) = 6.67384 \times {10}^{- 8} dyne - {cm}^{2} - {g}^{- 2} \qquad ( 2.18 )$$

this expression is within 3.6 parts per 100 thousand of the measured value of G:

6.67408×10⁻⁸ dyne-cm²gm⁻². Note that the expression gives proper limiting behavior at the Planck scale, yielding G even as all masses go to M_{P}, e²→ℏc and α and σ→1.

Therefore, a mass model, bridging the lepton-baryon mass system at its lowest energy end-members the electron and proton, that fulfills the expectation of our Gedanken experiment and has proper limiting behavior at both the Planck scale and scale of the fifth dimension, which is the subatomic scale, yields accurate expressions for both the proton mass and the gravitation constant.

A formula similar to Eq. 2.18 was originally published in approximate form in 1987 and corrected in 1988 and bears some resemblance to the formula published by T'Hooft based on “Instanton” theory that combines Hawking Evaporation with thermal physics.

Section 2. Particles from the Vacuum: The Unification of Gravity and Electromagnetism

The vacuum quantities associated with the Planck scale are:

$${r}_{P} = \sqrt{\frac{G ℏ}{{c}^{3}}} \qquad ( 2.19 )$$

$${M}_{P} = \sqrt{\frac{ℏ c}{G}} \qquad ( 2.2 )$$

$${q}_{v} = \sqrt{ℏ c} \qquad ( 2.21 )$$

The simplest concept that can be taken away from the mass formula of Eq. 2.14 then would use the vacuum derived “Planck Charge” qₚ as the controller of mass, from which the proton mass is obtained as the simplest result.

Considering other constraints to such a theory. In considering the reverse problem of particles emerging from the vacuum as opposed to the Gedanken concept of the particles merging with the vacuum, the proton cannot appear by itself, the proton must appear with another particle of opposite charge to preserve electric neutrality, however the particle cannot be just an antiparticle. In particular, the appearance of one particle does not increase entropy in the universe, because entropy requires complexity. So the same mass formula allowing the appearance of a proton must also allow the appearance of an electron to balance the proton and to maximize entropy. Therefore, the proton must appear as part of a system that includes the electron, so that hydrogen results:

$${q}_{p} = - {q}_{e} \qquad ( 2.22 )$$

$$\begin{matrix}{q}_{p} = e , & - e = {q}_{e}\end{matrix} \qquad ( 2.23 )$$

Another constraint occurs because the spacetime occupied by a particle in the vacuum initially cannot be simply a distance, but must be a spacetime interval. In the vacuum state all particles must be masses and move at the speed of light and have a spacetime interval of zero:

$${r}_{o}^{2} = ( {x}_{o}^{2} + {y}_{o}^{2} + {z}_{o}^{2} ) \qquad ( 2.24 )$$

$${r}_{o}^{2} - {c}^{2} {t}_{o}^{2} = 0 \qquad ( 2.25 )$$

It is seen that the appearance of the new hidden dimension occurs in a form analogous to the splitting of a canceling charge pair of particles from the vacuum, by splitting of a quantized light-like, or vacuum, space-time interval of length zero. In the unification of gravity and electromagnetism the hidden dimension size, where the hidden dimension can mix with the non-hidden dimensions, is the quantized particle size. Physically, the hidden dimension can be considered as an electric charge. The hidden dimension quantities are thus able to mix with the normal spacetime quantities because the hidden dimension quantities and the normal spacetime quantities are similar at smaller scales. This will lead to two particle types. One is associated with the time-like portion of the constrained interval, leading to a one-dimensional character, an electron, and another of equal size with a space-like character having three constrained sub-dimensions, a proton. The required birth of 3 sub-dimensions with the proton introduces entropy because the 3 sub-dimensions and the proton are uncorrelated.

The gravitation constant G, functions in the vacuum as the “interpreter” of charge into either mass or distance. Thus, ironically, charge and mass, the source terms for electro-magnetism and gravity, are unified already in the vacuum quantity G, which has units of charge to mass ratio squared in the esu system used here.

$$q \sqrt{G / {c}^{4}} = r \qquad ( 2.26 )$$

$${r}_{o}^{2} = ( G / {c}^{4} ) ( {q}_{x}^{2} + {q}_{y}^{2} + {q}_{z}^{2} ) \qquad ( 2.27 )$$

$${r}_{o}^{2} = {c}^{2} {t}_{o}^{2} = ( G / {c}^{4} ) {q}_{t}^{2} \qquad ( 2.28 )$$

Therefore, the quantized vacuum scale length, the Planck length, gives birth to a quantized larger scale hidden dimension. Because the quantized hidden dimension is an image of macroscopic space-time in a light-like interval, and the structure of the quantized hidden dimension is part of a split “lightlike” spacetime where charge q is analogous to macroscopic dimensions as a length, then charge conservation and interval conservation exists. From these conditions the following constraints on the charges of the particles are obtained as follows:

$${q}_{o} = - {q}_{t} = {q}_{x} + {q}_{y} + {q}_{z} \qquad ( 2.29 )$$

$${q}_{o}^{2} = {q}_{t}^{2} = {q}_{x}^{2} + {q}_{y}^{2} + {q}_{z}^{2} \qquad ( 2.3 )$$

where the subscripts denote the corresponding time or space dimensions in the unconstrained Cosmos. This can be explained variationally as requiring qₓ=q_{y}=⅔ and q_{z}=−⅓ (see below) by minimizing the product qₓq_{y}q_{z} subject to the constraints of Eq.s 2.29 and 2.30. Thus, the space-like portion of the split interval, the proton, has three sub-dimensions are interpreted as quarks or sub-charges, while the electron acts like a single entity.

### The Unification of Gravity and Electromagnetism in the Context of Kaluza-Klein Theory

Section 1. the unification of gravity and electromagnetism Sakharov and Kaluza-Klein Theory

The concept that Gravity-EM unification is possible shows a great simplification our models of physics, however, the same unification of gravity and electromagnetism requires the concept of the vacuum to become more complex.

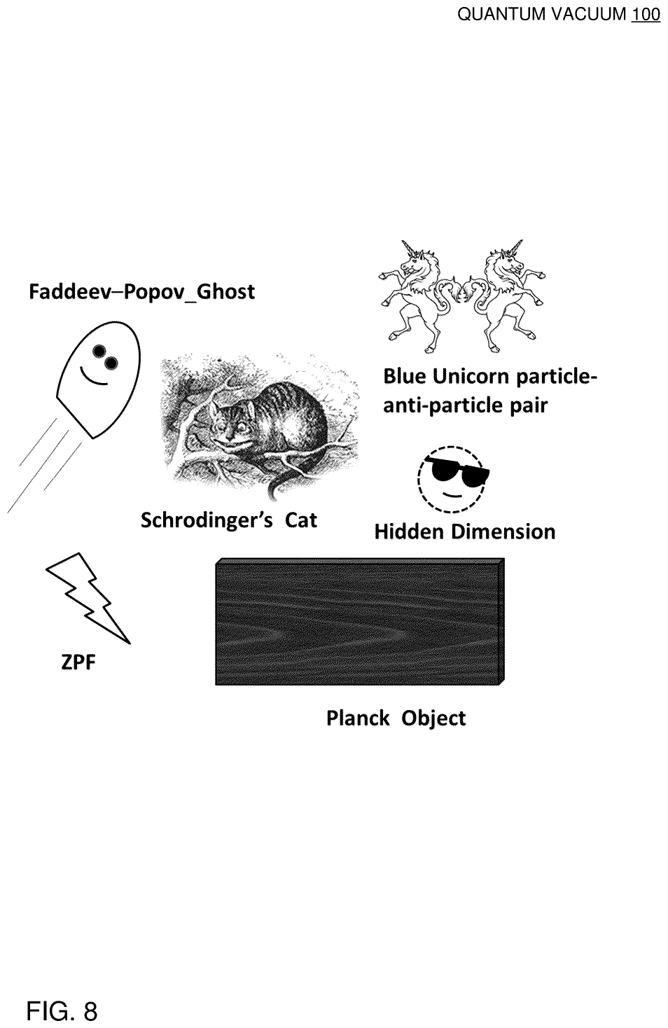

FIG. 8 is a diagram of a quantum vacuum 800, according to an implementation.

Conventionally, vacuum was thought to be mere emptiness, in contrast, quantum mechanics required the vacuum to become quite ‘busy’, and astrophysical observations of a non-zero cosmological constant required still more complication, so now, in turn, the unification of gravity and electromagnetism with its hidden “Kaluza-Klein” dimension, adds further complexity.

General Relativity, Maxwell's Equations, and quantum mechanics are the primary constraints on the Unification of gravity and electromagnetism. The first two constraints are both largely satisfied by Kaluza-Klein theory, where the coupled equations of General Relativity and Maxwell's equations can be derived from an extended Hilbert Action Principle by the assumption of a “hidden” or compact 5^{th} spatial dimension. The unification of gravity and electromagnetism can be considered to be mainly a merging of the Sakharov and Kaluza-Klein approaches to Gravity electro-magnetism unification: The Sakharov approach being the identification of ZPF electro-magnetism fields with spacetime and the Kaluza-Klein theory saying the separate appearance of separate electro-magnetism fields at long wavelengths is due to the appearance of a “cellular” structure in spacetime, i.e. a hidden dimension. The physical meaning of the unified gravity and electromagnetism view of spacetime and electro-magnetism fields in the context of the Sakharov and Kaluza-Klein theories is explained below. In particular, the results of the unification of gravity and electromagnetism in the context of the Kaluza-Klein theory is explained to understand the physical nature of a fifth dimension and the consequences of the fifth dimension.

First, the concept of ‘self-censorship’ in an electromagnetic spacetime of Sakharov and its requirement of a cutoff wavelength for ZPF is explained, beneath which self-censorship occurs. The ZPF effects matter at atomic-relevant frequencies, but just as the very high frequency limit of the ZPF does not appear physically, thus some change in physics must occur at frequencies above the gamma ray wavelengths for nuclear transitions. Following Sakharov, the cutoff at frequencies above the gamma ray wavelengths in the context of the Hilbert Action Principle is explained and the concept of a cutoff frequency for self-censorship by a simple mathematical analysis of the direct evidence of the ZPF, the Casimir Effect is explained too.

Secondly, the Kaluza-Klein theory is explained, from which appear both Maxwell's equations and the coupled Equations of general Relativity, by means of physical attributes of a ‘hidden dimension’ and the physical meaning of the ‘hidden dimension’ in the context of the Kaluza-Klein theory identifying the ‘hidden dimension’ with the charge-quantum of subatomic particles.

Thirdly, how the presence of charge in the vacuum and the concept of self-censorship and Maxwell's equations leads to the Schwarzschild metric of General Relativity is also explained.

### Section 2. Sakharov's Model and Self-Censorship

One of the curious issues of the unification of gravity and electromagnetism is that the ZPF energy vanishes, yet the ZPF is commonly observed in its effects on atoms and is key to understanding spontaneous emission of radiation from bound systems. One way that the ZPF can interact with ordinary electrodynamics is that that the “self-censorship” of the ZPF occurs at some high frequency cutoff, like the ground-state spectrum of phonons in a crystal are cutoff at wavelengths corresponding to the inter-particle separation. This would also correspond to the change of physics of the vacuum at wavelengths corresponding to the “cell-size” of the vacuum where strong E and B exists that create unified gravity-and-electromagnetism gravity fields exist. Proceeding with the simplest model, the cutoff wavelength value is assigned to the size of a Kaluza-Klein hidden dimension.

Cutoff frequencies on the ZPF, such as those commonly used at the Planck Scale, create problems for the Lorentz invariance of the ZPF. However, such concerns are of a higher order in this discussion. Here, such concerns are aside and whether such a frequency cutoff makes sense physically at leading order is determined.

The unification of gravity and electromagnetism is an alloy of the concepts of Sakharov concerning baryo-genesis and gravity's relationship to the electro-magnetism ZPF, and Kaluza-Klein theory of electro-magnetism-gravity unification via a hidden 5^{th} dimension. To begin with, the Hilbert action principle in 4 spacetime dimensions with a zero cosmological constant.

$$W = \int \frac{R}{16 π G} {dx}^{4} ’ \qquad ( 3.1 )$$

where g^{μv} is the metric tensor and R_{vμ} is the Ricci tensor. Finding the extremum of this action leads to the vacuum gravity equations with no electro-magnetism fields.

$${R}_{ν μ} - \frac{1}{2} {g}_{ν μ} R = 0 \qquad ( 3.2 )$$

Sakharov interpreted the integrand as a real energy density. He equated this energy density to a perturbed quantum electro-magnetism ground state spectrum of ZPF (Zero Point Fluctuation) due to the Heisenberg Uncertainty principle applied to the vacuum electro-magnetism field. The zeroth-order ZPF mass density is assumed to vanish due to a canceling cosmological constant term proposed by Yakov Zeldovich, a colleague of Sakharov's. This “Zeldovich Cancelation” ensures that only the perturbations due to curved space cause the effect of the ZPF to appear. Sakharov calculated the perturbed part of the ZPF due to spacetime curvature, assuming a cutoff at the Planck Scale. He then derived a formula for G in terms of an integral over the perturbed ZPF:

$${G}^{- 1} ≅ \frac{ℏ}{2 {c}^{5}} {\int }_{0}^{{ω}_{p}} ω d ω = \frac{ℏ}{{c}^{3}} 1 / {r}_{p}^{2} ; \qquad ( 3.3 )$$

$$G = \frac{{r}_{p}^{2} {c}^{3} ,}{ℏ} \qquad ( 3.4 )$$

However, Eq. 4.4 is dominated by the Planck wavelength frequencies and is thus insensitive to the lower bound of frequencies, near the hidden dimension size rₒ. Accordingly a long wavelength cutoff can be applied with no detectable change in the Gravitation Constant.

$${r}_{o} = \frac{{e}^{2}}{{( {m}_{p} {m}_{e} )}^{1 / 2} {c}^{2}} , \qquad ( 3.5 )$$

$${G}^{- 1} ≅ \frac{ℏ}{2 {c}^{5}} {{\int }^{{ω}_{p}}}_{{ω}_{o}} ω d ω = \frac{ℏ}{{c}^{3}} [ 1 / {r}_{p}^{2} - 1 / {r}_{o}^{2} ] \qquad ( 3.6 )$$

wherein the Planck frequency, ω_{P}=c/r_{P} and a cutoff frequency, ωₒ=c/rₒ are defined. This revised calculation, now including a long-wavelength cutoff (long compared to the Planck Length) yields:

$$G ≅ {\frac{{c}^{3} {r}_{p}^{2}}{ℏ} [ 1 - {r}_{p}^{2} / {r}_{o}^{2} ]}^{- 1} \qquad ( 3.7 )$$

Where the correction factor, r_{P}/rₒ˜10⁴³ and is thus undetectable by present technology.

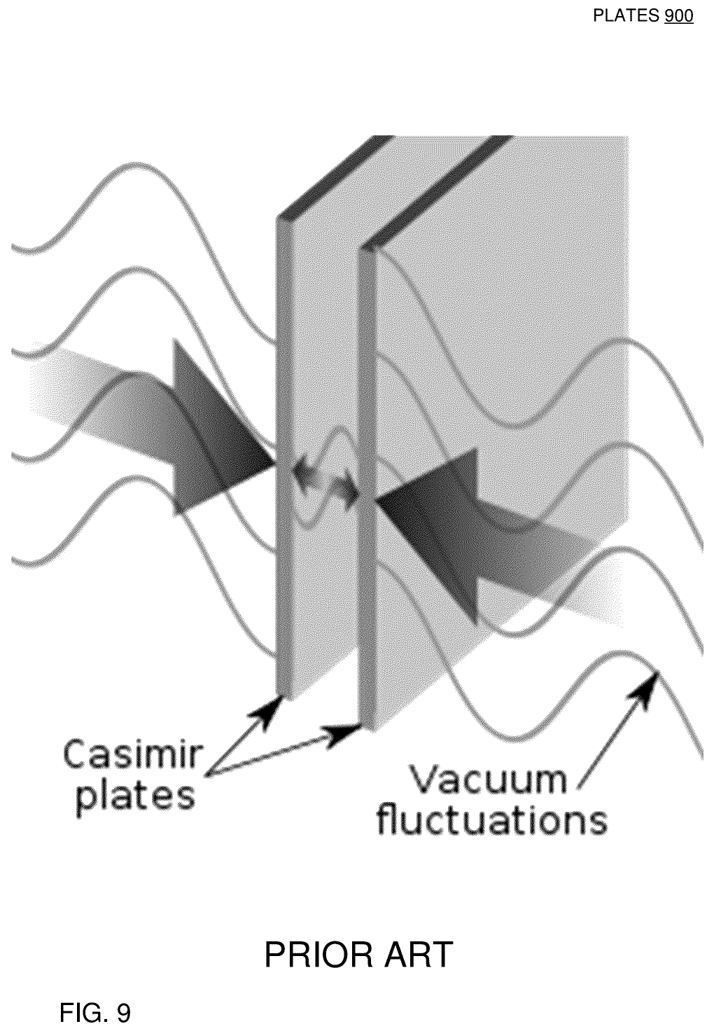

FIG. 9 is a diagram of plates 900 exhibiting the Casimir force, according to an implementation. Plates 900 show the cutoff 910 due to the finite gap between plates.

One of the constraints of a physical electrodynamic theory of gravity is that the ZPF can be detected physically through Casimir forces but also engages in “self censorship”. A spectrum of electro-magnetism modes, as demonstrated by the Casimir Force, interacts with everyday matter. Insight into this can be gained by considering how the Casimir Force occurs physically.

The Casimir Force can be derived as the radiation pressure of modes that can exist in a large region of large size L, and within this region a pair of thin metal plates of spacing [symbol] . (see FIG. 9)

Assuming a cutoff exists at frequency f_{c}>>c/ [symbol] 920, roughly equivalent to “regularization” the following expression can be obtained for wave field energy per unit area between plates separated by a gap of distance [symbol] :

$$\frac{< {E}_{a} >}{A} = \frac{ℏ c {π}^{2}}{6 {ℓ}^{3}} {\sum }_{n}^{{n}_{c}} {n}^{3} \qquad ( 3.8 )$$

The ZPF modes for the much larger region between plates separated by the large distance L can be expressed as:

$$\frac{< {E}_{L} >}{A} = \frac{ℏ c {π}^{2}}{6 {L}^{3}} {\sum }_{n}^{{n}_{c}} {n}^{′ 3} \qquad ( 3.9 )$$

### Assuming the Same Cutoff Frequencies

$$\frac{{n}_{c}^{′}}{L} = \frac{{n}_{c}}{ℓ} \qquad ( 3.1 )$$

The difference between the energies can be expressed as:

$$\frac{< {E}_{L} >}{A} = \frac{ℏ c {π}^{2}}{6 {ℓ}^{3}} [ {\sum }_{n = 1}^{{n}_{c}} {n}^{3} - {\sum }_{n = 1}^{{n}_{c}^{′}} {{n}^{′ 3} ( \frac{ℓ}{L} )}^{3} ] \qquad ( 3.11 )$$

Thus, the modes cancel at high frequencies 930, that is: high frequencies compared to everyday life, assuming a cutoff 910 exists in order to make this a finite difference between finite quantities.

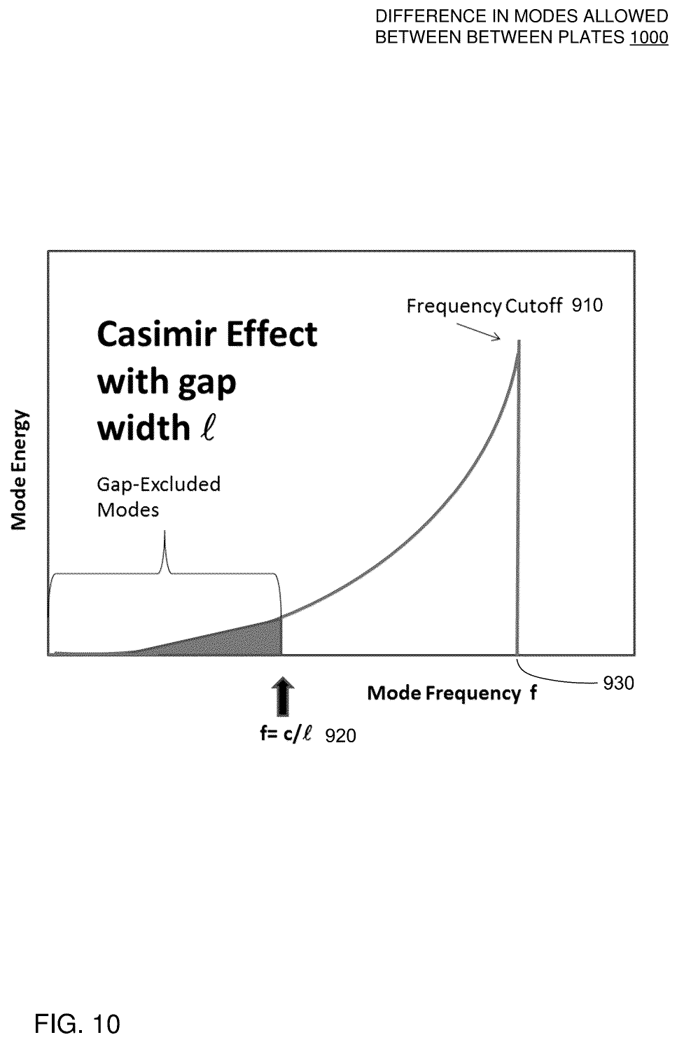

FIG. 10 is a diagram 1000 of the difference in modes allowed between plates, according to an implementation. In diagram 1000, the plates have a narrow space [symbol] between the plates and a pair of widely spaced plates of gap L, where [symbol] /L<<1.

Diagram FIG. 10 shows the mode energies and the difference caused by the excluded low frequency modes. This results in an expression, where assume a finite mode-width for the principle mode in order to convert to a continuous set of modes for the excluded modes:

$$\frac{< {E}_{L} >}{A} = - \frac{ℏ c {π}^{2}}{6 {ℓ}^{3}} [ {\sum }_{n = 1}^{L / a} {n}^{′ 3} ] \qquad ( 3.12 )$$

Integrating over the excluded modes as if the excluded modes are continuous and assuming a finite mode width for n=1 mode, so the integral can be ended far from n=1, can be obtained as follows:

$$[ {\sum }_{n = 1}^{L / a} {n}^{′ 3} ] ≅ {\int }_{0}^{{( 2 π )}^{- 1}} {x}^{3} d x = \frac{{x}^{2}}{3} {\vert}_{0}^{{( 2 π )}^{- 1}} ≅ \frac{1}{118} \qquad ( 3.13 )$$

Therefore, one method of seeing the ZPF fields directly via the Casimir effect implies that cutoffs must occur and but the Casimir effect involves differences in mode spectra far from this cutoff. Thus, an observation of the ZPF in atomic and nuclear transitions, supports the concept that a cutoff in wavelengths occur at the subatomic scale. By a naïve estimate this would occur at the photon energy E_{cuttoff}˜ [symbol] c/rₒ=3.0 GeV and that at shorter wavelengths self-censorship occurs, with the ZPF becoming part of spacetime. Since the ZPF plays a great role in electro-magnetism transitions of bound systems, a cutoff could manifest itself as an abrupt change in decay lifetimes of particles in this 3.0 GeV mass range due to a change in the ZPF physics. Such a change in lifetime is observed in the dramatic difference (˜347 times) in decay times from the η-c Charmed meson at mass 2984 MeV to the very similar, but much longer lived, J/ψ Charmed meson at 3097 MeV.

Assuming the non-zero Cosmological constant, the Zeldovich Cancelation can take care of any remaining residual mass of the ZPF above the cutoff, without interfering with its interactions with matter.

### Section 3. The Unification of Gravity and Electromagnetism and Kaluza-Klein

Maxwell's and Einstein's equations arise from a common basis. The presence of the hidden 5^{th} spatial dimension creates separate electro-magnetism and gravity fields. The unification of gravity and electromagnetism by the Kaluza-Klein formalism is introduced by a 5^{th} dimension that effectively scatters part of the ZPF electro-magnetism microstructure of spacetime into long wavelength E and B fields that are governed by Maxwell's equations. Thus very short wavelength ZPF modes become “spacetime,” while long wavelength modes become the electro-magnetism modes seen as electric and magnetic fields in ordinary matter. Assuming that an electromagnetic model of gravity and spacetime requires a cellular structure to spacetime, this arises from a definition of a spatial distance interval and the spherical isotropy of spacetime, where a spatial interval exists for a field-free region:

$${r}_{o}^{2} + {x}^{2} + {y}^{2} + {z}^{2} = {ℓ}^{2} \qquad ( 3.14 )$$

Where rₒ is a quantized distance in the 5^{th} dimension, which means that a spherical region can exist where rₒ= [symbol] , so that points technically at identical spatial coordinates are still separated within the hidden dimension. Thus, hidden dimension looks like a small spherical subatomic particle, which a difference in hidden dimension coordinates must appear in ordinary space as a spherical spatial void or cell.

This new Kaluza-Klein 5^{th} dimension, is a degree of freedom but is “compact”, that is, the new Kaluza-Klein 5^{th} dimension is limited in extent, unlike the other dimensions of space-time. However, the 5^{th} dimension must arise from the much smaller Planck length and deploy to its favored size. Assuming that at the Planck scale, all particles and fields are unified and identical, the world we basically experience then results from the deployment of the compact 5^{th} dimension from Planck scale, to form a cosmos with two particles: electrons and protons and two fields: electro-magnetism and gravity. The size of the fully deployed 5^{th} dimension can be explained by the consequence of the appearance of the 5^{th} dimension is appearance of real particle masses, mₑ and mₚ, wherein the new scale size rₒ, most simply, will depend on “particle” quantities: e, mₚ and mₑ. The hidden dimension size then, is a completely new quantity, and not dependent on the vacuum quantities G, c, and [symbol] . The new 5^{th} dimension size rₒ can be expressed in terms of purely particle quantities that accompany its appearance:

$${r}_{o} = \frac{{e}^{2}}{{m}_{o} {c}^{2}} \qquad ( 3.15 )$$

$$where {m}_{o} = {( {m}_{p} {m}_{e} )}^{1 / 2}$$

This physical concept of gravity as a statistical electromagnetic interaction related to “radiation pressure” from the quantum ZPF (Zero Point Fluctuation) was proposed by Sakharov and can be understood physically in the case of two bright objects in a box with dark walls, the two objects repel each other due to mutual radiation pressure with a 1/r² force dependence, in the second case two dark objects are placed in a box with bright walls and attract each other due to mutual shadowing with a 1/r² force dependence. Sakharov went further, using the Hilbert Action Principle

$$W = \int \frac{R}{16 π G} {dx}^{4} \qquad ( 3.16 )$$

where R/16πG is an energy density to be minimized, and which yields the vacuum equations of Einstein's General Relativity. Sakharov treated the action, R/16πG, having units of energy density, as a physical energy density due to the distortion of the ZPF by curved spacetime and used this to derive a formula for the Newton Gravitation Constant with the Planck scale forming the short wavelength limit of integration. This yielded:

$$G = \frac{{r}_{p}^{2} {c}^{3}}{ℏ} \qquad ( 3.17 )$$

Where r_{P}=( [symbol] G/c³)^{1/2} is the Planck mass from the ZPF, which demonstrates that self-consistency of the concept. Gravity can thus be considered as a consequence of the curvature of spacetime, with the fabric of spacetime being considered electromagnetic. However, in order to introduce electromagnetism explicitly one must introduce a hidden Kaluza-Klein dimension. This changes the Hilbert Action Principle, and for the case of a vacuum the Hilbert Action Principle becomes

$$W = \int φ \frac{{c}^{4} R}{16 π G} + {φ}^{3} \frac{{F}_{αβ} {F}^{αβ}}{4} {dx}^{5} \qquad ( 3.18 )$$

Where F_{αβ} is the Faraday electro-magnetism tensor and φ is considered here to be, effectively, a constant with φ=1. An excellent treatment of the scalar field φ, called the “Radion field” being fully dynamic was published by Lance Williams and its consequences will be examined in later works. The Kaluza-Klein 5^{th} dimension, which unifies gravity and electro-magnetism, cannot be introduced without the Radion scalar field φ being also introduced.

$$\frac{{F}_{α β} {F}^{α β}}{4} = \frac{{E}^{2} - {B}^{2}}{8 π} \qquad ( 3.19 )$$

The Basis Stress Tₒ, can be defined, which is the Planck Energy density, as:

$$8 π G / {c}^{4} = \frac{1}{{r}_{p}^{2} {T}_{o}} \qquad ( 3.2 )$$

Accordingly, in a form similar to the Lagrangian for sound waves

$$W = \int φ {r}_{P}^{2} {T}_{o} R - {φ}^{3} \frac{{E}^{2} - {B}^{2}}{8 π} d {x}^{5} \qquad ( 3.21 )$$

Because r_{P}²Tₒ is a product of a small quantity r_{P}² with a large quantity Tₒ=16π [symbol] c/r_{P}⁴., then r_{P}²Tₒ=rₒ²Tₒ* and have large scale length rₒ and a weaker basis stress, Tₒ*:

$$W = \int {T}_{o}^{*} {r}_{o}^{2} R + \frac{1}{4} {F}_{αβ} {F}^{αβ} d {x}^{5} \qquad ( 3.22 )$$

Assuming that 16πG/c⁴=r_{P}²Tₒ=4.14×10⁻⁴⁸ dyne⁻¹.

$${r}_{P}^{2} {T}_{o} = {r}_{o}^{2} {T}_{o} \frac{{r}_{P}^{2}}{{r}_{o}^{2}} = {r}_{o}^{2} {T}_{o} \frac{G {m}_{p} {m}_{e}}{{e}^{2} α} = {r}_{o}^{2} {T}_{o}^{*} \qquad ( 3.23 )$$

Where the modified stress is equivalent to the gravity stress between two masses 137 times the mesoscale mass mₒ but held a Planck length apart. This is much lower than the Planck stress.

$${T}_{o}^{*} = \frac{G {m}_{p} {m}_{e}}{{α}^{2} {r}_{P}^{4}} \qquad ( 3.24 )$$

Therefore, the Lagrangian for a Kaluza-Klein Vacuum can be considered as similar to the sound wave Lagrangian of a gas of pressure T*ₒ and “sub-molecular” scale size rₒ. Let us consider the physical picture that the universe begins as 4 dimensional at high densities near the Planck Scale and becomes 5 dimensional as expands. The physical picture that the 5^{th} dimension then “deploys” can be adopted to a certain size range, rₒ, as the universe expands and does not grow beyond this. The expression for ξ, the parameter indicating the deployment and activation of the hidden dimension size, rₒ, that follows the model can for formalized as:

$$ξ = tanh [ \frac{r}{{r}_{P}} ] \qquad ( 3.25 )$$

So that, effectively, ξ=1 for r/r_{P}>>1 or 0 for r/r_{P}=0. Thus the simplifying assumption can be adopted so, that the dynamics of ξ are minimal.

So the near the Planck scale ξ=0 and for r/r_{P}>>1ξ=1. Note that this means the Gravitational portion of the Kaluza-Klein Lagrangian (Eq. 3.20) appears far more quickly than the electro-magnetism portion as the fifth dimension deploys.

Where A is the electric 4 potential the indices, a and b, run from 1-5, κ=16πG/c⁴, g_{τv} is the familiar 4 metric tensor and ξ=φ² is a parameter that determines the size of the 5^{th} dimension, with ξ=1 being a compactified universe and ξ=0 being the primordial infinite 4^{th} dimensional universe. Accordingly, a Lagrangian for a set of massless scalar quanta, with M_{P}=( [symbol] c/G)^{1/2} being the Planck mass, a mass that can arise spontaneously out of the vacuum:

$$L = \frac{{h}^{2}}{{M}_{P}} \int ( {\partial }_{a} ϕ {\partial }_{b} {ϕγ}^{ab} ) \sqrt{- γ} {d}^{5} x \qquad ( 3.27 )$$

The minimization of this Lagrangian leads to a simple Klein-Gordon wave equation for massless quanta in flat space:

$${\partial }_{a} {\partial }_{b} ϕ {γ}^{a b} = 0 \qquad ( 3.28 )$$

However, if the fifth dimension is allowed to deploy and then become compact so that all dependence on the 5^{th} dimension becomes the form:

$$ϕ = {\sum }_{r} {ϕ}_{r} ( {x}^{v} ) exp ( {inx}^{5} / ( 2 π {r}_{o} ) \qquad ( 3.29 )$$

Where n is an integer index and rₒ is the size of the hidden dimension. Then the particles in the quantum Lagrangian acquire both mass and charge:

$$L = \frac{{h}^{2}}{{M}_{P}} \int ( {[ ( {\partial }_{a} - \frac{i n}{2 π {r}_{o}} ξκ {A}_{ν} ) ϕ ]}^{2} - {( \frac{n}{2 π {r}_{o}} )}^{2} {ϕ}^{2} ) \sqrt{- r} {d}^{5} x \qquad ( 3.3 )$$

Where the electric charge, with n=1, is identified as:

$$e = \frac{ξ κ}{2 π {r}_{o}} \qquad ( 3.31 )$$

and the characteristic mass:

$$m = \frac{h n}{2 π {r}_{o} {c}^{2}} \qquad ( 3.32 )$$

So that for field free space, therefore:

$${\partial }_{a} {\partial }_{b} ϕ {γ}^{a b} + {( \frac{m c}{h} )}^{2} ϕ = 0 \qquad ( 3.33 )$$

So that the appearance and compactification of a 5^{th} dimension allows both charged and massive particles to appear from a previously vacuum filled universe. These particles can move and scatter off each other freely, increasing entropy, just like the shattering of a stone obelisk into pieces increases entropy. However, the values of the characteristic mass and charge are subject to some adjustment because the vacuum must be considered electrodynamic and vacuum polarization and thus renormalization must occur. For instance for a value of ξ=n=1 and κbeing its normal vacuum value the electron charge e requires the hidden dimension size rₒ to be of the order of the Planck radius, however, without renormalization this would require the mass scale to be the Planck mass. However, that part of the mass is due to interaction with the polarized vacuum around the charge and this must reduce, or renormalize, the mass. So, renormalization occurs and erases this problem of charge-to-mass in the Kaluza-Klein theory. This is equivalent to the model of a “quartic potential”, triggered by the appearance of a Higgs Boson, that gives particles non-zero masses that are none-the-less lowest energy state, due to a gravitation-like negative self-potential. An analogous model occurs in cosmology where the proton density nₒ≅ψ², that is: a quantum probability squared, contributes to the mass-energy of the universe by the equation for energy density

$$w = {ψ}^{2} {m}_{p} {c}^{2} - \frac{8 π G}{3} {m}_{p}^{2} {ψ}^{4} \qquad ( 3.34 )$$

where for Ω=1 the second term becomes c².

Another way this can be looked at is that a renormalization occurs due to quantum vacuum polarization over wavelengths from the Planck length to the size of the hidden dimension rₒ so, similar to the calculation for the self-energy of the electron:

$$πln [ {r}_{o} / {r}_{p} ] ≅ {α}^{- 1} \qquad ( 3.35 )$$

### The Unification of Gravity and Electromagnetism and General Relativity

Section 1 The unification of gravity and electromagnetism and the Equivalence Principle

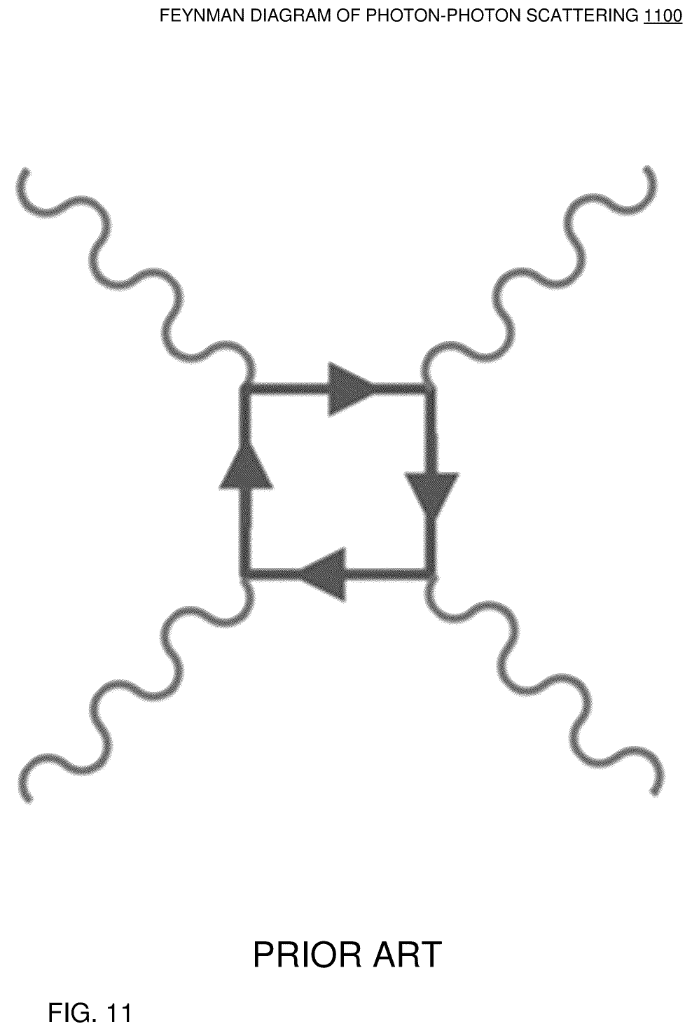

FIG. 11 is a Feynman diagram 1100 of photon-photon scattering, according to an implementation.

The cornerstone of General Relativity is the Equivalence Principle, which says all particles, regardless of charge or mass must fall at the same rate. This requirement is best satisfied by gravity forces not being forces at all, but by being manifestations of curvature of a spacetime manifold which all particles, even photons of light, are imbedded into, and on which the photons of light must follow geodesic paths. This requires photon-photon scattering to be an important process in curved spaces, as shown in FIG. 11. The solution is found through an interpretation of QED (Quantum Electro-Dynamics).

In QED both massive and massless particles interact constantly with an unseen vacuum full of ZPF fields and virtual particles. Even light can scatter off of light in QED, as shown in FIG. 11, so even photons can be considered to navigate across the vacuum by a series of interactions with photons of the ZPF. Thus, particles are bound to the electro-magnetism spacetime and forced to move by conforming to its structure by continual interactions. For charged particles, looking at the classical interaction of charged particles can be understood with arrays of E×B drifts. For photons, spacetime is a substance that has a varying index of refraction, like a solid dielectric, and that just as a photon bends is path through a dielectric by a series of interactions with its molecules and atoms, according to an Eikonal equation, so photons must interact with the vacuum. In order for the photons to respond to the variations of an electrodynamic spacetime Quantum Photon-Photon scattering must be the process by which photons follow geodesics in curved space, as shown in FIG. 11.

### Section 2 the Vacuum Bernoulii Equation

In the classical limit, a physical model of a gravity field as a curvature of a electrodynamic spacetime from Sakharov can be evaluated for consistency with a Kaluza-Klein 5^{th} dimensional spacetime and its dynamics. First, we consider the classical limit of the Newtonian gravity potential Φ which varies very slowly in time. Then a field Lagrangian for gravity can be determined, where g is the local gravity field:

$$R ≅ - 2 {g}^{2} \qquad ( 4.1 )$$

which in the Newtonian limit is:

$$∇ \cdot g = - 4 π G ρ \qquad ( 4.2 )$$

Accordingly:

$$\frac{R}{16 π G} = \frac{{g}^{2}}{8 π G} \qquad ( 4.3 )$$

And therefore in the Newtonian Limit where Kaluza-Klein Lagrangian:

$${L}_{K K} = \frac{{g}^{2}}{8 π G} - \frac{{E}^{2} - {B}^{2}}{8 π} \qquad ( 4.4 )$$

The Lagrangian is consistent with the concept of gravity fields in the unification of gravity and electromagnetism as arrays of E×B drifts, as shown below.

When this model of electro-magnetism gravity is combined with Poynting's theorem, the Kaluza-Klein action falls out as a conserved quantity and can be called the VBE (“Vacuum Bernoulli Equation”). A brief version of VBE derivation is shown below. Assuming B²/2μₒ is constant and vary E in time, then the charged particles can all accelerate at the same rate:

$$\dot{V} = \frac{\dot{E} \times B c}{{B}^{2}} = \frac{4 π \dot{S}}{{B}^{2}} = \frac{\dot{S}}{2 {u}_{o}} \qquad ( 4.5 )$$

Where uₒ=B²/8π and assuming some cycling of the E field to, as in a “sawtooth” waveform, with the reset being much faster than the particle cyclotron period 1/ω_{c}, which can result in some inefficiency, which can be approximately expressed as:

$$\dot{V} = \frac{〈 \dot{E} 〉 \times Bc}{{B}^{2}} = \frac{4 π 〈 \dot{S} 〉}{{B}^{2}} ≅ \frac{\dot{S}}{2 {u}_{o}} \qquad ( 4.6 )$$

The form Newtonian gravity theory can be written with gravity vector field g, where G is Newton's gravity constant:

$$∇ \cdot g = - 4 π G ρ \qquad ( 4.7 )$$

Assuming E=mc² and so an electro-magnetic energy density can form a mass density as a source for a gravity field. This density becomes:

$$ρ = \frac{u}{{c}^{2}} , u = ( {E}^{2} + {B}^{2} ) / 8 π \qquad ( 4.8 )$$

Equation 4.8 means when electro-magnetic energy flows into a spherical region from all sides, gravity vectors pointing into the region increase in time so that, for the case of a spherically symmetric region, then:

$$∇ \cdot \dot{g} = - 4 π G \dot{ρ} = - 4 π G ∇ \cdot S / {c}^{2} \qquad ( 4.9 )$$

Where both vectors can generate an additional vortex-like field F=∇×A that include curls of a vector potential.

For the simplest case of no “curl fields” then:

$$\frac{\dot{g}}{4 π G} = \frac{S}{2 {c}^{2}} \qquad ( 4.1 )$$

$$\frac{\dot{g}}{2 π G} \cdot g = S \cdot \frac{\dot{S}}{{ℓ}_{o} {c}^{2}} \qquad ( 4.11 )$$

Where [symbol] ₒ=(B²−E²)/8π is an invariant magnetic field energy density.

Integrating, the VBE (Vacuum Bernoulli Equation):

$$\frac{{g}^{2}}{2 π G} = \frac{{S}^{2}}{{ℓ}_{o} {c}^{2}} - C \qquad ( 4.12 )$$

$$\frac{{g}^{2}}{2 π G} - \frac{{S}^{2}}{{ℓ}_{o} {c}^{2}} + C = 0 \qquad ( 4.13 )$$

Upon substitution C=uₒ²/(2c² uₒ) then

$$\frac{{g}^{2}}{2 π G} - \frac{{S}^{2}}{{ℓ}_{o} {c}^{2}} + \frac{{E}^{2} + {B}^{2}}{{ℓ}_{o} {c}^{2} 8 π} = 0 \qquad ( 4.14 )$$

The VBE satisfies the Equivalence Principle since in the situation of free fall, not only does g=0 but also the E field is zero in the falling frame, due to the properties of the E×B drift, which is the frame where the Lorentz shift makes E=0 for the particle.

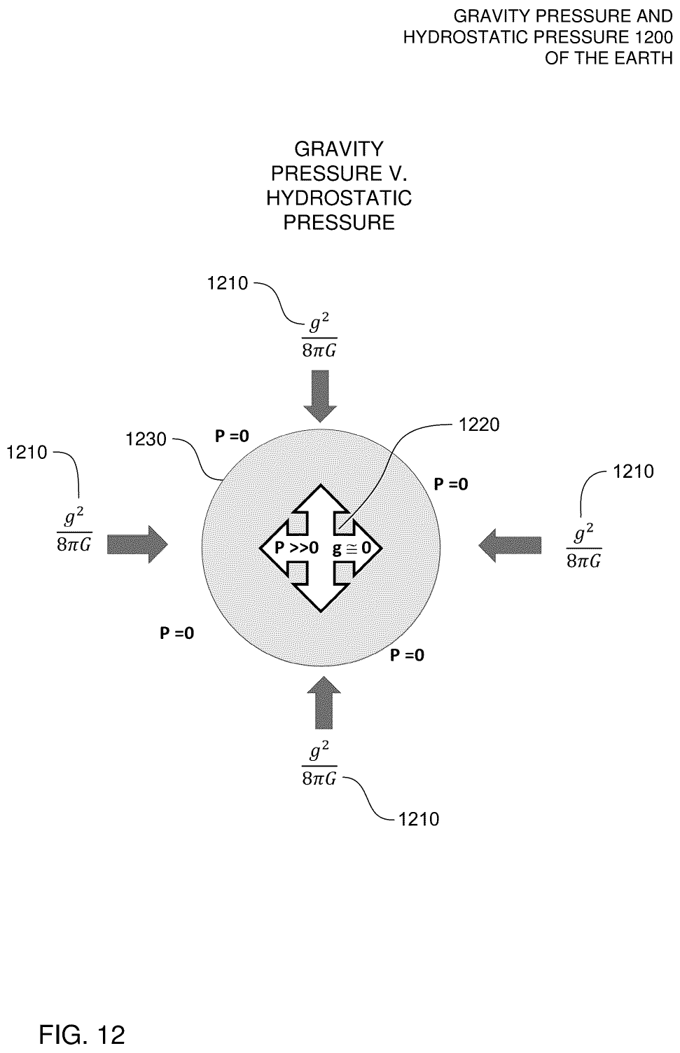

The Vacuum Bernoulli Equation states that when the local EM Poynting Vector S is increased, (such as by creating a Poynting Vortex under the conducting dome 110 in FIG. 1), the increased local EM Poynting Vector S creates an increased gravity pressure g2/(2 [symbol] G), as seen in FIG. 12, that presses on the underside of the conducting dome 110 in FIG. 1 and causes an effective lifting force on the conducting dome 110. This lifting force can provide human flight.

Using the expression

$$- {S}^{2} / {c}^{2} + {[ \frac{{E}^{2} + {B}^{2}}{8 π} ]}^{2} = {[ \frac{{E}^{2} - {B}^{2}}{8 π} ]}^{2} + \frac{{( E \cdot B )}^{2}}{8 π} \qquad ( 4.15 )$$

with <E⋅B>=0 in the vacuum, that is, a vacuum made of electro-magnetism waves.

Therefore, approximately:

$$\frac{{g}^{2}}{2 π G} - \frac{{( {B}^{2} - {E}^{2} )}^{2}}{{( 8 π )}^{2} {ℓ}_{o}} = 0 \qquad ( 4.16 )$$

With the approximation that [symbol] ₒ=Bₒ²/8π and the condition that E/B<<1 therefore:

$$\frac{{g}^{2}}{2 π G} - \frac{( {B}^{2} - {E}^{2} )}{8 π} ≅ 0 \qquad ( 4.17 )$$

Equation 4.17 can be interpreted as a portion of the Kaluza-Klein Lagrangian with only a partial variation of the electro-magnetism field allowed, that is constant B. Therefore, the E×B drift model of gravity appears consistent with Kaluza-Klein theory, with the Vacuum Bernoulii Equation being an equation describing small variations around the minimum value of the Kaluza-Klein Lagrangian, which can be likened to the nearly circular orbits of the planets where the Lagrangian itself becomes a constant of the motion.

Therefore, ignoring for the time being certain troublesome details: such as the relationship of the charge-to-mass problem to renormalization, and the full physical meaning of the ξ=φ² scalar field and its dynamics, the occurrence of particle spin, other physical quantities, the unification of gravity and electromagnetism postulates are basically consistent with an electrodynamic spacetime with a hidden 5^{th} dimension of a combined Sakharov-Kaluza-Klein approach, at least in the case of vacuum equations.

### Section 3. The Unification of Gravity and Electromagnetism and the Schwarzschild Metric

If the fundamental structure of spacetime is electro-magnetic, the metric tensor can be expressed as an electromagnetic tensor:

When this expression is used, the electro-magnetism stress tensor for the ZPF can be made to vanish as shown in the unification of gravity and electromagnetism.

Assuming isotropy the unified gravity-and-electromagnetism metric tensor follows as:

$${T}^{α β} = {F}_{γ}^{α} {F}^{γ β} - {g}^{α β} \frac{{F}_{μγ} {F}^{μ γ}}{4} = 0 \qquad ( 4.19 )$$

$${g}^{α β} = {2 [ {E}^{2} - {B}^{2} ]}^{- 1}$$

$$( \begin{matrix}{E}^{2} & 0 & 0 & 0 \\ 0 & - {E}_{x}^{2} + {B}_{y}^{2} + {B}_{z}^{2} & 0 & 0 \\ 0 & 0 & - {E}_{y}^{2} + {B}_{x}^{2} + {B}_{z}^{2} & 0 \\ 0 & 0 & 0 & - {E}_{z}^{2} + {B}_{y}^{2} + {B}_{x}^{2}\end{matrix} ) \qquad ( 4.2 )$$

Assuming a model of spacetime containing adjacent regions of strong E or B fields, the particles travel as wave packets and sample a volume swept out by a wave-front, thus the particles experience an average spacetime. An average over volume so that <B²>=<E²> and <E·B>=0 results in a volume average of two metric forms one dominated by electric flux, for instance, in its local direction E_{y}.

$${g}^{αβ} = [ \begin{matrix}2 & 0 & 0 & 0 \\ 0 & 0 & 0 & 0 \\ 0 & 0 & - 2 & 0 \\ 0 & 0 & 0 & 0\end{matrix} ] \qquad ( 4.21 )$$

And another, in an adjacent region, by magnetic flux also in B_{y}

$${g}^{a β} = [ \begin{matrix}0 & 0 & 0 & 0 \\ 0 & - 2 & 0 & 0 \\ 0 & 0 & 0 & 0 \\ 0 & 0 & 0 & - 2\end{matrix} ] \qquad ( 4.22 )$$

Upon volume average, assuming large scale isotropy, the familiar Lorentzian flat space metric can be recovered as follows.

$$〈 {g}^{a β} 〉 = [ \begin{matrix}1 & 0 & 0 & 0 \\ 0 & - 1 & 0 & 0 \\ 0 & 0 & - 1 & 0 \\ 0 & 0 & 0 & - 1\end{matrix} ] \qquad ( 4.23 )$$

Accordingly, the flat space Lorentz metric can be viewed as an average of adjacent regions dominated by powerful E and B fields, as if spacetime was a ferroelectric and ferromagnetic material.

Considering the case of a space slightly curved by the presence of matter, and assuming that all fundamental particles are charged, in accordance with the Standard Model, and assuming that the quarks inside protons and neutrons enjoy “ultraviolet freedom” and move freely in response to the ZPF fields, the Schwarzschild Metric can be derived from the unification of gravity and electromagnetism, which requires assuming that below the high frequency cutoff of the hidden dimension electrodynamics proceed normally in a local sense, except that the fields effect matter on larger length-scales only though the effect of the field on the metric rather than directly by electro-magnetism forces.

A charged point particle in the vacuum that is scattering ZPF radiation and creating a 1/r radiation E field around itself, creates an interference pattern and thus first order energy density, with the incident ZPF. This 1/r dependence will ultimately lead to the Schartwzschild metric in the limit of weak fields. To recover this metric, to leading order in Gm/(c²r)<<1, using approximate methods of classical electrodynamics. Quantum electrodynamics is required for such a calculation to be done accurately, rather than classical methods, since the calculation involves scattering of photons in highly relativistic and subatomic scenarios. Assuming this caveat, classical approximations can be assumed to obtain results to leading order, since the classical approximations should apply for weak fields and widely separated particles, as is the cosmic situation.

Beginning with the situation of the particles in the deep subatomic realm near the Planck scale, and assuming that the unification of gravity and electromagnetism of the vacuum requires alternative regions of E and B fields, the Lorentzian flat space metric emerges as the result of averaging. When the charged particles are assigned to the magnetic field regions and assuming that the magnetic field and the neighboring region are oriented in the y-direction, and assuming the magnetic fields are very strong and thus the charged particle is free to move only in the y direction, the ZPF are powerful electro-magnetism waves that scatter off of the charged particles but only with E fields of polarization in the y direction, where the charged particles are free to move.

FIG. 12 is a diagram of the gravity pressure and hydrostatic pressure 1200 of the Earth, according to an implementation. The quantity g²/(8πG) 1210, has units of pressure, and can be understood as a physical pressure. This is easily seen from a model of a planet such as Earth. In FIG. 12, hydrostatic pressure is a maximum at the center of the Earth 1220 whereas gravity field strength g is zero, as is g²/(8 πG), by Newton's law of gravity. On the earth's surface 1230 however, P=0 and both g and g²/(8πG) 1210 are at a maximum. Taken as a whole, the equation P (core of the Earth)≅g²/(8 πG) (surface of the Earth) and close to the Earth's surface 1230 the equation of equilibrium: P+g²/(8πG)=Constant, applies approximately. Therefore g²/(8πG) 1210 can be considered a physical pressure, like static pressure in the Bernoulli Equation.

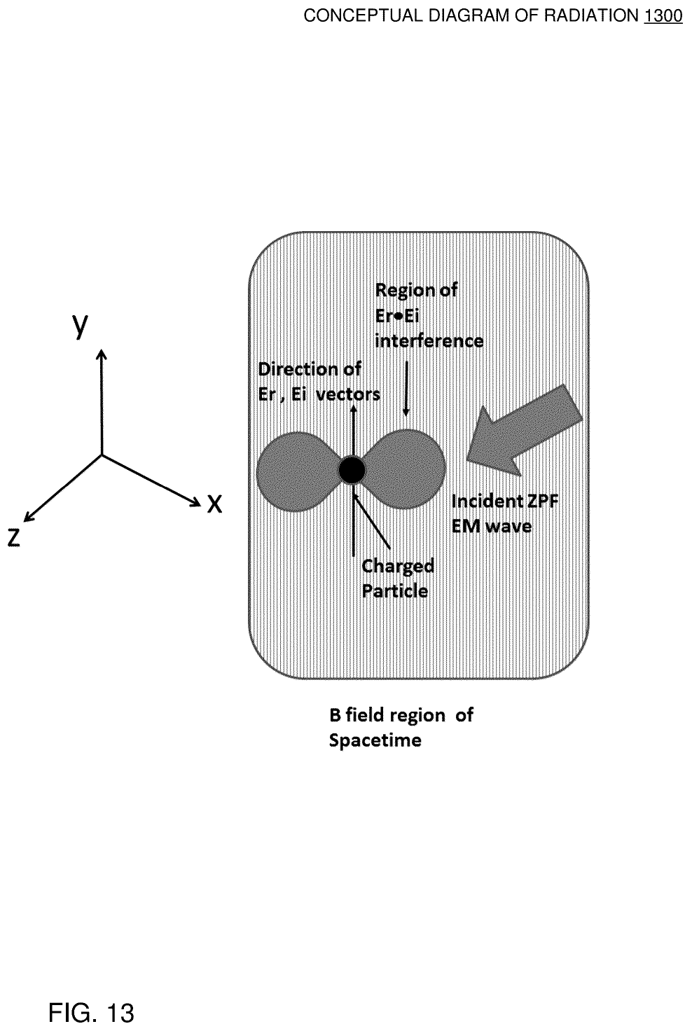

FIG. 13 is a conceptual diagram of radiation 1300 scattering off of a charged particle and creating a donut shaped region of interference between the scattered and incident waves, according to an implementation.

The E² energy density of the interference pattern of the scattered radiation field Eᵣ and a uniform incident ZPF field Eᵢ forms a donut shaped region around the charge in a x-z plane but has vanishing strength in the y direction.

The particle radiating power flux, S=cEᵣ²/4π, in esu units, because of its motion the ZPF creates an electric field stress on the surface of a sphere of radius r, centered on the particle, and normalized to the Thompson cross section at the classical radius of the charge, which has a mass of m, r_{c}=e²/mc², is proportional to the radiated power of the particle, where α is the acceleration of the particle.

$$\frac{8 π}{3} {r}^{2} \frac{{E}_{r}^{2}}{4 π} c = \frac{2}{3} \frac{{q}_{p}^{2}}{{c}^{3}} {a}^{2} \qquad ( 4.23 )$$

This expression limited to α<c²/r_{c}, is the particle classical radius in esu units. Where the acceleration is limited to the value α=c²/r_{c}, and obtain, upon simplification.

$${E}_{r} = {E}_{c} \frac{{r}_{c}}{r} \qquad ( 4.24 )$$

Where E_{c}=e/r_{c}², the electric field at the classical particle surface. Given the dependence of r_{c} on the particle mass, this relation ties the scattered radiation field strength to the particle mass, m.

When the mean interference term is added between the particle radiation and the ZPF electro-magnetism radiation fields of strength Eᵢ=q_{P}/r_{P}², the time averaged field strength is:

$$〈 {E}_{i} sin 2 π t 〉 ≅ \frac{1}{2 π} {E}_{i} \qquad ( 4.25 )$$

From equation 4.25, an energy density of interference between the scattered field and the ZPF E field, using the expression for the Planck charge q_{P}=eα^{-1/2} where α is the fine structure constant, is defined for the metric tensor as:

$${E}_{y}^{2} = 〈 {E}_{r} {E}_{i} 〉 ≅ \frac{1}{2 π} {E}_{c} \frac{{r}_{c}}{r} \frac{{q}_{p}}{{r}_{p}^{2}} \qquad ( 4.26 )$$

Gravity fields thus arise from the random interference of the fields of the ZPF and the radiation fields of the ZPF scattered off of charged particles. Using r_{c}=e²/mc², Eq. 4.26 can be simplified as:

$$\frac{〈 {E}_{r} {E}_{i} 〉}{{B}_{y}^{2}} ≅ \frac{1}{2 π} \frac{e}{{r}_{c}} \frac{1}{r} \frac{{q}_{p}}{{r}_{p}^{2}} \frac{{Gr}_{p}^{2}}{{c}^{4}} = \frac{Gm}{{rc}^{2}} \frac{{α}^{- 1 / 2}}{2 π} \qquad ( 4.27 )$$

$$\frac{1}{2} \frac{{E}_{y}^{2}}{{B}_{y}^{2}} ≅ \frac{{α}^{- 1 / 2}}{4 π} \frac{Gm}{{rc}^{2}} \qquad ( 4.28 )$$

$$\frac{{α}^{- 1 / 2}}{4 π} ≅ 1 \qquad ( 4.29 )$$

The Newtonian gravity potential, Φ is =identified as:

$$\frac{1}{2} \frac{{E}_{y}^{2}}{{B}_{y}^{2}} ≅ \frac{Gm}{r} = Φ \qquad ( 4.3 )$$

The metric tensor in the electric region, Eq. 4.21, is unchanged. The magnetic terms for the radiation field have interference terms with the incident wave that average to zero, as do contributions from Eₓ and E_{z}.

$${g}^{αβ} = {2 [ {E}^{2} - {B}^{2} ]}^{- 1} ( \begin{matrix}{E}_{y}^{2} & 0 & 0 & 0 \\ 0 & {B}_{y}^{2} & 0 & 0 \\ 0 & 0 & - {E}_{y}^{2} & 0 \\ 0 & 0 & 0 & {B}_{y}^{2}\end{matrix} ) \qquad ( 4.31 )$$

Solving for the metric tensor in the magnetic region of the general form yields:

$${g}^{αβ} = {[ 1 - {E}_{y}^{2} / {B}_{y}^{2} ]}^{- 1} [ \begin{matrix}- 2 {E}_{y}^{2} / {B}_{y}^{2} & 0 & 0 & 0 \\ 0 & - 2 & 0 & 0 \\ 0 & 0 & - 2 {E}_{y}^{2} / {B}_{y}^{2} & 0 \\ 0 & 0 & 0 & - 2\end{matrix} ] \qquad ( 4.32 )$$

Accordingly:

$${γ}^{′} = ( 1 - 2 Φ / {c}^{2} ) \qquad ( 4.33 )$$

To obtain the metric contribution at a distance in spherical coordinates, when averaging over the surface of a sphere for quantities which vary with angular distribution, and when a small reduction factor of S is introduced on the total electrical energy density term, term g^{oo}, to compensate for the relativistic distortion of the interference “donut”, by the motion of the charge, its total amount in a volume is conserved, even if its local density is increased by relativistic effects. Accordingly,

$$〈 {g}^{αβ} 〉 = [ \begin{matrix}- 1 - 2 Φ / {c}^{2} & 0 & 0 & 0 \\ 0 & - 1 / {γ}^{′} & 0 & 0 \\ 0 & 0 & - 1 + 2 Φ / {c}^{2} / S & 0 \\ 0 & 0 & 0 & - 1 / {γ}^{′}\end{matrix} ] \qquad ( 4.34 )$$

The corresponding components of the Schwarzschild metric can be found by using the expression, g^{rr}=(x² g^{xx}+y² g^{yy}+z² g^{zz})/r², where r²=(x²+y²+z₂). Averaging over the surface of a sphere of radius r around the charge and noting that the g^{yy} contribution to such an average must vanish, due to the Sin²θ dependence of the “donut shaped” interference pattern around the charge, where the y axis corresponds to θ=0 and π., is the spatial counterpart to the relativistic factor of S made on the energy density term in the time-time portion of the tensor, in order to obtain a spherical metric from a Cartesian one. Averaging again over orientations of the paired magnetic-electric domain, assuming macroscopic isotropy and thus obtaining an approximate value for the value of <g^{rr}>. Thus, the leading order in Φ/c² the time-time portion of the Schwarzschild metric can be expressed:

$$〈 {g}^{tt} 〉 ≅ 1 - 2 Φ / {c}^{2} = 1 - \frac{2 Gm}{{rc}^{2}} \qquad ( 4.35 )$$

After spatial and angular averaging, to leading order in Φ/c², the time-time element of the Schwartzchild metric is:

$$〈 {g}^{rr} 〉 ≅ \frac{- 1}{1 - 2 Φ / {c}^{2}} \qquad ( 4.36 )$$

Therefore, under the form of the metric tensor required for “self-censorship” of the ZPF, and its requirements on the structure of the vacuum to give a Lorentzian metric, the electrodynamics of a charge in the vacuum, scattering electro-magnetism waves from the ZPF, create an interference pattern in the electric field, which leads to the Schwarzschild metric, at least to leading order. The 1/r dependence of the scattered radiation E field and the form of the self-censoring metric, creates the Schwarzschild metric:

$${ds}^{2} = ( 1 - 2 Φ / {c}^{2} ) {dt}^{2} - {dr}^{2} / ( 1 - 2 Φ / {c}^{2} ) + {r}^{2} ( Sin {θ}^{2} d {θ}^{2} + d {ϕ}^{2} ) \qquad ( 4.37 )$$

and, by extension the Newtonian gravity potential.

Therefore, the unification of gravity and electromagnetism is consistent, to first order with the requirements of the Kaluza-Klein model of GR and Maxwell's equations.

Vacuum Decay and Cosmology in the unification of gravity and electromagnetism

### Section 1. The Cosmic Consequences of a Hidden 5^{th} Dimension

Edward Witten made the discovery in 1981 that the presence of a hidden 5^{th} dimension in the vacuum created an instability, causing expanding mirror-surfaced spherical regions to form expand at the speed of light. This “death by disco-ball” scenario stems from the property of spacetime, that several possible minimum energy states are accessible when a hidden 5^{th} dimension is added, and once accessed, these states can form a path to an even lower energy state for the system as a whole. This instability is moderated by the existence of quantum fields which would diffuse the instability among many different particle modes.

In the unification of gravity and electromagnetism, where QED is included implicitly in our concept of spacetime, the presence of a hidden dimension as degree of freedom acts as a “leak” or “tunnel” in spacetime, allowing quantum transitions to occur between two states, empty space and space with a proton-electron pair.

### Section 2. The Probability of a Transition in Unification of Gravity and Electromagnetism

Beginning with consideration of the Dirac Large Numbers Hypothesis, in esu units:

$$\frac{{Gm}_{p} {m}_{e}}{{e}^{2}} ≅ \frac{{r}_{e}}{{R}_{H}} \qquad ( 5.1 )$$

Here G is the Newton Gravitation Constant, mₚ and mₑ are the proton and electron mass respectively, and rₑ is the classical electron radius rₑ=e²/(mₑc²) and R_{H} is the Hubble radius, which is the Hubble Time T_{H} times the speed of light: R_{H}=cT_{H}

$$Ω = \frac{8 π {Gm}_{p} {nR}_{H}^{2}}{3 {c}^{2}} ≅ 1 \qquad ( 5.2 )$$

Where n is the number density of hydrogen plasma in space, critical optical thickness of the cosmos can be correlated as follows:

$${σ}_{Th} {nR}_{H} = \frac{8 π {r}_{e}^{2} {nR}_{H}}{3} ≅ 1 \qquad ( 5.3 )$$

Where σ_{Th}=8πrₑ²/3 is the Thompson scattering cross-section for electro-magnetism radiation. If gravity is mediated by some sort of electro-magnetism quanta, and assuming the hydrogen in space is fully ionized, which can be equated to the critical optical thickness to the condition of a critically open Cosmos:

$$\frac{8 π {r}_{e}^{2} {nR}_{H}}{3} ≅ \frac{8 π {Gm}_{p} {nR}_{H}^{2}}{3 {c}^{2}} \qquad ( 5.4 )$$

Eq. 5.1 can be obtained upon simplification. Implicit in this analysis is the assumption that the electro-magnetism scattering cross section of the electron is also the “unification of gravity and electromagnetism” interaction cross section of the other particles, most specifically the proton. he effective radius of the proton is rₚₑ=1.4×10⁻¹³ cm, which is the Compton wavelength of the charged pion, is approximately equal to the electrostatic radius of the electron rₑ/2=1.41×10⁻¹³. Therefore, for now, the proton and electron can be considered to have approximately the same size when considered in the loose sense of a “unified” interaction. Therefore, the Dirac condition is consistent with the critical density of matter in the universe for gravitational interactions, being correlated with the electro-magnetism critical scattering thickness of the Cosmos. Accordingly, the Dirac relation is consistent with a Cosmos where gravity interactions are a form of electro-magnetism interaction and the visible universe is both critically interacting gravitationally and electromagnetically. The Dirac Condition therefore evokes a concept of the Cosmos where each part of the Cosmos is in interaction with another part through a bath of electro-magnetism-like radiation.

The idea of gravity forces between bodies being caused by the interaction of the bodies with a ‘bath” of quanta is not new, being originally proposed by Fatio in the time of Newton. Such theories have been termed “kinetic theories of gravity” but were not put on a reasonable physical basis until Sakharov equated the bath of radiation with the ZPF.

The unification of gravity and electromagnetism can be tested by adopting a simple Sakharov model of gravity and asking what the radiation pressure must be to cause the gravity force between two electrons floating in space. The gravity force can be equated between two electrons separated by a distance D that is large compared to the dominant wavelengths λ_{bath} of the radiation bath, that is, λ_{bath}/D<<1 to the pressure of a radiation field acting on a Thompson cross section of each electron.

This leads us to write a leading order approximation expression for the gravity interaction between two electrons as being due to a mutual shadowing of an electro-magnetism radiation pressure:

$$\frac{{Gm}_{e}^{2}}{{D}^{2}} ≅ \frac{{σ}_{Th}^{2} {P}_{r}}{{D}^{2}} \qquad ( 5.5 )$$

Solving for the radiation pressure,

$$\frac{{Gm}_{e}^{2}}{{σ}_{Th}^{2}} ≅ {P}_{r} \qquad ( 5.6 )$$

And assuming the electro-magnetism radiation field is Planckian and solve for its temperature, where σ_{SB} is the Stefan-Boltzmann constant:

$$\frac{{Gm}_{e}^{2}}{{σ}_{Th}^{2}} ≅ {P}_{r} = \frac{4}{3} \frac{{σ}_{SB} {T}_{bath}^{4}}{c} \qquad ( 5.7 )$$

Remarkably, the temperature is very close to the observed temperature of the CBR (Cosmic Background Radiation) which is 2.73K

$${T}_{bath} = {[ \frac{3}{4} \frac{c}{{σ}_{SB}} \frac{{Gm}_{e}^{2}}{{σ}_{Th}^{2}} ]}^{1 / 4} = 2. 65 K \qquad ( 5.8 )$$

### Section 2 the Quantum Probability of the Interaction of Unified of Gravity and Electromagnetism

The gravitational interaction is very weak on a subatomic scale compared to the electro-magnetism interaction. In the context of unified of gravity and electromagnetism the Gravitation constant can be expressed approximately as:

$$G ≅ \frac{{e}^{2}}{{m}_{p} {m}_{e}} αexp ( - 2 {( {m}_{p} / {m}_{e} )}^{1 / 2} ) \qquad ( 5.9 )$$

Eq. 5.9 means the key parameter of Eq. 5.1, the ratio of electro-magnetism to gravity forces between an electron-proton pair, can be expressed as:

$${P}_{GEM} = \frac{{Gm}_{p} {m}_{e}}{{e}^{2}} ≡ αexp ( - 2 {( {m}_{p} / {m}_{e} )}^{1 / 2} ) \qquad ( 5.1 )$$

Please note, that consistent with the unification of gravity and electromagnetism concept that gravity interactions are mediated by an electro-magnetism interaction between particles and the quantum ZPF, that this probability of a gravity interaction P_{unified gravity-and-electromagnetism} is linear in α, which is the probability of a quantum electro-magnetism absorption and re-radiation, a photon scattering, by a charge e. For a characteristic “mesoscale” mass mₒ:

$${( {m}_{p} {m}_{e} )}^{1 / 2} = {m}_{o} \qquad ( 5.11 )$$

The gravity interaction between two masses M₁ and M₂ separated by distance D as follows:

$$- \frac{{GM}_{1} {M}_{2}}{{D}^{2}} 2 = \frac{{e}^{2}}{{D}^{2}} [ \frac{{iM}_{1}}{{m}_{o}} ] [ \frac{{iM}_{2}}{{m}_{o}} ] {P}_{GEM} \qquad ( 5.12 )$$

This formula shows that the gravity interaction between two masses can be understood with G acting as an operator or translator. It measures each mass in units of mₒ and applies an imaginary electric charge ie for each unit of mass. The interaction then becomes understood an electro-magnetism interaction between two similar imaginary electric charges, attractive rather than repulsive, but with the “dielectric constant” or attenuation factor of P_{unified gravity-and-electromagnetism}. Alternatively, consistent with P_{unified gravity-and-electromagnetism} containing the factor α, that can be interpreted P_{unified gravity-and-electromagnetism} as quantum probability of an absorption and re-radiation of a “unified gravity-and-electromagnetism photon” by each imaginary charge ie. This is very similar to a formula for G proposed by Clark based on a theory of gravity caused by boson exchange.

Adopting this physical interpretation Eq. 5.12 can be understood as being: “the probability of the” appearance of a spacetime region of curvature rₑ in the Cosmos is P_{unified gravity-and-electromagnetism}.”

### Section 3 Vacuum Decay in the Unification of Gravity and Electromagnetism

The Sakharov and by extension Kaluza-Klein are both derived from the Hilbert action principle of consistent with the vacuum ZPF acting as a reservoir of energy. Let us now ask the question differently using our expression for G.

In the unification of gravity and electromagnetism the presence of the Kaluza-Klein 5th dimension, along with the electron-proton system, leads to instability in the vacuum. The instability does lead to an explosion, the “Big Bang”, and the cosmos we observe is its result.

However, in the unification of gravity and electromagnetism, after the Big Bang, the residual vacuum instability leads only to a “afterglow” or “benign vacuum decay” characterized by the appearance of proton-electron pairs out of the vacuum at a slow rate. This can be seen from the following analysis, where a Ω≅1 condition is assumed, but the existence of “dark energy” is neglected and the “dark matter” is assumed as simply hydrogen in an ionized form that is difficult to detect:

Assuming, in keeping with the Dirac Condition, that the universe is a critical gravitation condition with critical density of hydrogen, n_{c}:

$$\begin{matrix}{n}_{c} = \frac{3}{8 π {Gm}_{p} {T}_{H}^{2}} & Ω ≅ 1\end{matrix} \qquad ( 5.13 )$$

And also is in an “eternal inflation” or “steady state condition” such that an inflation field keeps allowing particles to pop out of the vacuum uniformly throughout the cosmos to maintain the critical density n_{c}

$$\begin{matrix}\frac{dn}{dt} = \frac{3 {n}_{c}}{{T}_{H}} & Ω ≅ 1\end{matrix} \qquad ( 5.14 )$$

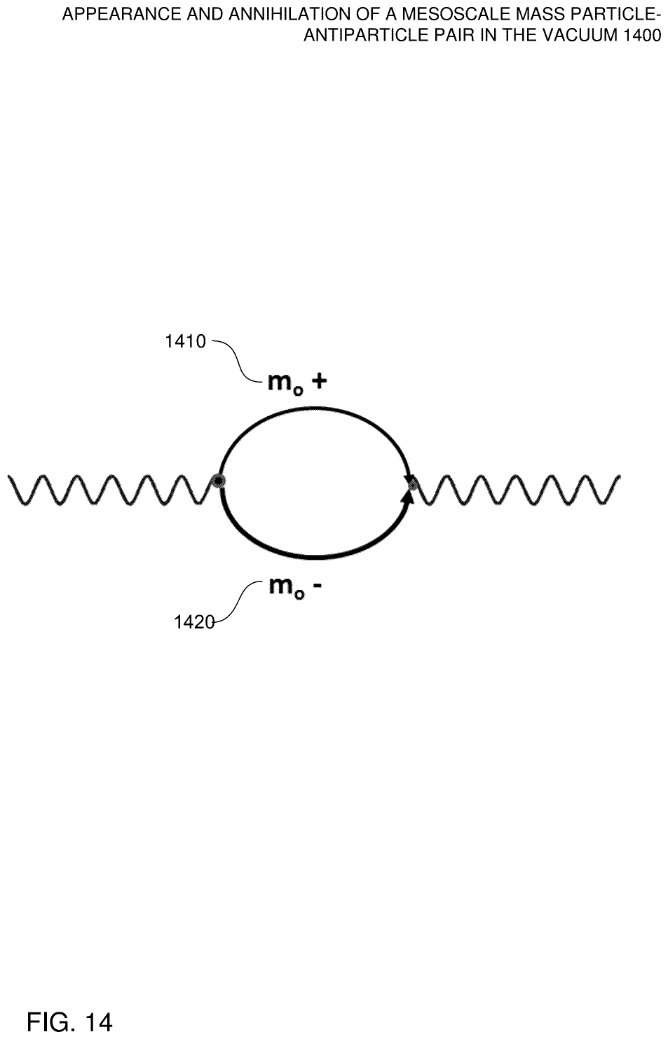

FIG. 14 is a diagram of the appearance and annihilation of a mesoscale mass particle-antiparticle pair in the vacuum 1400, according to an implementation. In FIG. 14, a probability P_{unified gravity-and-electromagnetism} of a unified gravity-and-electromagnetism photon being absorbed and re-emitted to affect a mass transition is assumed, thus transforming one mₒ into a proton 1410 and the other into an electron 1420. This is similar to pair creation and annihilation allowed by the Heisenberg Uncertainty Principle.

$$\frac{dn}{dt} = \frac{3}{8 π {Gm}_{p} {T}_{H}^{3}} \qquad ( 5.15 )$$

α can be defined as the probability of electro-magnetism photon being absorbed and re-emitted by a particle of electric charge e.

Then, be defining a Compton wavelength of mass mₒ: [symbol] = [symbol] /(mₒc) a quantum density fluctuation density can be defined, times the probability of a double mass transition and electro-magnetism photon scattering, as follows.

$$\frac{dn}{dt} = \frac{α c}{} {P}_{GEM}^{2} = α {c [ \frac{α σ}{{r}_{e}} ]}^{4} {P}_{GEM}^{2} \qquad ( 5.16 )$$

This density fluctuation time is the density increase in space due to the unified gravity-and-electromagnetism process of “vacuum decay” into hydrogen. By equating Eq. 5.15 and 5.16 the undetermined parameter of the Hubble Time can be solved. This unlikely process is a Feynman Diagram (see FIG. 11). The complexity of this event, two unified gravity-and-electromagnetism photon scatterings, one electro-magnetism photon scattering, make the event unlikely and also shows that is some instances it is incomplete, with a the electron-proton pair either going directly into a hydrogen ground state with no electro-magnetism radiation, or even more bizarre states such as a proton-negative mesoscale mass particle pairing or electron-positive mesoscale pairing, that will exist as long lived metastable states, perhaps making up a portion of “dark matter”.

Consider that the hydrogen will be born in an ionized state and that by assuming a presently steady-state Cosmos, with vacuum decay occurring just at the proper rate to keep the expanding Cosmos at critical density, solving for the Hubble Time, in this case merely an expansion parameter:

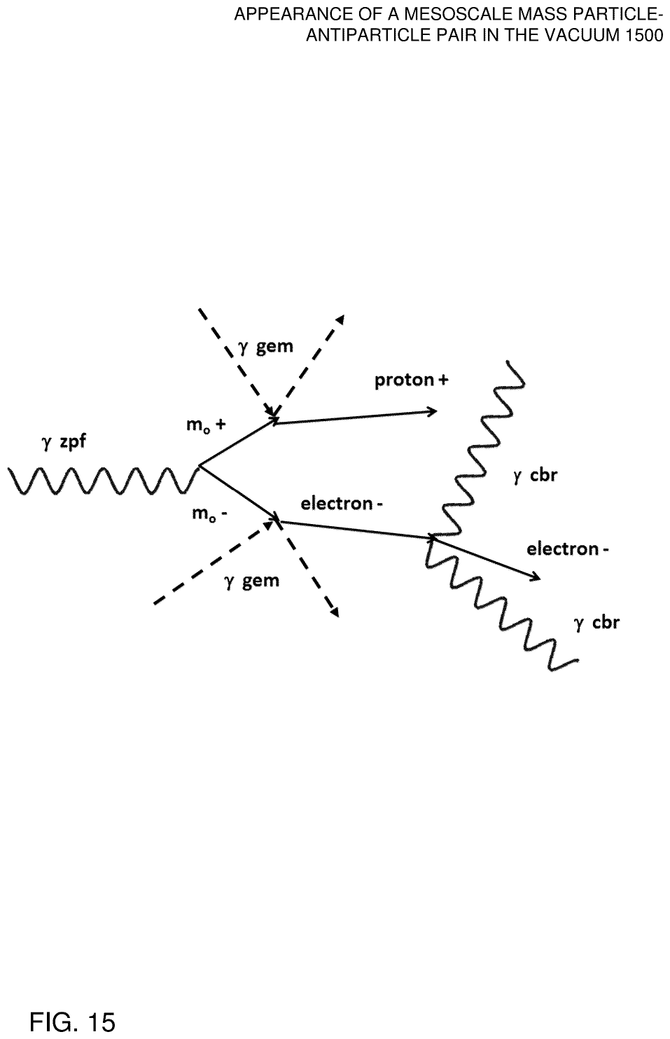

FIG. 15 is a diagram of the appearance of a mesoscale mass particle-antiparticle pair in the vacuum 1500, according to an implementation. In FIG. 15, after a double scattering event with unified gravity-and-electromagnetism photons, the transformation of the unified gravity-and-electromagnetism photons into a proton-electron pair with an additional scattering of electro-magnetism radiation.

$${T}_{H} = {( {\frac{9}{8 π} [ \frac{1}{α σ} ]}^{4} \frac{1}{α} )}^{1 / 3} ( \frac{{e}^{2}}{{Gm}_{p} {m}_{e}} ) \frac{{r}_{e}}{c} ≅ 1.2 \times {10}^{10} yrs \qquad ( 5.17 )$$

This value of T_{H} is close to that which is observed: T_{H}≅14 billion years.

It is tempting to show that this means the Cosmos can be explained, with this result, without recourse to a Big Bang. However, the observed abundances of deuterium and helium isotopes show strongly that the Cosmos began in a much denser state than it is now, so it seems best to assume it began with a bang and then went into a steady state afterwards. The most important part of this result, however, is that the vacuum decay process must result in electro-magnetism radiation since it results in a birth of an electric dipole where it formerly did not exist.

### Section 5 the Cosmic Background Radiation and the Sunyeav-Zelodvich Effect.

Assuming that when the electron-proton pair is born the electron-proton pair form an electric dipole radiator with the electron being the active radiator, assuming the proton-electron pair is born in a near zero-energy state, that is, it born ionized but “cold”, assuming that for this approximate calculation that the electron expands like a miniature “open’ universe and assuming that the electro-magnetism radiation emitted during this process is a black body spectrum emitted by the electron and the radiation pressure is just enough to overcome the electron self-gravity, then

$${P}_{R} {σ}_{Th}^{2} ≅ {Gm}_{e}^{2} \qquad ( 5.18 )$$

where PR is the radiation pressure and σ_{Th} is the Thompson electron cross section for low frequency electro-magnetism wave scattering. The temperature T_{CBR} of the electro-magnetism radiation field can be estimated. This becomes the CBR (cosmic background radiation) temperature.

$${P}_{R} = \frac{4}{3 c} {σ}_{S B} {T}_{R}^{4} \qquad ( 5.19 )$$

$${T}_{bath} = {[ \frac{3}{4} \frac{c}{{σ}_{S B}} \frac{{Gm}_{e}^{2}}{{σ}_{T h}^{2}} ]}^{1 / 4} = 2.65 K \qquad ( 5.2 )$$

Therefore, CBR is only partly due to the Big Bang but also due to vacuum decay that causes new proton-electron pairs to be emitted into the universe. Evidence for this this is seen in striking absence of the SZ (Sunyeav-Zelodvich) effect for galaxies of large red-shift. The SZ effect, the expected distortion of the CBR by dense plasmas in galaxies, disappears for galaxies for large red-shift, as would be expected if the CBR was due to vacuum decay in the line-of-sight to the faraway galaxies.

The CBR would exhibit the expected SZ effect for nearby galaxies, as is observed. Therefore, evidence of unified gravity-and-electromagnetism vacuum decay is present.

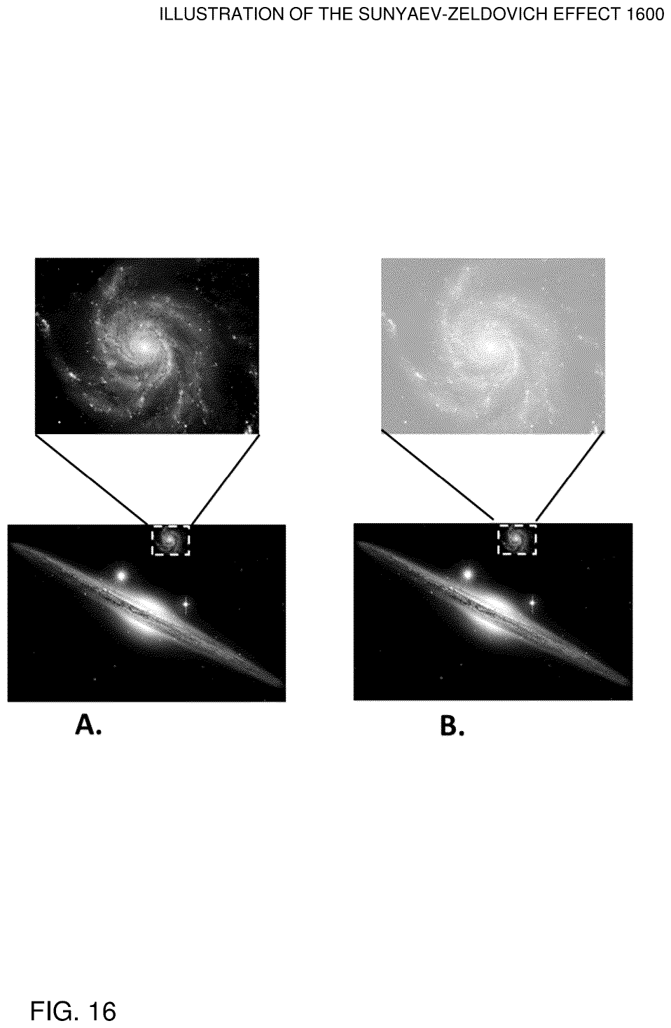

FIG. 16 is an illustration of the Sunyaev-Zeldovich effect 1600, according to an implementation. In FIG. 16, a nearby galaxy appears with strong contrast against the deep space background CBR and so does one farther away (enclosed in a square) if the CBR comes from a surface 13 billion light years away. B. However, if the CBR is being created in the space around us, then the nearby galaxy appears with strong contrast but the faraway galaxy (enclosed in a square) has less contrast when imaged, appearing lost in the mist due to CBR being created in the intervening line-of-sight.

### Section 4 Discussion Dark Energy and Vacuum Decay

So, it is the vacuum itself that is unstable to decay in the unification of gravity and electromagnetism. The products of this decay are the CBR and hydrogen in an ionized state. This analysis has ignored the very important property of the universe that it seems to have “dark energy” an anti-gravity repulsion of the cosmos that makes the universe want to not just expand, but explode, which is understood physically if the Cosmos is assumed to contain many masses M′=iM that are imaginary. The gravity force between two imaginary masses is repulsive:

$$\frac{{GM}_{1}^{′} {M}_{2}^{′}}{{D}^{2}} = - \frac{G ( i {M}_{1} ) ( i {M}_{2} )}{{D}^{2}} \qquad ( 5.21 )$$

Such imaginary masses are tachyonic, and hence must move faster than light and cannot be localized or interact directly with real matter. However the existence of a large mass of tachyons in the universe can be detected by the effect of the large mass of tachyons on the dynamics of spacetime, because the effect of the large mass of tachyons will create a dark energy term.

Therefore, Dark Energy can be modeled mathematically as a tachyonic field and the tachyonic stress tensor can be expressed, for low energies, as a “Cosmological Constant” A that represents dark energy:

$${T}_{ij} = {\partial }_{i} ϕ {\partial }_{j} ϕ - \frac{1}{2} {g}_{ij} ( {g}^{kl} {\partial }_{k} ϕ {\partial }_{l} ϕ - {m}^{2} {ϕ}^{2} ) , \qquad ( 5.22 )$$

where φ is the quantum wave field of the tachyons. Then for low energies (∂ᵥφ˜0), a Cosmological Constant is.

$${T}_{ij} ≅ \frac{1}{2} {g}_{ij} ( {m}^{2} {ϕ}^{2} ) = {g}_{ij} Λ \qquad ( 5.23 )$$

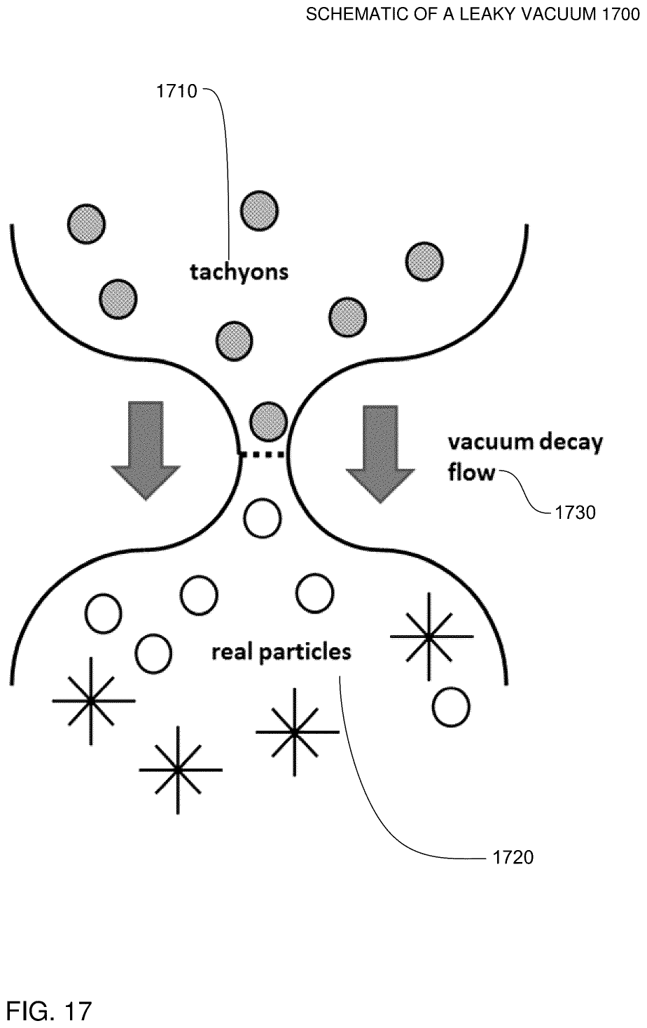

FIG. 17 is a schematic of a leaky vacuum 1700, according to an implementation. The proton-electron pair that appears will “tunnel” from another plane of existence then, by economy of hypothesis, accordingly, the dark energy represents a reservoir 1710 of protons and electrons in a tachyonic state, from which occasionally an electron-proton pair will transition, to become a real proton-electron pair 1720 in the Cosmos as it expands. Accordingly, the vacuum decay 1730 due to 5^{th} dimension can be better described creating as a “leaky vacuum” with the hidden 5^{th} dimension creating pores in the fabric of spacetime though which the proton-electron pairs diffuse from the imaginary state to a real one.

In FIG. 17, a tachyonic “dark energy” particle quantum field transitions into the real universe and appears as hydrogen. Therefore, it appears possible that the Dark Energy, the CBR, the Dirac Condition, and the fact that the universe is near Ω=1 can be explained by the presence of tachyonic matter that a hidden 5^{th} dimension allows to transition to real matter. This would mean that most of the matter in the universe is not real, but imaginary.

unified gravity-and-electromagnetism and the Exchange Bosons of the Strong and Weak Forces

### Section 1. Unification of Gravity and Electromagnetism and Simple Mie Scattering in the Vacuum

The unification of gravity and electromagnetism, by invoking a Kaluza-Klein hidden 5^{th} dimension to unify gravity and electro-magnetism forces, introduces a new phenomenon in the vacuum, that of quantum Mie scattering. The unification of gravity and electromagnetism, by postulating a hidden dimension of size Tₒ=e²/mₒc² to explain the existence and stability of the electron-proton pair, hydrogen, in the universe, must create the opportunity for a quantum resonance. That is, if a favored length occurs in the vacuum, a particle must exist at that length. However, there is subtlety here: the hidden dimension is hidden, it instead makes itself manifest directly through the two stable particles the electron and proton. If the electron is considered as a hollow massless, perfectly conducting, shell covered with charge, the radius is:

$${r}_{c e} = {e}^{2} / ( 2 {m}_{e} {c}^{2} ) \qquad ( 6.1 )$$

This concept applied to the proton results in:

$${r}_{c p} = {e}^{2} / ( 2 {m}_{p} {c}^{2} ) \qquad ( 6.2 )$$

Consider that, although these radii appear unphysical, actually being the result of quantum renormalization of the interactions of point charges with a quantum polarized vacuum, that the radii behave Quantum Mechanically like real conducting spheres. That is, quantum mechanics can treat large numbers of interactions, like a sound wave in a crystal, as if it is one coherent entity. This means these classical radii can support excitations of both the electro-magnetism ZPF and the scalar Radion field.

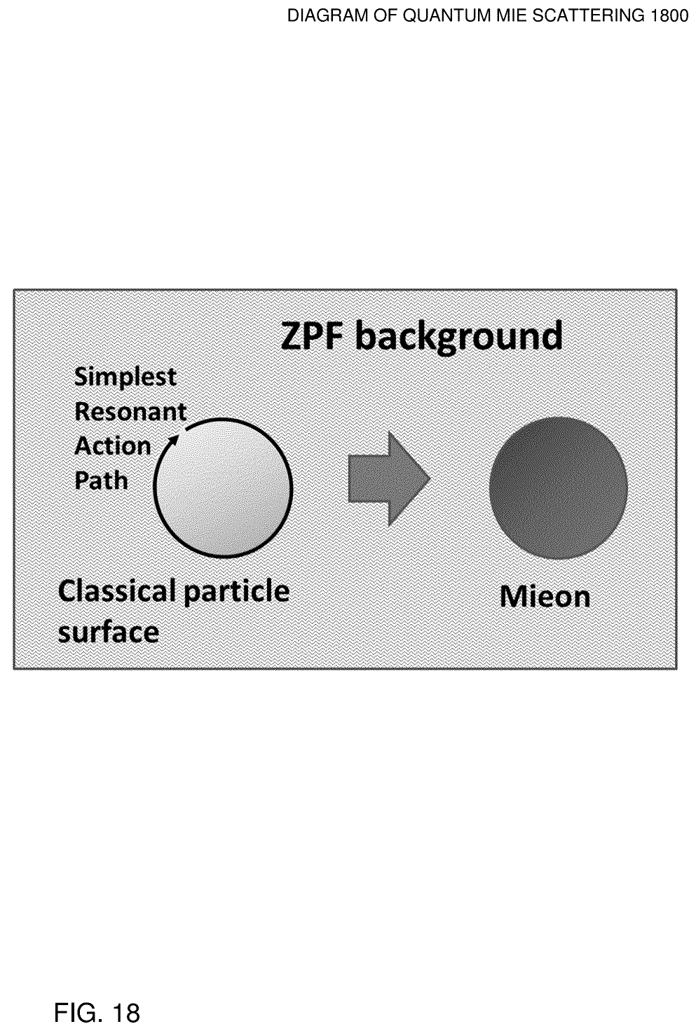

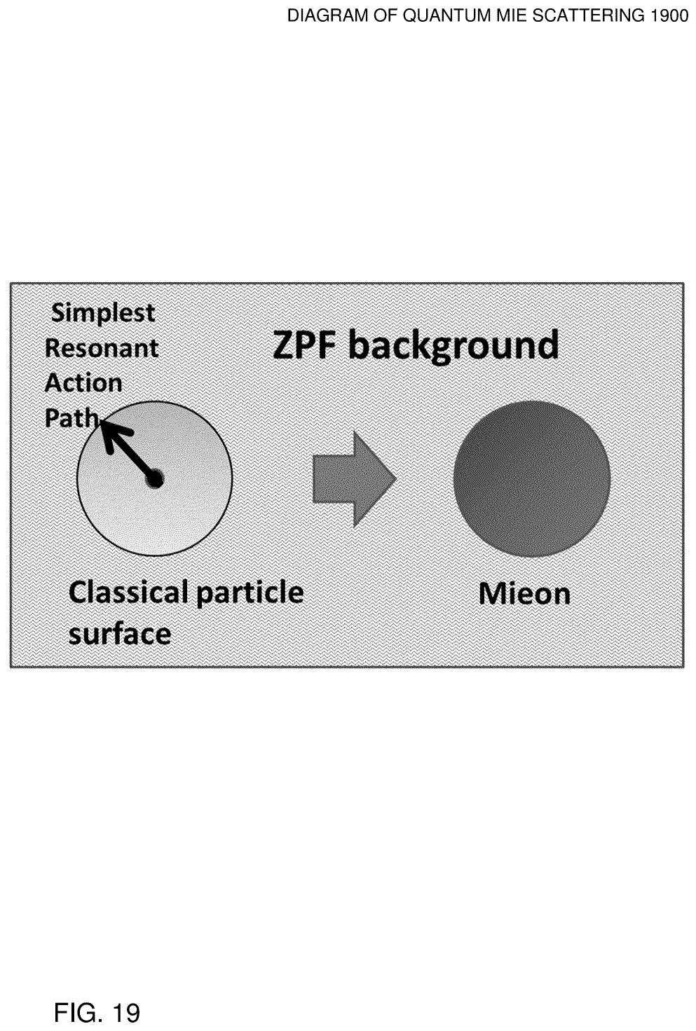

This means quantum Mie scattering can occur due to surface resonances on these conducting spherical surfaces. Quantum resonant excitations on the surfaces, called “Mieons” then must occur and being a wave field, will then propagate away from it. (see FIG. 18 and FIG. 19)

FIG. 18 is a diagram of quantum Mie scattering 1800, according to an implementation. The quantum Mie scattering in FIG. 18 is caused by a resonant excitation on a classical particle surface

FIG. 19 is a diagram of quantum Mie scattering 1900, according to an implementation. The quantum Mie scattering in FIG. 19 is caused by a Radion ZPF resonant excitation of a classical particle.

Since the concept of a quantum resonant path on a classical charged particle surface seems to be but one of many quantum possibilities, is generalized to include alternative paths of lower quantum possibility, in orders of our coupling strengths, α and 1/σ. Therefore, this concept of Mie resonances is expressed mathematically and generalized to include virtual paths of reduced probability of order α, for the electro-magnetism ZPF or 1/σ, for the Radion field by the following:

$$E {ℓ}_{E M} / c = Nh \qquad ( 6.3 )$$

$$E {ℓ}_{R} / c = N σ \frac{{e}^{2}}{c} \qquad ( 6.4 )$$

Where the path lengths [symbol] for electro-magnetism ZPF excitations and where N and P are integer multiple of ½, then:

$${ℓ}_{E M} = ( 2 π {r}_{c} + α P 2 π {r}_{c} ) \qquad ( 6.5 )$$

And likewise for Radion excitations, which are radial:

$${ℓ}_{R} = ( 2 {r}_{c} + ( P / σ ) 2 {r}_{c} ) \qquad ( 6.6 )$$

where E is the particle rest energy, c, is the speed of light h is Planck's constant. Rearranging, the electro-magnetism ZPF is:

$$E = Nhc / ( 2 π {r}_{c} + α P 2 π {r}_{c} ) = N ℏ c / {r}_{c} ( 1 + α P ) \qquad ( 6.5 )$$

$$E = 2 {Nm}_{c} {c}^{2} / α ( 1 + α P ) \qquad ( 6.6 )$$

Where m_{c} is the particle mass generating the classical radius

$$E ℓ / c = N σ \frac{{e}^{2}}{c} \qquad ( 6.7 )$$

$$ℓ = ( 2 π {r}_{c} + ( P / σ ) 2 π {r}_{c} ) \qquad ( 6.8 )$$

$$E = 2 σ {Nm}_{c} {c}^{2} / ( 1 + P / σ ) \qquad ( 6.9 )$$

Beginning with the simplest case where N=½ and P=0 at classical radius of the mesoscale particle r_{cm}=rₒ/2, the mass of the proton as a Radion excitation is:

$${m}_{p} = σ {m}_{o} {c}^{2} \qquad ( 6.1 )$$

Under the same circumstances of N=½, M=0 for an electro-magnetism ZPF scattering.

$${m}_{η c} = {m}_{o} {c}^{2} / α = 3 0.6 MeV \qquad ( 6.11 )$$

This mass is then the electro-magnetism ZPF Mieon associated with hidden dimension and is very close to the mass of the elusive Σ(3000) baryon at a mass of 3000 MeV, the eta-c charmed meson, at a mass of 2984 MeV with no charge or spin, and the much longer lived long lived J/ψ meson at 3097 MeV. So this this a mass-energy region of much activity, as expected if it corresponded to a Compton wavelength nearly matching the hidden dimension size. Following this procedure for N=½ M=0 the electro-magnetism ZPF excitation off the proton classical surface is obtained as follows:

$${m}_{H} = {m}_{p} {c}^{2} / α = 128.6 GeV \qquad ( 6.12 )$$

This is the approximate mass of the Higgs Boson of spin 0 and charge 0, as is σm_{ηc}.

So that:

$$\frac{{m}_{H}}{{m}_{η c}} ≅ {( {m}_{p} / {m}_{e} )}^{1 / 2} = σ = 42.85 \qquad ( 6.12 )$$

The experimental value is m_{H}/m_{ηc}≅42.6, so agreement is good.

Given the simple cases N=1, P=0, or first order, Mieon resulting from resonant modes on the electron classical surface. From Eq.6.6:

$${m}_{\pm π} = 2 {m}_{e} {c}^{2} / α = 140. MeV \qquad ( 6.11 )$$

Which is the mass of the charged π-meson which has spin 0. At first it is confusing to associate the electron classical radius with the proton, however because CP violation favors matter over anti-matter the existence of positive charge of +e must induce negative electrons to appear in the vacuum at that radius. This means even though it is a proton, virtual electrons are present around it because of QED. This, and fact that positive charges are treated differently by nature than negative ones-protons and electrons are both stable-means that a positive charge e can have associated with it a radius associated with an electron and ‘strike forth’ pions. Accordingly, the electric classical radius of the proton is:

$${m}_{\pm W} = 2 σ {m}_{p} {c}^{2} / α = 80.41 GeV \qquad ( 6.11 )$$

Which is the mass of the charged W-boson which has spin 1. These formulas are quite accurate as is seen in Table 1. In both cases the spin of the mieon is the spin on the classical surface of the parent particle is plus or minus [symbol] /2. The ratio of the masses of these two bosons:

$$\frac{{M}_{W}}{{m}_{π \pm }} = {σ}^{3} α = 574.3 \qquad ( 6.12 )$$

This is versus the actual experimental value m_{w}/m_{π±}=574.2, so again agreement is good. The particles resulting from simple Mie scattering (P=0) in the unification of gravity and electromagnetism are summarized in Table 1.

TABLE 1
Particle masses predicted by the unification of
gravity and electromagnetism simple Mie, P =
0, scattering theory and observed masses.

| | Predicted Mass - | | Observed Mass- | | |
|---|---|---|---|---|---|
| Particle | Energy | | Energy | | error |
| ±Charged Pion | 140.05 | MeV | 139.60 | MeV | 0.3% |
| ±W Boson | 80.409 | GeV | 80.398 | GeV | 0.014% |
| Eta-Charmed Meson | 3000.6 | MeV | 2985 | MeV | 0.7% |
| Higgs Boson | 127.69 | GeV | 126.0 | GeV | 1.3% |

### Section 2. Unification of Gravity and Electromagnetism and Complex Mei Scattering in the Vacuum

The path integrals on classical particle surfaces “tumble” in 5 space, and to first order, all the degrees of freedom are identical. This will allow 5-fold perturbations to develop on the path integral so that virtual paths exist that add or subtract to the effective length of the path, (see FIGS. 4 and 5) so M=5.

$$E = 2 {Nm}_{c} {c}^{2} / α ( 1 + 5 α ) \qquad ( 6.6 )$$

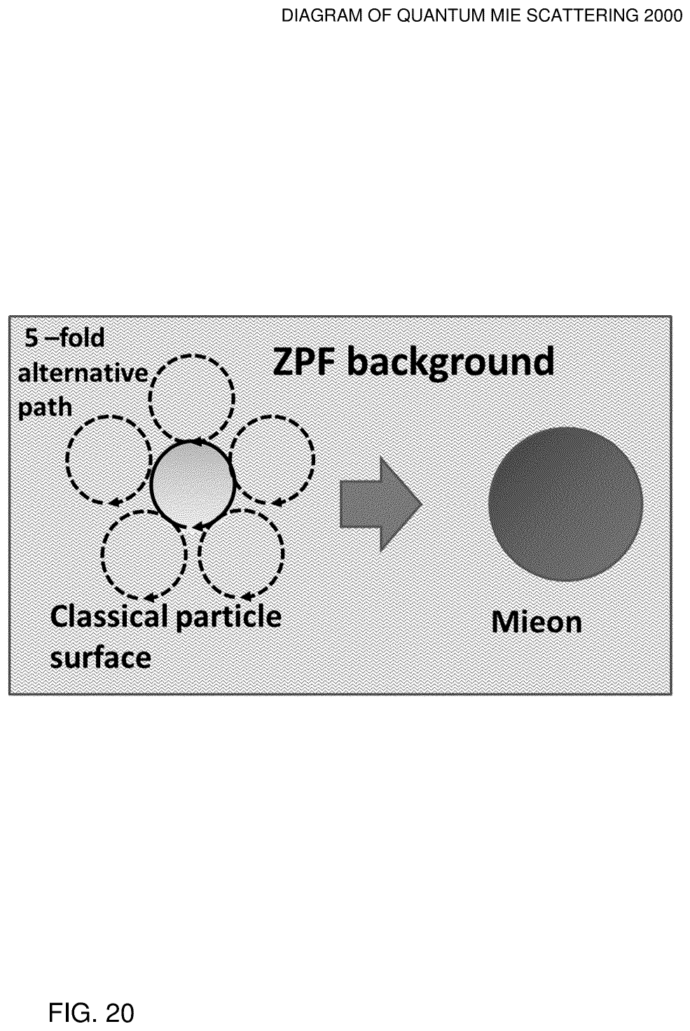

FIG. 20 is a diagram of quantum Mie scattering 2000, according to an implementation. The quantum Mie scattering in FIG. 20 is caused by a resonant excitation on a classical particle surface plus a five-fold alternative quantum path.

Accordingly for the case of N=5/2 and P=5 for mₒ

$${m}_{\pm μ} = 5 {m}_{o} {c}^{2} / ( 1 + 5 α ) = 105.63 MeV \qquad ( 6.6 )$$

So the electron-muon is in fact a high order resonance off the hidden 5^{th} dimension. For the electron:

$${m}_{π o} = 2 {m}_{e} {c}^{2} / α ( 1 + 5 α ) = 135.1 MeV \qquad ( 6.6 )$$

Where m_{c} is the particle mass generating the classical radius

$$E = 2 σ {Nm}_{c} {c}^{2} / ( 1 + P / σ ) \qquad ( 6.9 )$$

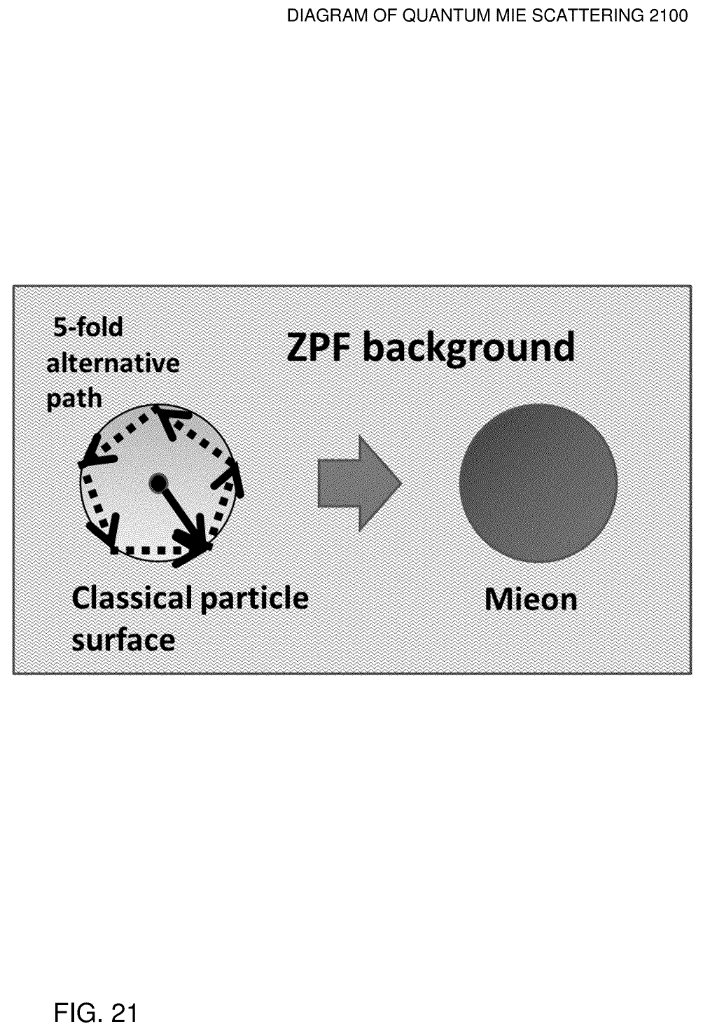

FIG. 21 is a diagram of a quantum Mie scattering 2100, according to an implementation. The quantum Mie scattering in FIG. 21 is caused by a resonant excitation on a classical particle structure with a 5-fold alternative path also being excited.

Where P=−5 N=1 for the proton. This perturbation features “backflow”, a negative contribution to the line integral:

$${m}_{z} = 2 σ {m}_{p} {c}^{2} / ( 1 - 5 / σ ) = 91.03 GeV \qquad ( 6.9 )$$

Finally, where N=½ and for M=0 a Radion scattering off the electron, which is a new particle.

$${m}_{o} = σ {m}_{e} {c}^{2} = 21.9 MeV \qquad ( 6.9 )$$

This is the mesoscale particle, which termed as the M* particle. The M* particle has never been observed, but some evidence for its existence can be found, and will be discussed in the next section. The M* particle can be expected to be charge-neutral and have spin 0 like the Higgs Boson. The predicted particle masses and those experimentally observed are summarized in Table 2. The M* particle is expected to decay into electron-positron pairs and photons.

TABLE 2
Particle masses predicted by the unification
of gravity and electromagnetism and observed
masses including the new predicted M* particle

| | | | |
|---|---|---|---|
| | Predicted Mass - | Observed Mass- | |
| Particle | Energy | Energy | error |

| | | | | | |
|---|---|---|---|---|---|
| Neutral Pion | 135.12 | MeV | 134.98 | MeV | 0.1% |
| Z Boson | 91.03 | GeV | 91.19 | GeV | 0.2% |
| Muon | 105.63 | MeV | 105.66 | MeV | 0.02% |

| | | | | |
|---|---|---|---|---|
| M*particle | 21.9 | MeV | **** | **** |

Unexpectedly, the unification of gravity and electromagnetism created a doorway to understanding with two short-range forces of nature the Weak and Strong nuclear forces, because in unifying gravity and electro-magnetism in a geometric theory, the unification of gravity and electromagnetism produced a geometric scale regime for subatomic particles and the regime for the interactions of the subatomic particles. The quantum particles which create the short range forces are thus scatterings out of the full spectrum of the ZPF by the resonant structures. The unification of gravity and electromagnetism produced the picture of electro-magnetism forces not only between charged objects but also between uncharged structures that can be extended to include short-range nuclear forces.

### Section 3. Evidence the Unified Gravity-and-Electromagnetism Mesoscale Particle

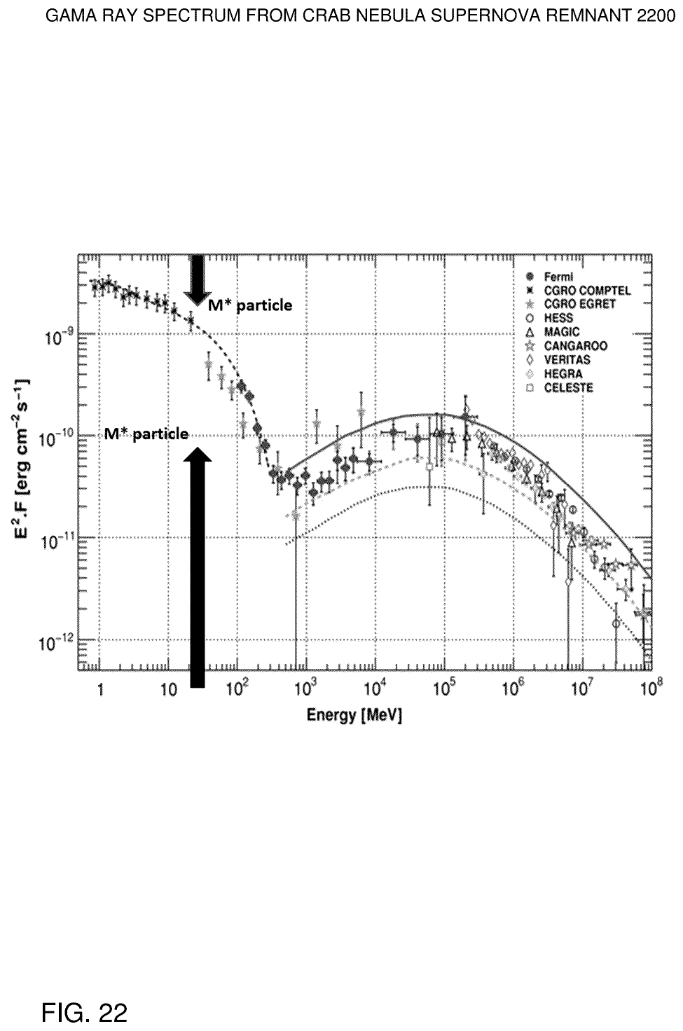

FIG. 22 is a diagram of a Gama ray spectrum 2200 from Crab nebula supernova remnant.

Evidence for the existence of the M* particle can be found in astrophysical data. The brightest gamma ray source in the heavens is the supernova remnant, the Crab nebula. The continuous spectrum of Gamma rays shows an abrupt change at the approximate energy of 22 MeV as would be expected if M* existed, as in FIG. 22.

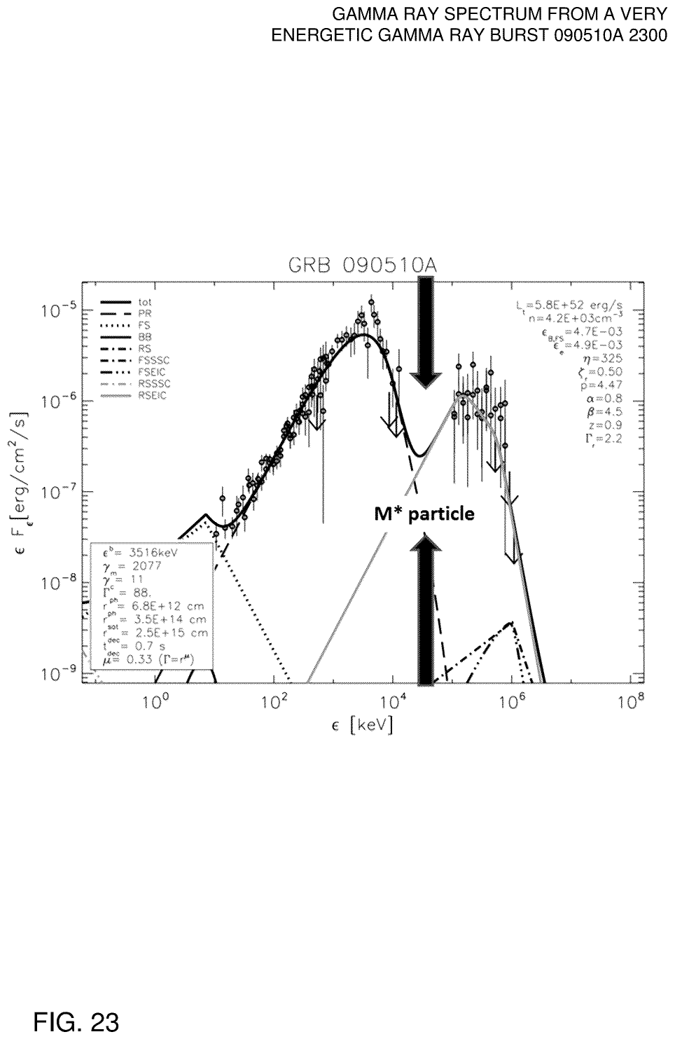

FIG. 23 is a diagram of Gamma ray spectrum from a very energetic Gamma Ray Burst 090510A.

Further evidence is seen in the continuous gamma spectrum from the very energetic Gamma Ray Burst 090510A, as in FIG. 23.

### Section 4. Summary

Therefore, the effects of the hidden dimension on the vacuum, and the consequent classical particle surfaces can be understood as creating the possibility of quantum Mie scattering, with the result of a new particles. In particular the M* particle is predicted.

The application of this idea results in the π meson and the W and Z boson masses to high accuracy as quantum Mie scatterings off of the classical electron and proton particle structures. Thus, the unification of gravity and electromagnetism unifies the two long-range forces of nature, gravity and electro-magnetism, and expectedly lays the groundwork for understanding the Strong and Weak forces as well

The muon may also be explained by the unification of gravity and electromagnetism as a favored higher resonance on the hidden dimension size rₒ.

Finally, and perhaps most importantly, the Higgs Boson mass is recovered from this Mieon model as a resonance off the proton, the primary source of known mass in the Cosmos.

### The Unification of Gravity and Electromagnetism and the Standard Model

Section 1. unified gravity-and-electromagnetism Unification and the Standard Model

The Standard Model is a grand edifice assembled over decades of patient labor, that explains most of reality, at the level of the everyday to the subatomic. The Standard Model is a superb testament to human intellectual endeavor, but like all concepts of the Cosmos, the Standard Model must be incomplete, even as the human mind and its knowledge is limited, and here and there the Standard Model is troubled by glaring problems.

The Standard Model of Physics does not include gravity since General Relativity has defied all attempts at quantization, except for the case of weak fields. With this major exception the Standard Model gives a coherent picture of most of the physics that can be experimentally verified: Quantum Electrodynamics, the Quark theory, with its many varieties of Quarks, as a theory of the Strong force, The Electro-Weak unification theory including the W and Z particles with its requirement for the Higgs Boson to give particles mass. However, gravity has been included informally in the Standard Model to solve some of its serious problems.

The Standard model predicts that the quantum ZPF must give the vacuum not just the density of lead, but of infinity. Gravity, being let into the discussion by a back door, rescues the Standard Model from complete embarrassment by lending itself to a rudimentary quantization, and produces the Planck length, so that the ZPF has a high frequency cutoff. Gravity then leaves, again by the back door, with the Standard Model “patched” so that instead of the absurd prediction of infinity for the mass density of the vacuum, it is reduced to the merely ridiculous value of 10⁹⁶ grams per cc. At this point the Yakov Zeldovich can cancel this value with his cosmological constant, again from gravity theory. Similar problems exist in particle mass-renormalization, where high frequency cutoffs at the Planck scale must be introduced, even if cleverly disguised. So it can be said that General Relativity is a pillar of the Standard Model even if it is not acknowledged.

The unification of gravity and electromagnetism is an attempt to extend the Standard Model to include gravity more formally than the Standard Model does now, so that a model of physics that explains the Cosmos from the Hubble Radius to the Planck Length will exist. The unification of gravity and electromagnetism, as a consequence of its 5 dimensional geometry, also explains why the charges of the quarks are in multiples of ⅓, among other things. Here the Unification of gravity and electromagnetism, with its hidden dimension size of rₒ, corresponding to a particle mass of approximately 3000 MeV, and a split of a zero spacetime interval into a time-like portion, the electron, and space-like particle, the proton, is shown to be reconciled with the quark model of the proton with the requirement of Planckian, high entropy physics even in a subatomic setting. In all of this the seminal connection by Bekenstein and Hawking of gravity with entropy and thus mass with entropy is seen to be central.

### Section 2. Quarks and the Subdimensions of the 5^{th} Dimension

Quarks in three colors appear naturally in the unification of gravity and electromagnetism. As was previously discussed the Kaluza-Klein fifth dimension can be considered to be a new dimension which can replace either time or space in a light-like interval, as was seen in Eq. 2.25 The fifth-dimension then becomes a constrained image of either the time or space portion of spacetime and thus has four sub-dimensions. The electron corresponds to a “time-like” or scalar entity while the proton corresponds to a space-like component, having three sub-dimensions. However, the three sub-dimensions in this case cannot actually be resolved singly but only collectively. However, can minimize the volume of this three-space, given the two constraints of charge conservation and the conservation of mesoscale radius, defined in Eq. 7.3, which is, respectively, a constraint on the sum of the quark charges, and the sum of the squares of quark charges. Accordingly, the constrained relaxation of the system, in the form a Lagrange multiplier system:

$${q}_{1} {q}_{2} {q}_{3} + {λ}_{1} ( {q}_{1}^{2} + {q}_{2}^{2} + {q}_{3}^{2} ) + {λ}_{2} ( {q}_{1} + {q}_{2} + {q}_{3} ) \qquad ( 7.1 )$$

Where the three-volume formed by the quark charges: q₁q₂q₃ is minimized, subject to the constraints that the total charge of the quark charges: q₁q₂q₃ is that of the electron (in electron units):

$${q}_{1} + {q}_{2} + {q}_{3} = 1 \qquad ( 7.2 )$$

And the sum of the squares of formula 7.2 is also unitary, so the classical radius of the compound particle is that of an electron:

$${q}_{1}^{2} + {q}_{2}^{2} + {q}_{3}^{2} = 1 \qquad ( 7.3 )$$

Accordingly, upon varying the values of q₁, q₂, q₃ respectively, the three equations:

$${q}_{1} {q}_{2} + 2 {λ}_{1} {q}_{3} + {λ}_{2} = 0 \qquad ( 7.4 )$$

$${q}_{1} {q}_{3} + 2 {λ}_{1} {q}_{2} + {λ}_{2} = 0 \qquad ( 7.5 )$$

$${q}_{3} {q}_{2} + 2 {λ}_{1} {q}_{1} + {λ}_{2} = 0 \qquad ( 7.6 )$$

which have the solutions:

$${λ}_{1} = \frac{1}{3} {λ}_{2} = - \frac{2}{9} \qquad ( 7.7 )$$

$${q}_{1} = - \frac{1}{3} , {q}_{2} = {q}_{3} = \frac{2}{3} \qquad ( 7.8 )$$

This corresponds to the standard quark model, and the second solution is that of an electron with q₁=−1 and q₂ and q₃=0. Thus, in solving the problem of the structure of a 5th dimension, one finds that its 3-volume, upon being minimized, with constraints, yields the charges of the quark system. Thus, the unification of gravity and electromagnetism, by requiring baryons to be “spacelike” to balance the “timelike” electron, and be of minimum size, is actually compatible with the Standard Model.

Section 3. The Mass of the Proton from a Planckian Quark Model

The proton has inside its radius of approximately r_{c}=rₑ/2, the approximate Compton radius of the charged pion. Three dynamic entities, quarks, are inside, as a reflection of the space-like structure it acquires when the 5th dimension split the vacuum spacetime interval. The quarks are inseparable, and cannot be seen in isolation. In the unification of gravity and electromagnetism this is due to the fact that the proton is a three-dimensional object and cannot be made into something of lower dimensionality, just like a rubber ball can be squashed but not reduced to infinitesimal thickness, when released from pressure it rebounds to its normal spherical shape. What also occurs, in the unification of gravity and electromagnetism, is that the proton is isotropic and spherical and this means that the quarks are best modeled as chaotically mixed at all times. In the unification of gravity and electromagnetism the proton is full of entropy.

Therefore the proton can be modeled as full of chaotic electro-magnetism fields as a spherical shell of radius r_{c}-rₑ/2 full of Planckian radiation fields, one field for each of the 3 color charge fields (see FIG. 1.). Considering that the electric charge resides on the surface of the shell, which is full of neutral π mesons, and considering the shell to be thin, assuming an emissivity of close to one ε≅1.0 so the Black Body model will be valid, and selecting the temperature of the Planckian fields to be kT=m_{πo}c²=264 mₑc², the mass of the neutral pion, the Black Body modes of longer wavelength than the radius of a spherical cavity are cut off, however, the wavelength of energy maximum for a Planckian distribution is approximately ⅕ that of λ=kT/(hc)=9.183×10⁻¹³ cm where h is the normal form of Planck's constant. A cutoff of wavelengths longer than that corresponding to kT thus leaves approximately 96.6% of the energy in shorter wavelength modes intact, thus such a cutoff does not violate our Planckian assumption.

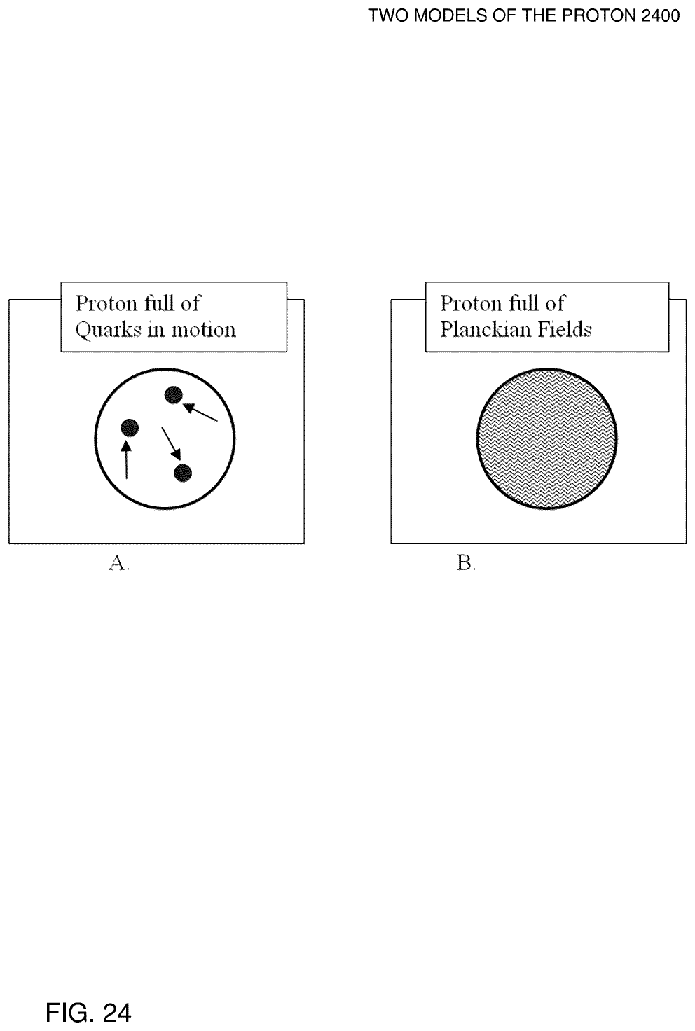

FIG. 24 is a diagram 2400 of two models of the proton. Side A is a model of a proton having three rapidly and chaotically moving quarks. Side B is a model of a proton having fields in the proton as being at maximum entropy, due to quark free motion, that is: Planckian.

Therefore, assuming the proton is full of electro-magnetic energy W in 3 Planckian modes or colors in a volume V_{c} of a sphere of radius r_{c}, then:

$$W = ( 0.9 \; 66 {V}_{c} ) 3 [ \frac{8 {π}^{5}}{15} ( \frac{{( kT )}^{4}}{{( hc )}^{3}} ) ] \qquad ( 7.9 )$$

Here the Planckian modes must be considered independent, so the Planckian modes simply add to each other. Using the fact that r_{c}/(m_{πo}c²/hc)=1/6.518, accordingly:

$$W = 6 {π}^{5} 0.966 [ \frac{16 π}{45} ( 264.2 ) {m}_{e} {c}^{2} ( \frac{{r}_{c}^{3}}{{λ}_{π o}^{3}} ) ] \qquad ( 7.1 )$$

$$\begin{matrix}W = 6 {π}^{5} {m}_{e} {c}^{2} ( 0.966 ) [ \frac{16 π}{45} ( \frac{264.2}{276.9 )} ) ] \\ = 6 {π}^{5} {m}_{e} {c}^{2} ( 1.03 )\end{matrix} \qquad ( 7.11 )$$

$$W ≅ 6 {π}^{5} {m}_{e} {c}^{2} \qquad ( 7.12 )$$

Therefore, the Lenz-Wyler formula, mₚ/mₑ=6π⁵ which is accurate to 17 parts per million, can be derived approximately from a simple model of the proton as containing 3 independent Planckian fields of temperature corresponding to the rest energy of the neutral π meson. This is consistent with the concept that entropy exists even in the subatomic scale and is associated with mass and gravity.

### Section 4. The Neutron Mass

In among the unstable particles found in nature, none is more stable than the neutron. In isolation a neutron has a half-life of 15 minutes, longer than many radioactive isotopes. The neutron can viewed, in first approximation, as a highly compressed form of hydrogen, since it decays into an electron and a proton, plus a neutrino. The neutrino can be considered as representing part of the binding potential of the system. However studies have revealed no electron running around with the quarks inside the neutron instead its mass difference from the proton seems attributed to the Weak interaction. Using the line integral models developed above, the mass energy of the proton can be expressed as being similar to the proton in being a line integral on the hidden dimension rₒ but, similar to the Z particle, it also includes a second order contribution due to “backflow” that increases its mass.

$$E = \frac{σ {e}^{2}}{{r}_{o}} ( \frac{1}{1 - \frac{5}{2} {σ}^{- 2}} ) \qquad ( 7.13 )$$

This leads to the expression for the neutron mass:

$${m}_{n} = {m}_{p} {c}^{2} ( \frac{1}{1 - 5 / 2 {σ}^{2}} ) = 938.2 \; 72 GeV ( 1.001363 = 939.5 \; 51 GeV \qquad ( 7.14 )$$

Formula 7.14 agrees with the measured value of mₙ=939.565 to within 1.5 parts per 100,000. Therefore, similar to the W and Z particles of the Weak Force the relationship between the proton is found with an expansion parameter of σ and, similar to the relationship between the W and Z particles, the neutron arises because of a “backflow” or “shortcut”, correction to the line integral on the hidden dimension size. The expression for the neutron mass can be written in terms of the proton and electron mass and obtain:

$${m}_{n} = {m}_{p} + 2.532 {m}_{e} \qquad ( 7.15 )$$

The neutron mass can therefore be written approximately as:

$${m}_{n} ≅ {m}_{p} + \frac{5}{2} {m}_{e} \qquad ( 7.16 )$$

Therefore, the neutron mass is approximately that of a proton plus a contribution due to an Weak component spread out over 5 dimensions with ½ mₑ per degree of freedom. The neutron can be thus modeled approximately as a proton with an electron thermal distribution inside it but moving a 5 space, being thus only partly present in the 3-space volume.

Therefore, these highly accurate expressions for both the proton-electron mass ratio and the neutron mass from the Standard Model are consistent with unification of gravity and electromagnetism concepts.

### Section 5. The Standard Model and the Value of G

A similar formula for G can be obtained, as that obtained by the unification of gravity and electromagnetism, by using results from the Standard Model of Physics. This takes advantage of recent results in renormalization and the value of the fine structure constant.

It is a wellOknown result of Sakharov that gravitation constant can be found as an integral over the ZPF (Zero Point Fluctuation) spectrum:

$${G}^{- 1} ≅ \frac{ℏ}{2 {c}^{5}} {\int }_{0}^{{ω}^{*}} ω d ω = \frac{ℏ {ω}_{P}^{2}}{{c}^{5}} , \qquad ( 7.17 )$$

$$G = \frac{{c}^{3} {r}_{P}^{2}}{ℏ} . \qquad ( 7.18 )$$

The Sakharov model for the gravity force is basically that of a radiation pressure produced by the ZPF and is successful in the sense that is self-consistent. However, what is needed is a formula for the Planck length that is independent of G.

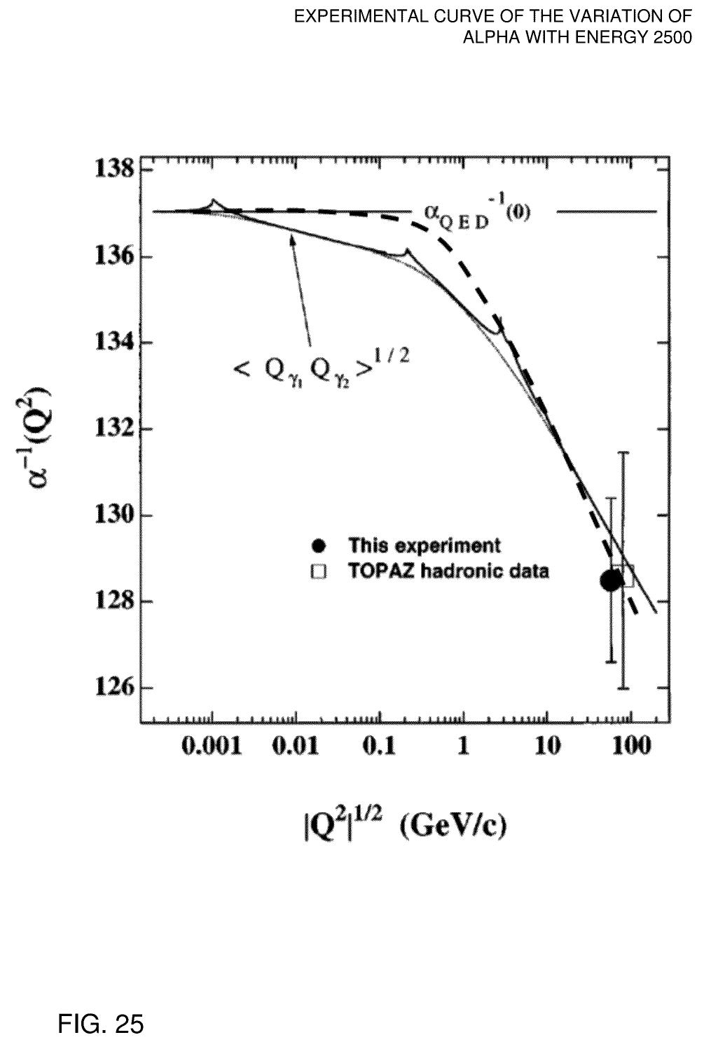

FIG. 25 is a diagram 2500 of an experimental curve of the variation of α with energy, according to an implementation. In FIG. 25, the heavy dashed line is the approximate curve of Eq. 7.19.

The fine structure constant, α, has a logarithmic dependence on energy formed by an integral with cutoffs at high and low energy. Based on the success of the Sakharov formula for G it can be postulated that the high energy cutoff of the logarithmic term in renormalization must be the Planck scale. The variation of α with energy has been successfully predicted by such a model. The variation of alpha with energy, as in FIG. 25, can be approximated in the region of 0 to 10 Gev from its curve of variation as the function

$${α}^{- 1} ≅ 3.20 ln [ \frac{{W}^{*} + {w}_{p r o b e}}{{W}_{P}} ] \qquad ( 7.19 )$$

Thus, the value of α⁻¹ asymptotes to 137 at Wp<<W*. Since the expression in Eq. 7.19 involves the Planck energy, it can be inverted to find an approximate expression for the Planck length:

$${r}_{P} ≅ \frac{h}{{M}_{η c} c} exp [ \frac{- 1}{3.20 α} ] .$$

From which one obtains by r_{P}=(G [symbol] /c³)^{1/2} for G.

$$G ≅ \frac{ℏ c}{{M}_{ηc}^{2}} exp [ \frac{- 1}{1.60 α} ] = 7 \text{.10} \times {10}^{8} dyne - {cm}^{2} {g}^{- 1} \qquad ( 7.21 )$$

This expression is very similar to that derived by Clarke, based on a quantum model of gravity forces as being due to boson exchange, and also resembles the expression derived by T'Hooft.

$$\frac{{e}^{2}}{{m}_{p} {m}_{e}} α = \frac{ℏ c}{{M}_{η c}^{2}} \qquad ( 7.22 )$$

$${[ 3.2 α ]}^{- 1} = {( {m}_{p} / {m}_{e} )}^{1 / 2} = 42.8503 \qquad ( 7.23 )$$

Therefore, the unification of gravity and electromagnetism, in its salient points can be considered validated and somewhat in agreement with the Standard Model of physics.

### Section 6. Entropy and the Fine Structure Constant

Hawking emphasizes that single particles possess entropy because it creates gravity, and gravity is associated with thermal electro-magnetism fields. The concept that a single particle can create entropy can be applied to the problem of a single electron interacting with the ZPF field. The fine structure constant can be interpreted as the probability of an electron absorption and emission of a photon during an electron electro-magnetism interaction time, which is classically the time it takes an electro-magnetism wave to cross an electron diameter. In a complete picture of an electro-dynamic vacuum this electro-magnetism interaction time is better understood as the sum of effects over many layers of vacuum polarization charge surrounding the electron or other charged particle.

The electron moving at the speed of light undergoes multiple scattering events by the ZPF each Compton length, thus the ratio of the light transit time of the electron classical radius rₑ=e²/mₑc², which is the electron interaction time, to the Compton radius, gives the probability of photon absorption and radiation by an electron, which is the fine structure constant:

$${α}^{- 1} = \frac{{r}_{c}}{{r}_{e}} = \frac{{λ}_{c}}{2 π {r}_{e}} = \frac{ℏ c}{{e}^{2}} = 137.0 \; 36 \qquad ( 7.24 )$$

The model of the electron can be compared to a perfect absorber, which must absorb a photon and reradiate the photon in every direction. The electron is modeled two ways as a perfectly absorbing sphere and a cube or similar shape of the same volume and approximately the same surface area.

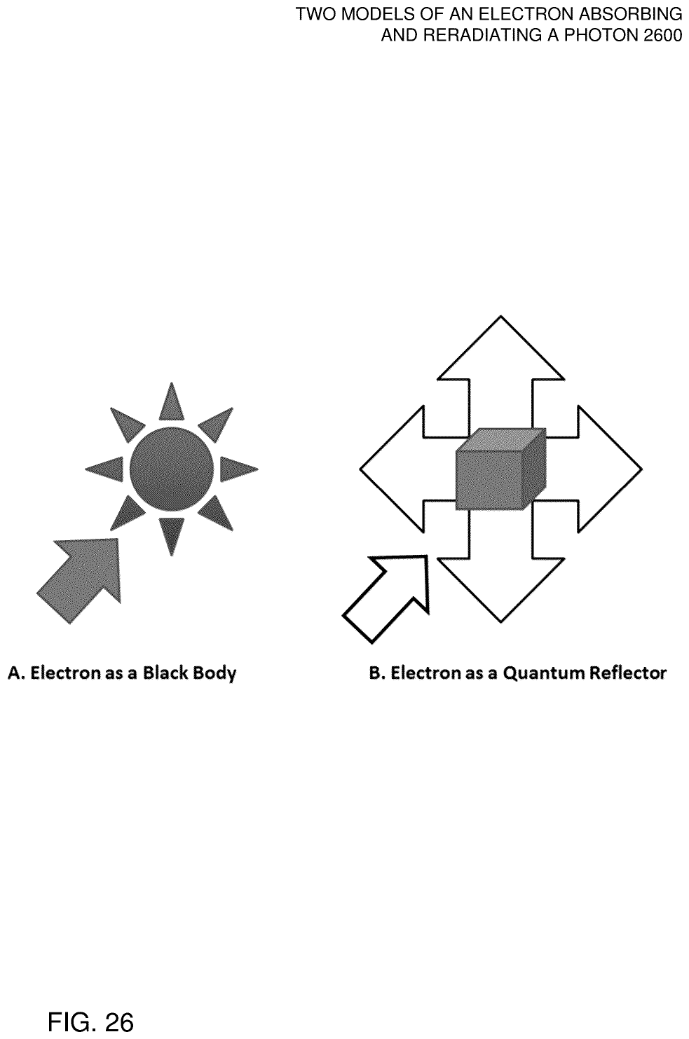

FIG. 26 is a diagram 2600 of two models of an electron absorbing and reradiating a photon, according to an implementation. In side A of FIG. 26, the electron acts as a Black Body and in side B of FIG. 26, the electron acts as a Quantum Reflector.

The perfect absorber must have a Planckian distribution of photons inside, and since for a Planckian photon gas P∝n^{4/3}, an effective number density can be written:

$$n = {{λ}^{- 3} ( \frac{2 {π}^{5}}{15} )}^{3 / 4} \qquad ( 7.25 )$$

The box of the same volume absorbing a single must have a single photon, must then fill each direction with photons going each way, and with both polarizations so that there is a photon density in any direction:

For one Photon:

$$n = {λ}^{- 3} / 32 \qquad ( 7.26 )$$

The uniform radiator sends and receives a photon and then sends it out over 4π radians whereas the cube can receive it over 3 faces but only send it out over 5 faces, since it cannot merely reflect it, so this gives us combinatorial ratio of 3/5 for a direction probability. Alternatively, this ratio can be interpreted as the ratio of 3 degrees of freedom of ordinary space, to the 5 degrees of freedom of the five dimensional spacetime-manifold. So, the ratio of probability of photons being radiated from the electron as a perfect black body, with its requirement of Planckian statistics, to the probability of quantum reflector of identical volume, is the ratio of the effective proton densities and surface areas:

$${α}^{- 1} = \frac{1}{4 π} {( \frac{2 {π}^{5}}{15} )}^{3 / 4} ( 64 [ \frac{5}{3} ] ) = 137 \text{.036} \qquad ( 7.27 )$$

$${α}^{- 1} = \frac{10}{3 π} {( \frac{32 {π}^{5}}{15} )}^{3 / 4} = 137.036 \qquad ( 7.28 )$$

This formula was originally found by Wyler, who found it from ratios of volumes in higher dimensional spaces.

### Section 7. Discussion: Entropy in the Subatomic Realm

Therefore, the unification of gravity and electromagnetism is compatible with the Standard Model, but only if the Hawking linkage of gravity to entropy is accepted. In this scenario, the Planckian distribution, the result of joining electro-magnetism theory to entropy—and the origin of quantum mechanics—is present at subatomic scales and determines the physics there. This entropy, or spreading over possible states, operates in a 5 dimensional manifold. The consequence of this is the baryons, and leptons, most particularly their lowest lying endmembers, can be understood as geometric objects, with the electron as a one-dimensional in color-charge and the proton as three-dimensional in color-charge, the latter fact leading to a rich range of subatomic phenomenon in the Standard Model.

Finally it is found that the integrals for particle self-energies, so helpful for renormalizability in the Standard Model, must include the Planck cutoff, and based on the experimental observed variation of the fine structure constant, lead back to formulas for G similar to that derived from the unification of gravity and electromagnetism. This all shows, as has been seen before, that gravitational physics, while not included formally, under-girds the Standard Model and is key to its success. Accordingly, the unification of gravity and electromagnetism is an attempt to make the Standard Model more formally complete, even as experiment and theory continue to expand its description of the Cosmos.

### SUMMARY

### Section 1. The Higgs Boson and Unified Gravity-and-Electromagnetism

The unification of gravity and electromagnetism is a “Bohr Model” of gravity-EM unification: it provides basic physical models and can explain certain observations. However, it is freely admitted to be a rudimentary theory at this point. Therefore, us summarize the theory and address, in a following section, the most serious problem blocking the incorporation of GR into the Standard Model: that of barriers to quantization of GR, in the context of unified gravity-and-electromagnetism. But first let us summarize some results.

The unification of gravity and electromagnetism can be based on two postulates:

Gravity Fields can be made equivalent to an array of E×B drifts. This requires the phenomenon of “self-censorship” of quantum ZPF and a form of the metric tensor that is a normalized portion of the Maxwell Stress tensor.

$${g}_{α β} = \frac{4 {F}_{α}^{γ} {F}_{γβ}}{{F}_{μ γ} {F}^{μ γ}} \qquad ( 8.1 a )$$

$$ϕ = \frac{1}{2} \frac{{E}_{x}^{2}}{{B}_{o}^{2}} {c}^{2} \qquad ( 8.1 b )$$

Gravity and electro-magnetism forces appear separately from the Planck Scale in a way correlated with appearance of the electron-proton pair. This requires a “hidden 5^{th} dimension” scale size rₒ to serve as a long wavelength cutoff relative to the Planck length and yields a mass model explaining both the value of G and the mass of the proton:

$${m}_{P} = {M}_{P} exp ( - ( {α}^{- 1 / 2} + α ) ln σ ) = 1.6 \; 726 \times {10}^{- 27} kg \qquad ( 8.2 )$$

$$G = ( {e}^{2} / {m}_{P} {m}_{e} ) α exp ( - 2 ( σ - 1 / {σ}^{2} ) ) = 6.6 \; 72 \times {10}^{- 8} dyne - {cm}^{2} - {g}^{- 2} \qquad ( 8.3 )$$

It is found that this leads to a combination of Kaluza-Klein and Sakharov models for both the vacuum, the appearance of hydrogen in the Big Bang, and the coexistence of both electro-magnetism and General Relativity with an effective short wavelength limit at the hidden dimension size serving as a cutoff for directly detectable ZPF electro-magnetism phenomenon. ZPF electro-magnetism waves shorter in wavelength than this cutoff become part of the metric. This incorporation of the short wavelength ZPF in the metric means its mass-energy density does not appear.

Unexpectedly, the hidden dimension structures associated with the proton and the electron, their classical radii, in the presence of the Vacuum ZPF, must act as conducting spheres supporting quantum Mie Scattering, and the Mieons thus formed correspond in mass, with high accuracy, to the π mesons carrying the Strong Force and the W and Z boson carrying the Weak Force. The most general excitation of the hidden 5^{th} dimension itself produces the Higgs Boson at a predicted mass of 128 GeV. A new particle of low mass and no charge, the M* particle at mass of 22 MeV, is predicted to exist, though with low probability.

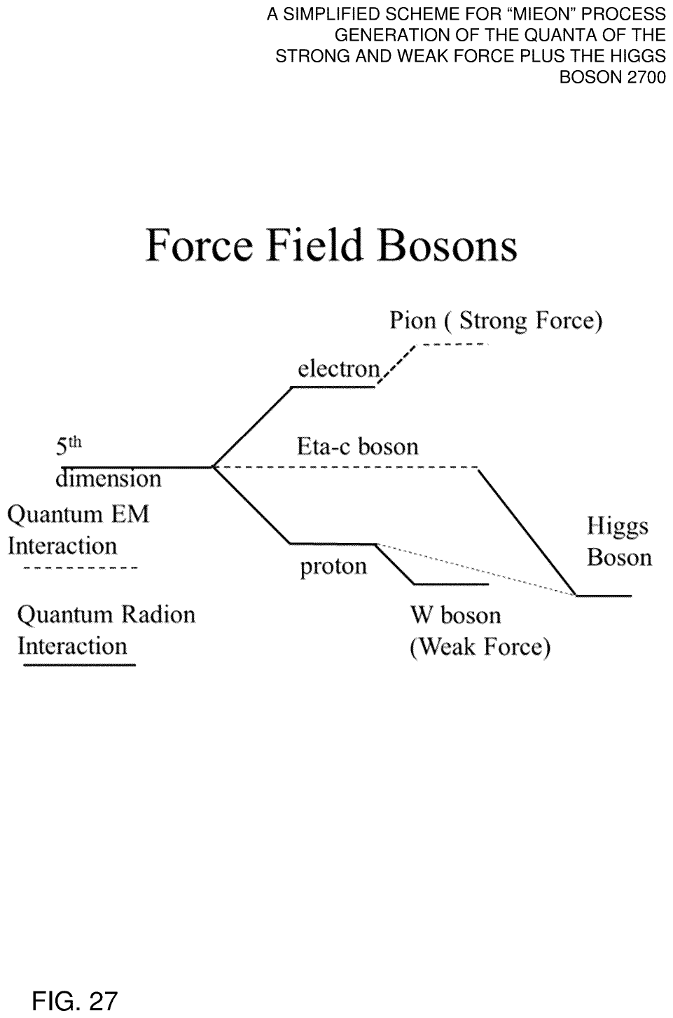

FIG. 27 is a diagram 2700 of a simplified scheme for “Mieon” process generation of the quanta of the Strong and Weak Force plus the Higgs Boson. Under the conjecture of Alfred Luhen, the Higgs Boson cannot exist and generate mass outside the context of General Relativity. Accordingly, the simplest way for this to occur in the context of unified of gravity and electromagnetism is that the Higgs scalar field occurs in Kaluza-Klein theory as the Radion scalar field so that both gravity, electro-magnetism-mass energy as gravity source term, and particles are born together with the Radion field. The Higgs Boson is the creator of mass in the unification of gravity and electromagnetism because of the relationship m_{Higgs}≅mₚ/α so that the Compton radius of the Higgs Boson is the electro-magnetism interaction length of the proton:

$${Higgs}_{} = \frac{{e}^{2}}{{m}_{P} {c}^{2}} \qquad ( 8.4 )$$

Thus, the known source of mass in the universe, the proton, is in electro-magnetism resonance with the Higgs Boson, that is, the proton electro-magnetism self-interaction time is the Compton oscillation time of the Higgs. Therefore, the Higgs Boson is a key part of the mechanism for production of hydrogen in the Cosmos at the Big Bang. This resonance also ensures that the vacuum will unstable to the periodic production, not of “balls of nothingness”, but of hydrogen-electron pairs, with attendant electro-magnetism radiation detected as part of the CBR. Thus the unification of gravity and electromagnetism connects the Planck length to the Hubble Radius, via the 5^{th} dimension size rₒ, this is done through though the mass-scale parameter σ=(mₚ/mₑ)^{1/2}.

The value of the mass-scale parameter σ by a transcendental equation can be derived because σ determines both geometry and mass scaling of the mesoscale or subatomic scale relative to the Planck Scale:

Thus an equation for σ, in terms of α, by using the relationships described, follows:

$$ln ( {r}_{o} / {r}_{P} ) = σ - \frac{1}{{σ}^{2}} \qquad ( 8.5 )$$

$$ln ( {m}_{o} / {m}_{P} ) = - ln σ ( {α}^{- 1 / 2} + α + 1 ) \qquad ( 8.6 )$$

$$ln ( {m}_{o} / {m}_{P} ) = - ln ( {r}_{o} / {r}_{P} ) + ln α \qquad ( 8.7 )$$

Combining these equations, the TCE (“Transcendental Cosmic Equation”) for the number σ, and the relationship between σ and α can be obtained by finding roots of the equation:

$$σ - \frac{1}{{σ}^{2}} - ln σ ( {α}^{- 1 / 2} + α + 1 ) - ln α = 0 \qquad ( 8.8 )$$

As the Planck scale is approached where both α and σ→1 that both sides of Eq. 8.8 disappear to leading order. The values used in solving the TCE are shown in Table 3.

TABLE 3
Values used for the calculation of σ from the TCE.

| | | | TCE | Error |
|---|---|---|---|---|
| mass (gram) | Length (cm) | Ratios (observed) | value | (ppth) |
| mₚ(Planck mass) = 2.1651e−5 | rₚ(Planck length) = 1.6162e−33 | α⁻¹ = 137.03599917 | 137.036 | — |
| mₒ(M* mass) = 3.90341e−26 | rₒ(mesoscale radius) = 6.57624e−15 | σ = 42.85035 | 42.85572 | 0.12 |
| Ln(mₚ/mₒ) = 47.770 | Ln(rₒ/rₚ) = 42.84992 | −Ln(α) = 4.92024 | 4.92024 | — |

The TCE can be integrated and thus a potential function in σ:

$$\frac{{σ}^{2}}{2} + \frac{1}{σ} - σ ( ln σ - 1 ) ( {α}^{- 1 / 2} + α + 1 ) - σ ln α + C \qquad ( 8.9 )$$

where C is a constant. This can considered to be a “Sombero” potential for particles in the vacuum where σ=1 could be considered the Planck Vacuum state and σ=42.8503 is the present vacuum state with a Higgs Boson mass of 128 GeV, as in FIG. 27.

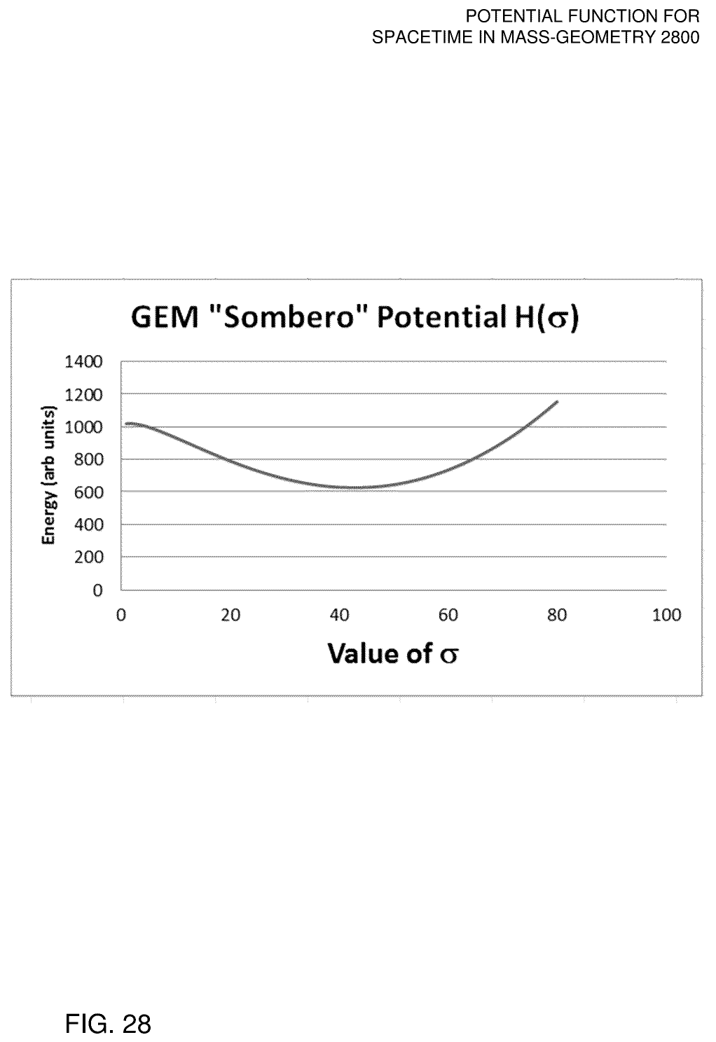

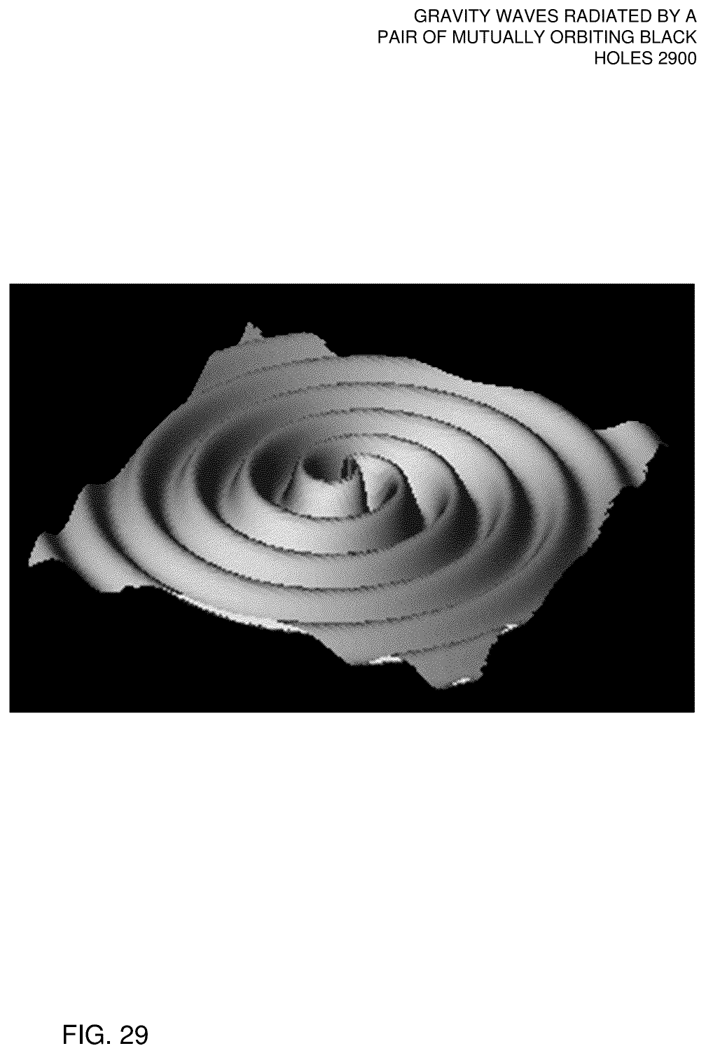

FIG. 28 is a diagram 2800 of a potential function for spacetime in mass-geometry parameter σ. In FIG. 28, spacetime has a minimum energy for σ≅42.8503.

The proton-electron pair are seen in the unification of gravity and electromagnetism space-like and time-like objects respectively, viewed in the context of unified of gravity and electromagnetism of electric charge being a distance in the 5^{th} dimension. The three-charge-dimensional character of the proton is then constrained both by charge and charge-squared to match the electron. This shows that the observed stability of the proton is due to topological constraints on its decay in charge-space.

$${q}_{e} = {q}_{x} + {q}_{y} + {q}_{z} \qquad ( 8.1 )$$

$${q}_{e}^{2} = {q}_{x}^{2} + {q}_{y}^{2} + {q}_{z}^{2} \qquad ( 8.11 )$$

Finally, the proton-electron mass ratio can be calculated based on the quark-gluon fields in the proton being in a state of maximum entropy and thus Planckian. Independent of the TCE thus:

$$σ = {( 6 {π}^{5} )}^{1 / 2} \qquad ( 8.12 )$$

This connects the primary mass generating particle in the universe, and thus the primary source of gravity, with entropy. This is consistent with the production of entropy by gravity, in the viewpoint of Bekenstein-Hawking. Hawking discovered an expression for the entropy of a Black Hole S_{BH}, with radius: Rₛ=2GM/c²

$${S}_{BH} = \frac{kA}{4 {r}_{P}^{2}} \qquad ( 8.13 )$$

$${S}_{BH} = \frac{k π {R}_{S}^{2}}{{r}_{P}^{2}} \qquad ( 8.14 )$$

As another strange result, it is found that, within unified gravity-and-electromagnetism, nature is so impatient to create entropy that it creates it and matter from the vacuum itself, through the process of vacuum decay, whereby the vacuum is still producing proton-electron pairs in a steady state “continual inflation” process long after the Big Bang created the basic structure of the universe. Assuming this process maintains an Ω≅1 Cosmos, the Hubble Time can be understood as equal to a Dirac relation, with attendant electro-magnetism radiation emission corresponding closely to the Cosmic Background radiation.

The hidden dimension structure of spacetime is found to allow separate but coupled electro-magnetism and gravity fields, and create hydrogen, but also to create the exchange bosons for the subatomic Strong and Weak Forces. Finally, again, as a most general quantum excitation of the 5^{th} dimension, the unification of gravity and electromagnetism requires the Higgs Boson, revealing it to be part of an elaborate mechanism in the vacuum spacetime to make a hydrogen filled universe in the Big Bang and in quantum resonance with the proton, which is the known source of mass in the universe. Again, unified gravity-and-electromagnetism further predicts the existence of an elusive M*, uncharged particle, associated with the hidden dimension at mass 22 MeV.

$${T}_{H} = {( {\frac{9}{8 π} [ \frac{1}{α σ} ]}^{4} \frac{1}{α} )}^{1 / 3} ( \frac{{e}^{2}}{{Gm}_{P} {m}_{e}} ) \frac{{r}_{e}}{c} \tilde{=} 1.2 \times {10}^{10} yrs \qquad ( 5.17 )$$

### Section 2. Unified Gravity-and-Electromagnetism, the KB (Kursunoglu-Brandenburg) Hypothesis of GRBs (Gamma Ray Bursters), and the Problem of Quantization of Gravity

The goal of the unification of gravity and electromagnetism is to fully incorporate GR into the Standard Model, however, this would appear to require a quantized theory of gravity. unified gravity-and-electromagnetism points the way to quantizing gravity, by combining it with the already quantized theory of electro-magnetism through QED. Unfortunately, discussion of this effort is beyond the scope of this text. However, in the context of unified gravity and electromagnetism, it is easily apparent that one barrier to gravity quantization can be eliminated. This is the problem of formation of Black Holes and associated infinities in quantized gravity. Gravitons, the quanta of gravity, possess mass, creating a high frequency instability creating an effective cascade to high wavenumber k, and the formation of micro-black-holes, in conventional attempts at quantization of GR. This resembles the transition of a high Reynolds Number laminar flow to a turbulent cascade of micro-vortices in a moving fluid. This feature of GR quantization is unphysical, since all of spacetime would become singular if it was true. Thus, some strong physical effect must prevent this. This should happen naturally in the unification of gravity and electromagnetism since gravity fields are due to a micro-structure of electric and magnetic fields making up spacetime-even as fluid flows are made up of molecules containing strong E and B fields. By analogy, strong enough turbulence or pressure variations in real fluids cause ionization to occur, turning the fluid into a dense, radiating plasma. Accordingly, in the unification of gravity and electromagnetism, this “spacetime ionization” should occur by an extension of the same effect as Hawking Evaporation, whereby increased power is radiated as the blackholes become smaller. (see Eq. 8.15). This can be translated to increased rate of evaporation with high k (see Eq. 8.16)

$$P = \frac{ℏ {c}^{6}}{15360 {π ( GM )}^{2}} = \frac{ℏ {c}^{2}}{3840 π {R}_{S}^{2}} \qquad ( 8.15 )$$

$$P \approx \frac{{ℏ ( kc )}^{2}}{4000} \qquad ( 8.16 )$$

Thus, an extension of Hawking Evaporation can be invoked to a ‘unified gravity-and-electromagnetism-Hawking micro-black-hole suppression effect’ whereby micro-black holes evaporate into the ZPF faster than the micro-black holes can form, which creates a ‘unified gravity-and-electromagnetism-viscosity’ in spacetime, because of the electrodynamic nature of spacetime in the context of unified gravity and electromagnetism and the existence of a hidden 5^{th} dimension, rₒ, analogous to a molecular mean free path in fluids. It is a prediction of the unification of gravity and electromagnetism that a similar effect to micro-black-hole suppression via spacetime ionization occurs in strong GRBs, caused when two blackholes or neutron stars collide and merge to form a larger black-hole. This is the KB (Kursunoglu-Brandenburg) Hypothesis.

Large GRB events are ‘EM-gravity unification events’ where nature converts large amounts of high frequency gravity waves, in the paired supernova remnant in-spiral process, directly into electro-magnetic energy and a matter-antimatter plasma. The events leading up to a GRB are among the most strange and powerful in the universe.

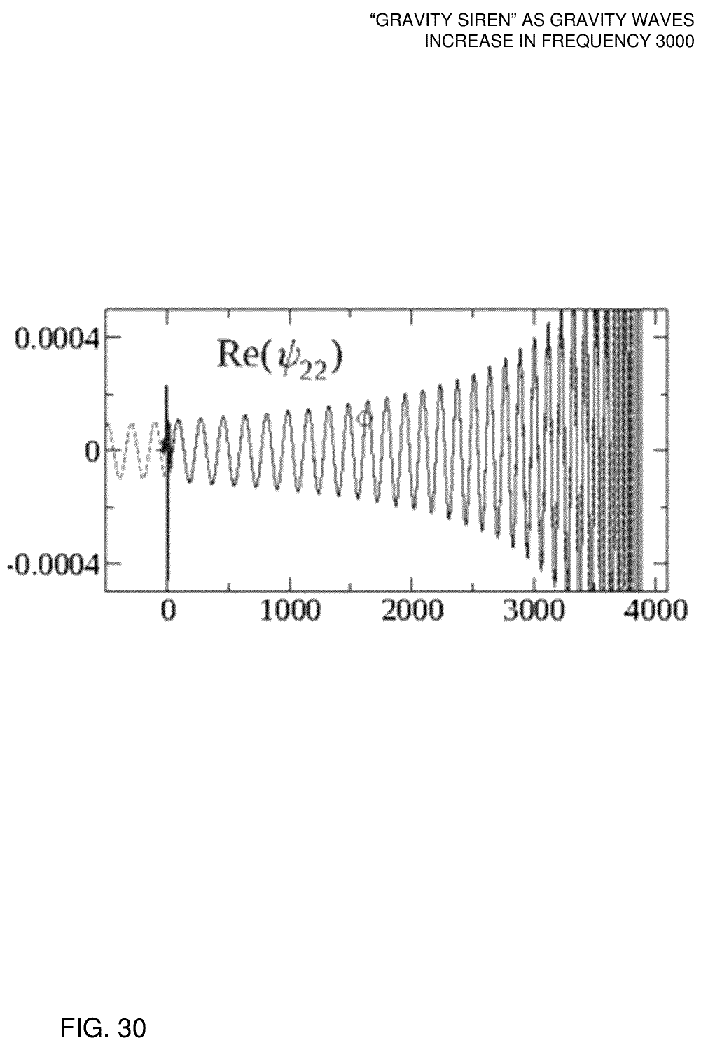

FIG. 30 is a diagram 3000 of gravity waves radiated by a pair of mutually orbiting Black Holes.

The KB Hypothesis can be conceptually modeled as beginning with a system of two supernova remnants, of approximately a Solar Mass each, orbiting each other at a separation distance 2R. Assuming that most of space around the pair of remnants is swept clean of matter, so the space around the pair of remnants is a very pure vacuum. The pair of remnants create gravity waves of dominant frequency Op being the frequency of the orbital period of the gravity wave, as in FIG. 29 (Eq. 8.17) As the waves drain energy from the system, the distance between the masses shrinks, increasing the speed of the masses and the frequency ωₚ of the masses, the in-spiral leading to increasing orbital frequency of the waves emitted. The increasing orbital frequency of the emitted waves leads to a signature gravity wave ‘siren’ with frequency rising in time, as in FIG. 30.

$${ω}_{p}^{2} = \frac{GM}{4 {R}^{3}} \qquad ( 8.17 )$$

As the system shrinks further the system must become relativistic, with rising γ, leading to synchrotron gravity wave formation, in turn leading to even more intense gravity wave power radiation (see Eq. 8.18). This creates a cloud of high frequency, strong gravity turbulence in the radiating system near-field. Drawing on the concept of spacetime as a fluid, a turbulent transition in highly stressed spacetime can be imagined as the turbulent transition occurs in everyday fluids such transitions are seen to occur in simulations of rapidly spinning Black Holes.

$${P}_{S} \tilde{=} \frac{{γ}^{4} G {ω}^{2} {M}^{2}}{c} \qquad ( 8.18 )$$

FIG. 30 is a diagram 3000 of the “gravity siren” as gravity waves emitted by mutually orbiting pair of black-holes increases in frequency as the system loses energy and “in-spirals”.

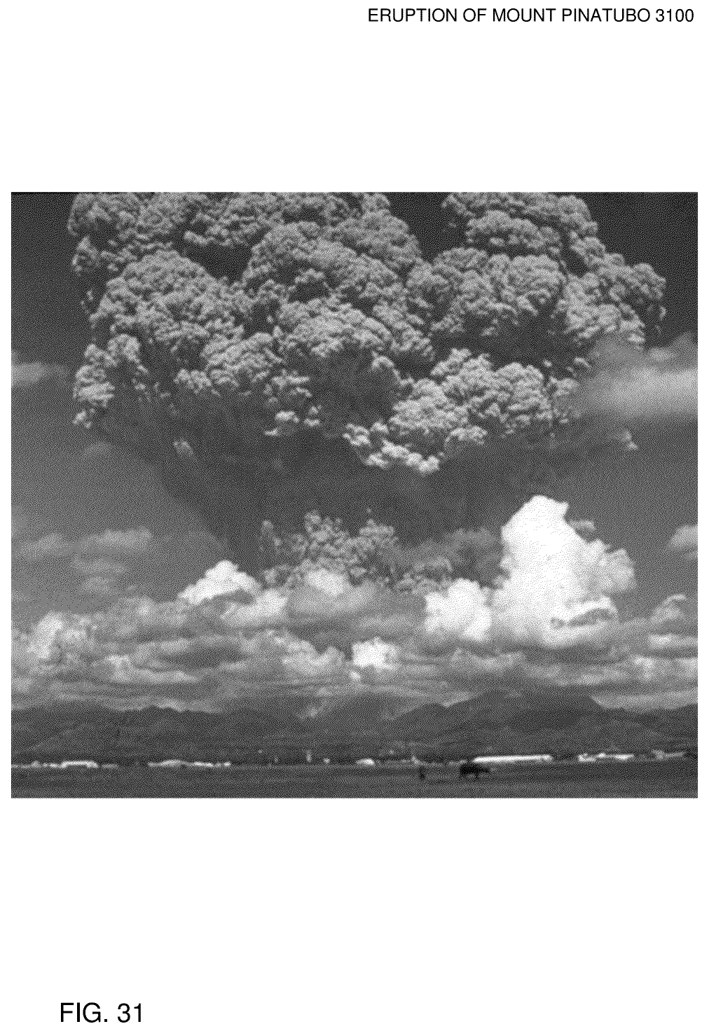

FIG. 31 is a diagram 3100 of an eruption of mount Pinatubo showing the result of an efficient turbulent cascade, turning a rising flow into a chaotic, turbulent flow. In everyday fluids, a transition from laminar velocity fields to turbulent cascade of vortices to smaller wavelengths occurs when the ratio of inertial forces to viscous forces, the Reynolds number, exceeds a critical value of several thousands. Interpreted differently, the Reynolds number can be considered a ratio between macroscopic action density in a system and its action density at molecular scales. Adopting a view that nature seeks to minimize action in all systems, a high Reynolds number system can be considered “top heavy” in its distribution of action, with the turbulent cascade being nature's way of distributing action across all scales of the system to minimize it. This process in nature can be very efficient in diffusing energy from long to short energy scales, as in FIG. 31.

Following this model in the context of unified gravity and electromagnetism a “unified gravity and electromagnetism Reynolds Number” for the system of binary black-holes as a ratio of action densities in the binary black-hole system and the quantum action density at the scale of rₒ, can be expressed as the hidden dimension size. For two approximately solar mass black-holes, M_{S}, separated by 1 A.U. from each other the value of the Re_{unified gravity and electromagnetism} is of order 1:

$${Re}_{GEM} \tilde{=} \frac{{M}_{S} {V}_{orbit} {r}_{o}^{3}}{{R}_{orbit}^{2} ℏ} \approx 1 \qquad ( 8.19 )$$

However for the same two blackholes whose event horizon's are in contact and the two blackholes whose event horizon's are in contact are moving at nearly the speed of light, the value of Re_{unified gravity and electromagnetism} is astronomical:

$${Re}_{GEM} \tilde{=} \frac{{GM}_{S}^{2} {r}_{o}^{3}}{{cR}_{S}^{3} ℏ} \approx {10}^{27} \qquad ( 8.2 )$$

This large ratio of macroscopic to quantum level action, indicates the conditions for a turbulent cascade of intense gravity wave energy into micro-blackholes, in the context of unified gravity and electromagnetism, is likely before black-hole merger occurs.

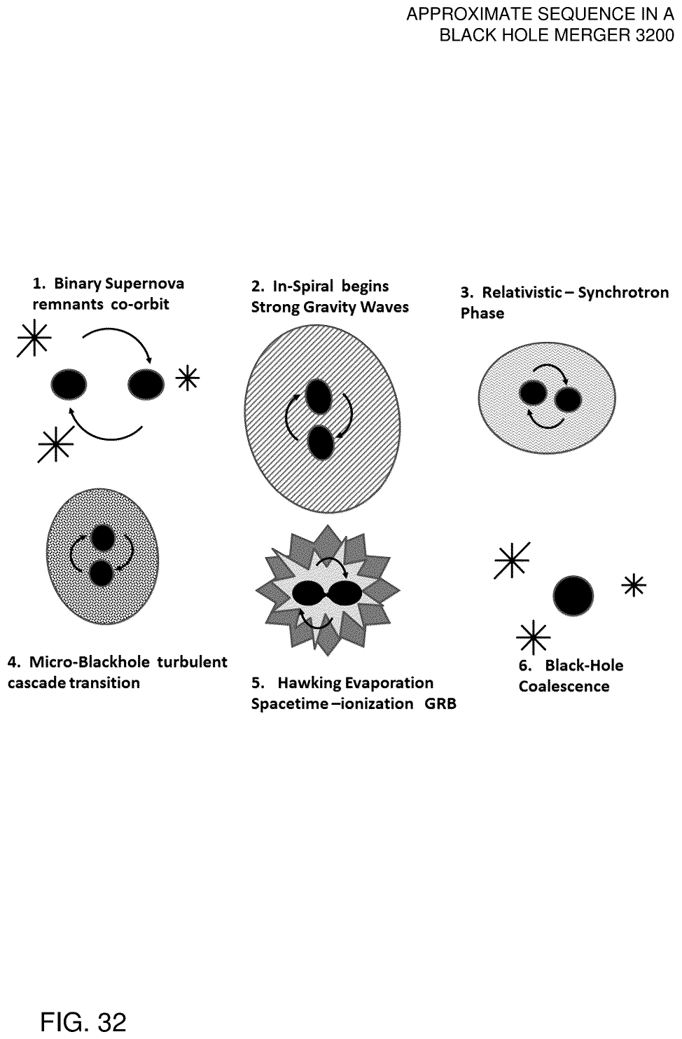

FIG. 32 is diagram 3200 of the approximate sequence in a Black Hole merger. In FIG. 32, the merger leads to coincident Gravity Wave and Gamma Ray bursts.

Under the KB hypothesis, this potential for instability leads to chaotic, turbulent cascade to high k gravity waves, turning strong, high frequency gravity waves into a cloud of micro-blackholes, as in FIG. 32. These blackholes then undergo Hawking Evaporation ‘en mass’ leading to the observation of a GRB.

It can be predicted by the unification of gravity and electromagnetism that this process will create not only a matter-antimatter plasma, but also, like the Big Bang, a large amount of hydrogen. The signature of this KB process should be strong peaks in gamma ray emission (allowing for some gravity red-shift) at the 0.511 MeV (electron) and 938 MeV (proton) matter-antimatter annihilation lines, but also, for a period, in the center of the GRB, a strong Lyman Alpha line, the signature of hot hydrogen. However, these effects should occur during the final stages of the ‘in-spiral’ of two neutron stars or Black holes before the two neutron stars or the Black holes coalesce, and the space around the resulting large black-hole is swept clean. In other words, the KB Hypothesis proposes that in order to dissipate a lot of energy and create a lot on entropy from empty space, nature creates a matter-antimatter plasma from the bare vacuum. Literally, nature “tears matter right out of spacetime” in scenarios of sufficiently intense gravity turbulence. Some hydrogen should be created also. By analogy, spacetime will “ionize” and become a matter-antimatter plasma when subjected to sufficiently intense high gravity wavenumbers just as a Blackhole Event Horizon must be covered with a “sheen” of matter and antimatter.

Energetically, it is well known that the merging of two black holes of mass M results in approximately M/20 of the resulting black-hole mass being lost to gravitational radiation Since the scenario requires approximately Chandrasekar masses of ˜1.2 M_{Solar} the observation of most GRBs radiating approximately 0.1-0.001 M_{Solar} rest energy, depending on beaming, is in reasonable agreement, assuming the unified gravity and electromagnetism-GR-Hawking process of converting high k gravity waves to a matter-antimatter plasma is reasonably efficient, as are most turbulent cascades produced by high energy events in nature.

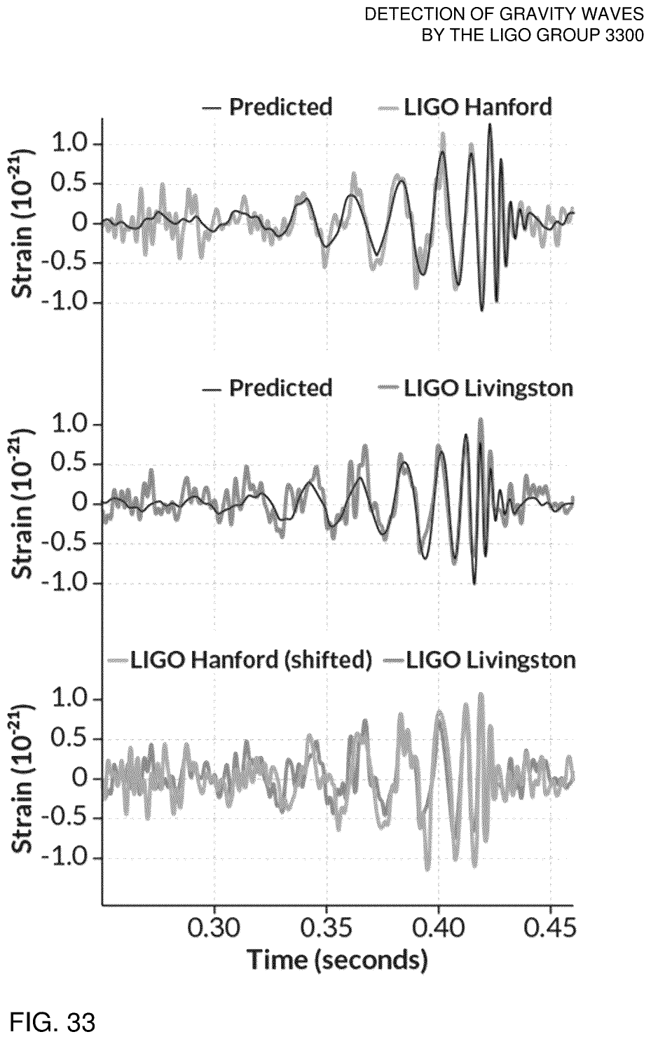

FIG. 33 is a diagram 3300 of the detection of Gravity Waves by the LIGO group.

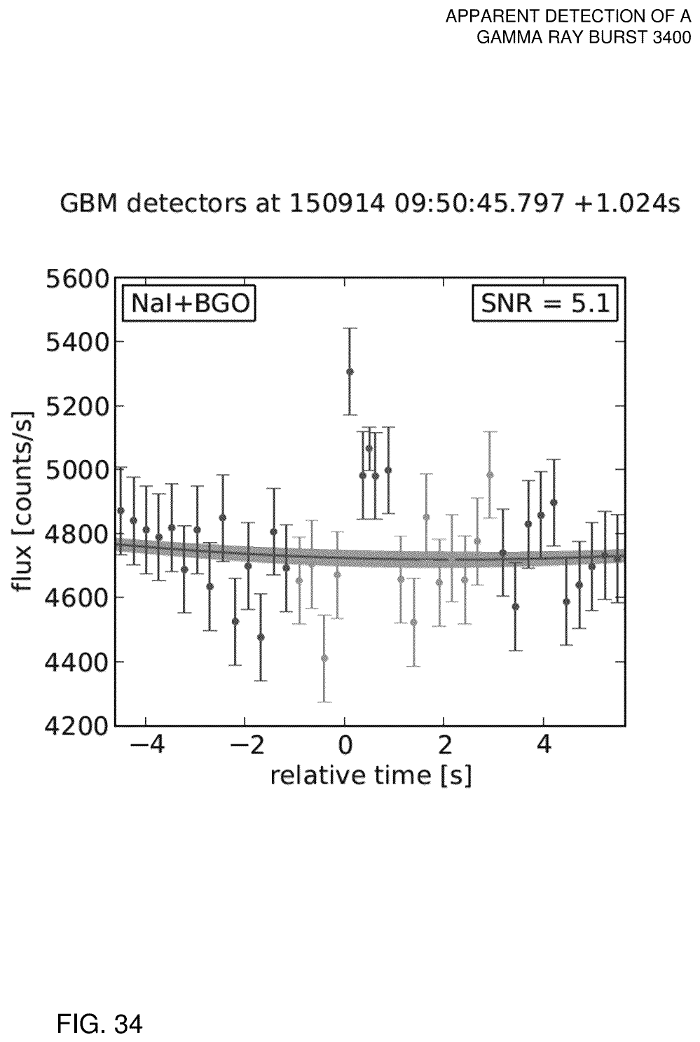

FIG. 34 is a diagram 3400 of the apparent detection of a Gamma Ray burst by the FERMI observatory coincident in time with the detection Gravity Waves by the LIGO group.

The recent observation of gravity waves from a Black hole merger appears to support the KB hypothesis, as in FIG. 33. The event, in this case two large Black holes of 26 and 36 Solar masses, whose action would have been expected to have swept the surrounding space clean of matter, also appears to have created a weak GRB, as in FIG. 34, which is a a strong confirmation of the KB hypothesis, since the merger of two Black holes of such large mass would be expected to occur in bare vacuum and only through the unification of gravity and electromagnetism can one create electro-magnetism radiation from the vacuum.

However, other workers do not corroborate this GRB detection so the matter remains experimentally unresolved until more data is gathered.
A=area (m²)
A=acceleration (m/s²)
Aᵥ=electro-magnetism four potential, (Volts)
ae=electronic charge (Coulombs),
E=electric field (Volts/m),
B=Magnetic field (Webbers/m²),
c=speed of light (m/s),
G=Newton gravitation constant (kg⁻²-m³-s²),
√-g=square root of the determinate of the metric
tensor (pure number),
g_{v,u}=metric tensor (pure number),
g.=Newtonian gravity acceleration (m-s⁻²),
h=Planck's constant (kg-m²-s⁻¹),
ℏ=Planck's constant divided by 2π(kg-m²-s⁻¹),
L=Lagrangian (kg-m²-s⁻¹)
L′=Lagrangian (kg-m²-s⁻¹)
K=energy density (Joules/m³)
u=energy density (Joules/m³)
mₚ=proton mass (kg),
mₑ=electron mass (kg),
M_{ηc}=mass of the η_{cc} charmed meson
S=Poynting flux (Watts-m⁻²).
R=Curvature scalar (m⁻²),
Rₘ=Proton to electron mass ratio (pure number)
r_{c}=classical particle radius (m)
rₒ=mesoscale radius
V_{D}=drift velocity (m/s)
v=velocity (m/s)
W_{P}=Planck energy (Joule)
W*=3.0 GeV
wₚ=probe energy of experiment (Joule).
α=fine structure constant (pure number),
α_{S}=strong force fine structure constant (pure number),
φ=wave field potential (m^{-3/2})
γ_{ab}=five dimension metric tensor,
Λ=Cosmological constant, (m⁻²)
ρₘ=mass density (kg/m³)
ξ=γ₅₅
εₒ=permittivity of space (m⁻¹-coulomb²/Joule)

$${g}^{αβ} = [ \begin{matrix}1 & 0 & 0 & 0 \\ 0 & - 1 & 0 & 0 \\ 0 & 0 & - 1 & 0 \\ 0 & 0 & 0 & - 1\end{matrix} ] \qquad ( 4.2 )$$

$${g}^{αβ} = {2 [ {E}^{2} - {B}^{2} ]}^{- 1} ( \begin{matrix}{E}^{2} & 0 & 0 & 0 \\ 0 & - {E}_{x}^{2} + {B}_{y}^{2} + {B}_{z}^{2} & 0 & 0 \\ 0 & 0 & - {E}_{y}^{2} + {B}_{x}^{2} + {B}_{z}^{2} & 0 \\ 0 & 0 & 0 & - {E}_{z}^{2} + {B}_{y}^{2} + {B}_{x}^{2}\end{matrix} )$$

### Method Implementations

In the previous section, apparatus of the operation of an implementation was described. In this section, the particular methods performed by apparatus 100 of such an implementation are described by reference to a series of flowcharts.

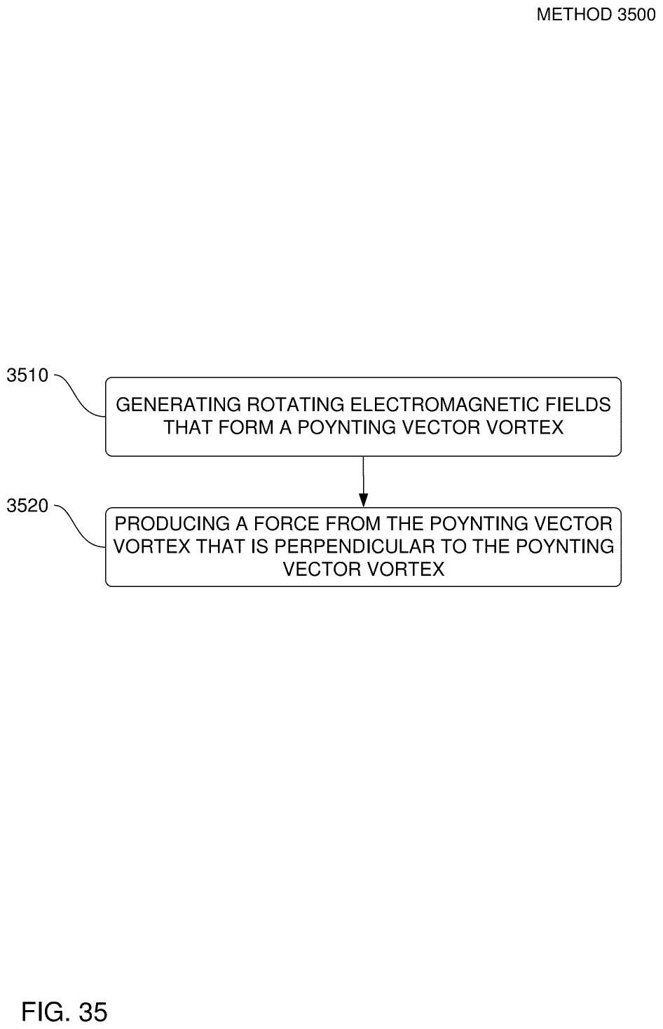

FIG. 35 is a flowchart of an experimental method 3500 to control a propulsion apparatus, according to an implementation.

Method 3500 that can control a propulsion apparatus includes energizing electrically at least three electrically conducting coils from one or more power sources, at block 3510 and generating rotating electromagnetic fields that form a Poynting vector vortex, the Poynting vector vortex producing a force that is perpendicular to the Poynting vector vortex, at block 3520. In some implementations, the force is a gravity. In some implementations, the generating 3520 is performed by three or more electrically conducting coils attached to an interior of the electrically conducting dome, such as shown in FIG. 1

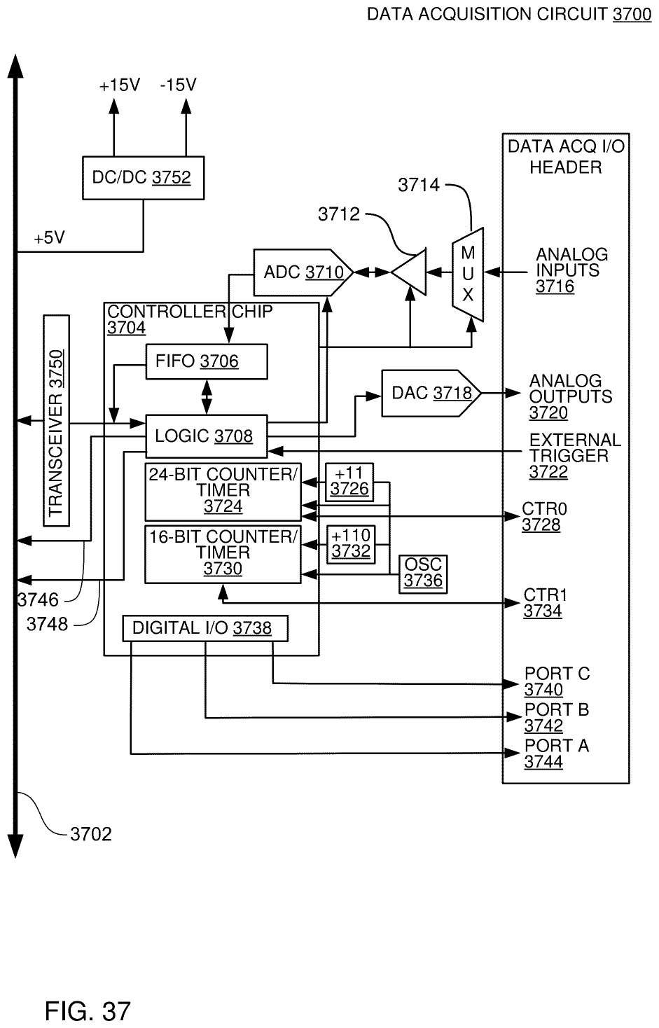

In some implementations, method 3500 represents a sequence of instructions which, when executed by a processor, such as processor 3602 in FIG. 36, controller chip 3704 in FIG. 37 or processing unit 3804 in FIG. 38, cause the processor to perform the respective method. In other implementations, method 3500 is implemented as a computer-accessible medium having executable instructions capable of directing a processor, processor 3602 in FIG. 36, controller chip 3704 in FIG. 37 or processing unit 3804 in FIG. 38, to perform the respective method. In varying implementations, the medium is a magnetic medium, an electronic medium, or an optical medium.

### Hardware and Operating Environments

FIG. 36 is a block diagram of an experimental propulsion control computer 3600 in which different implementations can be practiced. The propulsion control computer 3600 includes a processor 3602 (such as a Pentium III processor from Intel Corp. in this example) which includes dynamic and static ram and non-volatile program read-only-memory (not shown), a first bridge 3604, operating memory 3606 (SDRAM in this example). The first bridge 3604 includes integrated video 3608 that couples the propulsion control computer 3600 to a XVGA communication path 3612and a LCD and/or LCDVS device 3612.

The first bridge 3604 is operably coupled to a bus 3614 and the bus 3614 is operably coupled to a second bridge 3616 and an Ethernet® controller 3618.

The second bridge 3616 is operably coupled to a CODEC 3620 and the CODEC 3620 is coupled to an audio port 3622. The second bridge 3616 is operably coupled to communication ports 3624 (e.g., UDMA IDE 3626, USB port(s) 3628, RS-232 3630 COM1/2 and/or keyboard interface 3632).

An RS-232 port 3634 is coupled through a universal asynchronous receiver/transmitter (UART) 3636 to the second bridge 3616.

The second bridge 3616 is operably coupled to a data acquisition circuit 3638 with analog inputs 3640 and outputs 3642 and digital inputs and outputs 3644.

In some implementations of the propulsion control computer 3600, the data acquisition circuit 3638 is also coupled to counter timer ports 3646 and watchdog timer ports 3648. In some implementations of the propulsion control computer 3600, the second bridge 3616 is operably coupled to an expansion bus 3650.

In some implementations, the Ethernet® controller 3618 is operably coupled to magnetics 3652 which is operably coupled to an Ethernet® local area network 3654.

With proper digital amplifiers and analog signal conditioners, the propulsion control computer 3600 can be programmed to control the experimental propulsion apparatus 100, either in a predetermined sequence, or interactively modify in response. Rotating electromagnetic (EM) fields, such as rotating EM fields 160, can be monitored by sensors, the output of which, after passing through appropriate signal conditioners, can be read by the analog to digital converters that are part of the data acquisition circuit 3638. Thus, the strength, stability, density, torque, eddy currents, sine wave, phase(s), direction and other characteristics of the rotating EM fields can be made available as information that an application program can operate on in as part of its decision-making software that acts to control the rotating EM fields in order to control the gravity force 180.

FIG. 37 is a block diagram of an experimental data acquisition circuit 3700 of an experimental propulsion control computer, according to an implementation. The data acquisition circuit 3700 is one example of the data acquisition circuit 1112 in FIG. 11 above. Some implementations of the data acquisition circuit 3700 provide 16-bit A/D performance with input voltage capability up to +/−10V, and programmable input ranges.

The data acquisition circuit 3700 can include a bus 3702, such as a conventional PC/104 bus. The data acquisition circuit 3700 can be operably coupled to a controller chip 3704. Some implementations of the controller chip 3704 include an analog/digital first-in/first-out (FIFO) buffer 3706 that is operably coupled to controller logic 3708. In some implementations of the data acquisition circuit 3700, the FIFO 3706 receives signal data from and analog/digital converter (ADC) 3710, which exchanges signal data with a programmable gain amplifier 3712, which receives data from a multiplexer 3714, which receives signal data from analog inputs 3716.

In some implementations of the data acquisition circuit 3700, the controller logic 3708 sends signal data to the ADC 3710 and a digital/analog converter (DAC) 3718. The DAC 3718 sends signal data to analog outputs. The analog outputs, after proper amplification, can be used to control the coils, and thus control the gravity force 180. In some implementations of the data acquisition circuit 3700, the controller logic 3708 receives signal data from an external trigger 3722.

In some implementations of the data acquisition circuit 3700, the controller chip 3704 includes a digital input/output (I/O) component 3738 that sends digital signal data to computer output ports.

In some implementations of the data acquisition circuit 3700, the controller logic 3708 sends signal data to the bus 3702 via a control line 3746 and an interrupt line 3748. In some implementations of the data acquisition circuit 3700, the controller logic 3708 exchanges signal data to the bus 3702 via a transceiver 3750.

Some implementations of the data acquisition circuit 3700 include 12-bit D/A channels, programmable digital I/O lines, and programmable counter/timers. Analog circuitry can be placed away from the high-speed digital logic to ensure low-noise performance for important applications. Some implementations of the data acquisition circuit 3700 are fully supported by operating systems that can include, but are not limited to, DOS™, Linux™, RTLinux™, QNX™, Windows 98/NT/2000/XP/CE™, Forth™, and VxWorks™ to simplify application development.

FIG. 38 is a block diagram of a hardware and operating environment 3800 in which different implementations can be practiced. The description of FIG. 38 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

Computer 3802 includes a processing unit 3804, commercially available from Intel, Motorola, Cyrix and others. The computer 3802 is one implementation of propulsion control computer 195 in FIG. 1 and computer 206 in FIG. 2. The computer 3802 also includes system memory 3806 that includes random-access memory (RAM) 3808 and read-only memory (ROM) 3810. The computer 3802 also includes one or more mass storage devices 3812; and a system bus 3814 that operatively couples various system components to the processing unit 3804. The memory 3808 and 3810, and mass storage devices 3812, are types of computer-accessible media. Mass storage devices 3812 are more specifically types of nonvolatile computer-accessible media and can include one or more hard disk drives, floppy disk drives, optical disk drives, and tape cartridge drives. The processing unit 3804 executes computer programs stored on the computer-accessible media.

Computer 3802 can be communicatively connected to the Internet 3816 via a communication device, such as modem 3818. Internet 3816 connectivity is well known within the art. In one implementation, the modem 3818 responds to communication drivers to connect to the Internet 3816 via what is known in the art as a “dial-up connection.” In another implementation, the communication device is an Ethernet® or network adapter 3820 connected to a local-area network (LAN) 3822 that itself is connected to the Internet 3816 via what is known in the art as a “direct connection” (e.g., T1 line, etc.).

A user enters commands and information into the computer 3802 through input devices such as a keyboard (not shown) or a pointing device (not shown). The keyboard permits entry of textual information into computer 3802, as known within the art, and implementations are not limited to any particular type of keyboard. Pointing device permits the control of the screen pointer provided by a graphical user interface (GUI) of operating systems such as versions of Microsoft Windows®. Implementations are not limited to any particular pointing device. Such pointing devices include mice, touch pads, trackballs, remote controls and point sticks. Other input devices (not shown) can include a microphone, joystick, game pad, satellite dish, scanner, or the like.

In some implementations, computer 3802 is operatively coupled to a display device 3824. Display device 3824 is connected to the system bus 3814 through a video adapter 3826. Display device 3824 permits the display of information, including computer, video and other information, for viewing by a user of the computer. Implementations are not limited to any particular display device 3824. Such display devices include cathode ray tube (CRT) displays (monitors), as well as flat panel displays such as liquid crystal displays (LCD's). In addition to a monitor, computers typically include other peripheral input/output devices such as printers (not shown). Speakers (not shown) provide audio output of signals. Speakers are also connected to the system bus 3814.

Computer 3802 can be operated using at least one operating system to provide a graphical user interface (GUI) including a user-controllable pointer. Computer 3802 can have at least one web browser application program executing within at least one operating system, to permit users of computer 3802 to access intranet or Internet world-wide-web pages as addressed by Universal Resource Locator (URL) addresses. Examples of browser application programs include Netscape Navigator® and Microsoft Internet Explorer®.

The computer 3802 can operate in a networked environment using logical connections to one or more remote computers, such as remote computer 3828. These logical connections are achieved by a communication device coupled to, or a part of, the computer 3802. Implementations are not limited to a particular type of communications device. The remote computer 3828 can be another computer, a server, a router, a network PC, a client, a peer device or other common network node. The logical connections depicted in FIG. 38 include the local-area network (LAN) 3822 and a wide-area network (WAN). Such networking environments are commonplace in offices, enterprise-wide computer networks, intranets and the Internet.

When used in a LAN-networking environment, the computer 3802 and remote computer 3828 are connected to the local network 3822 through network interfaces or adapters 3820, which is one type of modem 3818. When used in a conventional WAN-networking environment, the computer 3802 and remote computer 3828 communicate with a WAN through modems. The modems, which can be internal or external, is connected to the system bus 3814. In a networked environment, program modules depicted relative to the computer 3802, or portions thereof, can be stored in the remote computer 3828.

Computer 3802 also includes an operating system 3830 that can be stored on the system 3806 and ROM 3810, and/or mass storage device 3812, and is and executed by the processing unit 3804. Examples of operating systems include Microsoft Windows®, Apple MacOS®, Linux®, UNIX®, providing capability for supporting application programs 3832 using, for example, code modules written in the C++® computer programming language. Examples are not limited to any particular operating system, however, and the construction and use of such operating systems are well known within the art.

Instructions can be stored via the mass storage devices 3812 or system memory 3806, including one or more application programs 3832, other program modules 3834 and program data 3836.

Computer 3802 also includes power supply. Each power supply can be a battery.

Some implementations include computer instructions to measure the strength, stability, density, torque, eddy currents, sine wave, phase(s), direction and other characteristics of the rotating EM fields and control the coils, and thus control the gravity force 180 that can be implemented in instructions or the instructions stored via the mass storage devices 3812 or system memory 3806 in FIG. 38.

FIG. 39 is a block diagram of a handheld device 3900, according to an implementation. The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

The hand-held device 3900 also includes an operating system 3934 and modules 3936 to 3947 which are described in more detail below. The operating system 3934 and the modules 3936 to 3947 that are executed by the main processor 3902 are typically stored in a persistent nonvolatile medium such as the flash memory 3908, which may alternatively be a read-only memory (ROM) or similar storage element (not shown). Those skilled in the art will appreciate that portions of the operating system 3934 and the modules 3936 to 3947, such as specific device applications, or parts thereof, may be temporarily loaded into a volatile store such as the RAM 3906. Other modules can also be included.

The subset of modules 3936 to 3947 that control basic device operations, including data and voice communication applications, will normally be installed on the hand-held device 3900 during its manufacture. Other modules include a message application 3938 that can be any suitable module that allows a user of the hand-held device 3900 to transmit and receive electronic messages. Various alternatives exist for the message application 3938 as is well known to those skilled in the art. Messages that have been sent or received by the user are typically stored in the flash memory 3908 of the hand-held device 3900 or some other suitable storage element in the hand-held device 3900. In one or more implementations, some of the sent and received messages may be stored remotely from the hand-held device 3900 such as in a data store of an associated host system with which the hand-held device 3900 communicates.

The modules can further include a device state module 3940, a Personal Information Manager (PIM) 3942, and other suitable modules (not shown). The device state module 3940 provides persistence, i.e. the device state module 3940 ensures that important device data is stored in persistent memory, such as the flash memory 3908, so that the data is not lost when the hand-held device 3900 is turned off or loses power.

The PIM 3942 includes functionality for organizing and managing data items of interest to the user, such as, but not limited to, e-mail, contacts, calendar events, voice mails, appointments, and task items. A PIM application has the ability to transmit and receive data items via the wireless network 3905. PIM data items may be seamlessly integrated, synchronized, and updated via the wireless network 3905 with the hand-held device 3900 subscriber's corresponding data items stored and/or associated with a host computer system. The functionality of PIM 3942 creates a mirrored host computer on the hand-held device 3900 with respect to such items. The mirrored host computer can be particularly advantageous when the host computer system is the hand-held device 3900 subscriber's office computer system.

The hand-held device 3900 also includes a connect module 3944, and an IT policy module 3946. The connect module 3944 implements the communication protocols that are required for the hand-held device 3900 to communicate with the wireless infrastructure and any host system, such as an enterprise system, with which the hand-held device 3900 is authorized to interface.

One further example of hand-held device 3900 includes a Jetway JC-111-B compact chassis with dual expansion slots and with a DC-DC wide input range M4-ATX power supply (Logic Supply, South Burlington, VT, USA). The hand-held device 3900 uses a ZOTAC GF9300-I-E LGA 775 Mini ITX motherboard with the Intel Q9550S Yorkfield 2.83 GHz 65 W Quad-Core desktop processor and 8 GB of PC2 6400 dual channel desktop memory. The PCIe expansion slot contains the PIXCI® EL1DB (EPIX, Buffalo Grove, IL, USA) dual base camera link frame grabber for 204 MB/s sustained data transfer of imaging spectrometer data. The motherboard Gigabit Ethernet, USB 2.0, and COM ports are relied on for simultaneous control and data transfer. Data is written to two 512 Gb SATA II solid state disks (one fixed mounted and one ejectable) with up to 180 MB/s sustained sequential write capability. User interfacing is accomplished via direct connection or using an Ethernet remote desktop connection to either a laptop or rack mount general purpose PC.

### CONCLUSION

An experimental gravity modification system, method and apparatus is described. A technical effect of the systems, methods and apparatus described herein is experimental modification of gravity. Although specific implementations are illustrated and described herein, it will be appreciated by those of ordinary skill in the art that any arrangement which is calculated to achieve the same purpose may be substituted for the specific implementations shown. This application is intended to cover any adaptations or variations.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future electrically conducting dome, different electrically conducting coils and new power sources.

The terminology used in this application meant to include all rotating electromagnetic fields and Poynting vector vortices and alternate technologies which provide the same functionality as described herein.

1. An experimental apparatus to modify gravity, the apparatus comprising:
an electrically conducting dome;
three or more electrically conducting coils attached to an interior of the electrically conducting dome; and
a power source electrically coupled to the electrically conducting coils,
the electrically conducting coils configured to generate rotating electromagnetic fields that form a Poynting vector vortex, that produces a force that is perpendicular to the Poynting vector vortex.

2. The experimental apparatus of claim 1, wherein the apparatus further comprises being centered and symmetrical about a center axis.

3. The experimental apparatus of claim 2, wherein the electrically conducting coils further comprise being positioned symmetrically about the center axis.

4. The experimental apparatus of claim 1, wherein each of the electrically conducting coils further comprise being identical to each other.

5. The experimental apparatus of claim 1, wherein the three or more electrically conducting coils further comprise no more than three electrically conducting coils.

6. The experimental apparatus of claim 1, wherein the three or more electrically conducting coils further comprise no more than four electrically conducting coils.

7. The experimental apparatus of claim 1, wherein the three or more electrically conducting coils further comprise no more than eight electrically conducting coils.

8. An experimental system to modify gravity, the experimental system comprising:
an electrically conducting dome;
three or more electrically conducting coils attached to an interior of the electrically conducting dome; and
a power source electrically coupled to the electrically conducting coils,
wherein the electrically conducting coils are configured to generate rotating electromagnetic fields that form a Poynting vector vortex, that produces a force that is perpendicular to the Poynting vector vortex.

9. The experimental system of claim 8, wherein the system further comprises being centered and symmetrical about a center axis.

10. The experimental system of claim 9, wherein the electrically conducting coils further comprise being positioned symmetrically about the center axis.

11. The experimental system of claim 8, wherein each of the electrically conducting coils further comprise being identical to each other.

12. The experimental system of claim 8, wherein the three or more electrically conducting coils further comprise no more than three electrically conducting coils.

13. The experimental system of claim 8, wherein the three or more electrically conducting coils further comprise no more than four electrically conducting coils.

14. The experimental system of claim 8, wherein the three or more electrically conducting coils further comprise no more than eight electrically conducting coils.

15. An experimental method comprising:
energizing electrically at least three electrically conducting coils from one or more power sources; and
generating rotating electromagnetic fields that form a Poynting vector vortex, the Poynting vector vortex producing a force that is perpendicular to the Poynting vector vortex.

16. The experimental method of claim 15, the force further comprising gravity.

17. The experimental method of claim 15, wherein the generating is performed by three or more electrically conducting coils attached to an interior of the electrically conducting dome.

18. (canceled)

19. (canceled)
